(19) United States
(12) Patent Application Publication
(10) Pub. No.: US 2024/0061959 A1
(43) Pub. Date: Feb. 22, 2024

(54) INFORMATION PROCESSING, INFORMATION INTERACTION, TAG VIEWING AND INFORMATION DISPLAY METHOD AND APPARATUS

(71) Applicant: BEIJING ZITIAO NETWORK TECHNOLOGY CO., LTD., Beijing (CN)

(72) Inventors: Bowen SHEN, Beijing (CN); Liyue ZHAO, Beijing (CN); Lian ZHANG, Beijing (CN); Xiaoming ZHANG, Beijing (CN); Yuhao PAN, Beijing (CN)

(21) Appl. No.: 18/456,062

(22) Filed: Aug. 25, 2023

Related U.S. Application Data
(63) Continuation of application No. PCT/CN2022/077874, filed on Feb. 25, 2022.

(30) Foreign Application Priority Data
Feb. 26, 2021 (CN) 202110217494.9
Feb. 26, 2021 (CN) 202110217727.5
Feb. 26, 2021 (CN) 202110218477.7
Mar. 25, 2021 (CN) 202110322532.7

(51) Int. Cl. G06F 21/62; G06F 40/117; G06F 3/04842; G06Q 10/109; G06F 9/451

(52) U.S. Cl. CPC G06F 21/629; G06F 40/117; G06F 3/04842; G06Q 10/109; G06F 9/451; G06F 3/0486

(57) ABSTRACT

Method and apparatus for information processing, information interaction, tag viewing and information display are provided. The method for information processing comprises: receiving a tag adding operation triggered by a user for a target object; and generating a correspondence relationship according to the tag adding operation, wherein the correspondence relationship comprises a correspondence relationship between a target tag and the target object.

This application is a continuation application of International Application No. PCT/CN2022/077874, filed on Feb. 25, 2022, which claims priority to Chinese Patent Application No. 202110217494.9, titled “METHOD AND DEVICE FOR PROCESSING INFORMATION”, filed on Feb. 26, 2021, Chinese Patent Application No. 202110217727.5, titled “METHOD FOR INFORMATION INTERACTION, AND METHOD AND DEVICE FOR VIEWING TAG”, filed on Feb. 26, 2021, Chinese Patent Application No. 202110218477.7, titled “METHOD AND DEVICE FOR PROCESSING INFORMATION”, filed on Feb. 26, 2021, and Chinese Patent Application No. 202110322532.7, titled “METHOD FOR PROCESSING INFORMATION, METHOD AND DEVICE FOR DISPLAYING INFORMATION”, filed on Mar. 25, 2021, with the China National Intellectual Property Administration, all of which are incorporated herein by reference in their entireties.

### FIELD

The present disclosure relates to the technical field of data processing, and in particular to a method for processing information, a method for information interaction, a method for viewing a tag, as well as a method and a device for displaying information.

### BACKGROUND

Development of a project may require collaboration of multiple organizations (e.g., multiple departments, or multiple teams). Members participating in the project may generate some information related to the project during the development of the project, such as tasks, schedules, messages, documents, and chat groups. Such information may belong to different information domains, for example, tasks, schedules, messages, documents, and chat groups belong to different information domains.

How to integrate and manage the information related to the project is a problem desired to be resolved.

### SUMMARY

In order to solve the above technical problem or at least partly solve the above technical problem, a method for processing information, a method for information interaction, a method for viewing a tag, a method and a device for displaying information are provided according to embodiments of the present disclosure, to integrate and manage different information, so as to carry out collaborative work.

In a first aspect, a method for processing information is provided according to an embodiment of the present disclosure. The method includes: acquiring, in response to a tag adding operation triggered by a first user, a first tag indicated by the tag adding operation; determining use permission of the first tag, where the use permission indicates whether the first user has permission to use the first tag; and displaying the first tag and/or use permission information indicating the use permission of the first tag.

In a second aspect, a device for processing information is provided according to an embodiment of the present disclosure. The device includes: a first acquiring unit configured to acquire, in response to a tag adding operation triggered by a first user, a first tag indicated by the tag adding operation; a second acquiring unit configured to determine use permission of the first tag, where the use permission indicates whether the first user has permission to use the first tag; and a first displaying unit configured to display the first tag and/or use permission information indicating the use permission of the first tag.

In a third aspect, a device is provided according to an embodiment of the present disclosure. The device includes: a memory; and a processor configured to execute instructions stored in the memory, to cause the device to perform the method in the first aspect.

In a fourth aspect, a computer-readable storage medium is provided according to an embodiment of the present disclosure. The computer-readable storage medium stores instructions instructing a device to perform the method in the first aspect.

In a fifth aspect, a computer program product is provided according to an embodiment of the present disclosure. The computer program product, when running on a computer, causes the computer to perform the method in the first aspect.

According to an embodiment of the present disclosure, a method for processing information is provided. The method is performed by a first device. Use permission is set for a first tag in advance. The use permission of the first tag indicates whether the first user has permission to use the first tag. Using the first tag refers to adding the first tag to information. In order to tagging information, the first user triggers a tag adding operation. After the first user triggers the tag adding operation, the first device acquires the first tag indicated by the tag adding operation and determines the use permission of the first tag in response to the tag adding operation triggered by the first user. After acquiring the first tag and determining the use permission of the first tag, the first device displays the first tag and/or use permission information indicating the use permission of the first tag. It can be seen that, in the embodiment of the present disclosure, the first tag is defined with the use permission. The first user is not allowed to add the first tag only according to his own subjective wishes. Whether the first user is allowed to use the first tag depends on whether the first user has permission to use the first tag. In an example, users in a team (such as the team of R&D project A) are allowed to use the first tag. Users outside this team are not allowed to use the first tag. In this way, users outside the team are prevented from adding the first tag to the information, which facilitates the integration of the information of the project A based on the first tag. Therefore, this solution is beneficial to information integration.

In the embodiments of the present disclosure, the user is allowed to add a tag to a target object. Correspondingly, the tag that the user wants to add to the target object is determined according to the tag adding operation triggered by the user on the target object, and then the correspondence between the target tag and the target object is obtained. In this way, when the user wants to view the object corresponding to a tag, the client terminal searches for the object (including the target object) corresponding to the tag according to the correspondence and displays the find object. In this way, the client terminal adds a tag to the target object based on the tag adding operation, thereby distinguishing the target object from other objects, so that the user can quickly find the desired object. Therefore, the user can flexibly manage objects.

In a sixth aspect, a method for information interaction is provided according to an embodiment of the present disclosure. The method includes: receiving a tag adding operation triggered by a user on a target object; and generating a correspondence according to the tag adding operation, where the correspondence includes a correspondence between a target tag and the target object.

In a seventh aspect, a method for viewing a tag is provided according to an embodiment of the present disclosure. The method includes: receiving a tag viewing operation triggered by a user on a tag viewing control; and displaying at least one tag according to the tag viewing operation.

In an eighth aspect, a device for information interaction is provided according to an embodiment of the present disclosure. The device includes: a receiving module configured to receive a tag adding operation triggered by a user on a target object; and a generating module configured to generate a correspondence according to the tag adding operation, where the correspondence includes a correspondence between a target tag and the target object.

In a tenth aspect, a device for viewing a tag is provided according to an embodiment of the present disclosure. The device includes: a receiving module configured to receive a tag viewing operation triggered by the user on the tag viewing control; and a display module configured to display at least one tag according to the tag viewing operation.

In a tenth aspect, an electronic device is provided according to an embodiment of the present disclosure. The electronic device includes: a memory configured to storing one or more programs; and one or more processors configured to execute the one or more programs, to implement the method for information interaction, or the method for viewing a tag.

In an eleventh aspect, a computer-readable storage medium is provided according to an embodiment of the present disclosure. The computer-readable storage medium stores computer program that, when executed by a processor, implements the method for information interaction or the method for viewing a tag.

In the embodiments of the present disclosure, the user is allowed to add a tag to a target object. Correspondingly, the tag that the user wants to add to the target object is determined according to the tag adding operation triggered by the user on the target object, and then the correspondence between the target tag and the target object is obtained. In this way, when the user wants to view the object corresponding to a tag, the client terminal searches for the object (including the target object) corresponding to the tag according to the correspondence and displays the find object. In this way, the client terminal adds a tag to the target object based on the tag adding operation, thereby distinguishing the target object from other objects, so that the user can quickly find the desired object. Therefore, the user can flexibly manage objects.

In a twelfth aspect, a method for processing information is provided according to an embodiment of the present disclosure. The method includes: determining permission authorized to a first user for a first tag and viewing permission authorized to the first user for first information, where the first information has the first tag; and determining, based on the permission authorized to the first user for the first tag and the viewing permission authorized to the first user for the first information, content to be presented to the first user.

In a thirteenth aspect, a method for processing information is provided according to an embodiment of the present disclosure. The method includes: determining viewing permission authorized to a first user for a first tag in response to a viewing operation triggered by a first user for the first tag, where the viewing permission indicates whether the first user has permission to view associated information of the first tag; and displaying the associated information of the first tag in response to determining that the first user has permission to view the first tag.

In a fourteenth aspect, a device for processing information is provided according to an embodiment of the present disclosure. The device includes: a first determining unit configured to determine permission authorized to a first user for a first tag and viewing permission authorized to the first user for first information, where the first information has the first tag; and a second determining unit configured to determine, based on the permission authorized to the first user for the first tag and the viewing permission authorized to the first user for the first information, content to be presented to the first user.

In a fifteenth aspect, a device for processing information is provided according to an embodiment of the present disclosure. The device includes: an acquiring unit configured to acquire viewing permission authorized to a first user for a first tag in response to a viewing operation triggered by a first user for the first tag, where the viewing permission indicates whether the first user has permission to view associated information of the first tag; and a first displaying unit configured to display the associated information of the first tag in response to determining that the first user has permission to view the first tag.

In a sixteenth aspect, a device is provided according to an embodiment of the present disclosure. The device includes: a memory; and a processor configured to execute instructions stored in the memory, to cause the device to perform the method in the twelfth or thirteenth aspect.

In a seventeenth aspect, a computer-readable storage medium is provided according to an embodiment of the present disclosure. The computer-readable storage medium stores instructions instructing a device to perform the method in the twelfth or thirteenth aspect.

In an eighteenth aspect, a computer program product is provided according to an embodiment of the present disclosure. The computer program product, when run on a computer, causes the computer to perform the method in the twelfth or thirteenth aspect.

According to the embodiments of the present disclosure, the method for processing information is provided. In an example, the method is performed by a first device. For first information with the first tag, the first device first determines the permission authorized to the first user for the first tag and the viewing permission authorized to the first user for the first information. Then, according to the permission authorized to the first user for the first tag and the viewing permission authorized to the first user for the first information, the first device determines the content to be presented to the first user. It can be seen that, with this solution, the content to be presented to the first user is determined in combination with the permission authorized to the first user for the first tag and the viewing permission authorized to the first user for the first information, so as to manage the information related to the project.

According to the embodiments of the present disclosure, the method for processing information is provided. In an example, the method is performed by a first device. The first user triggers a viewing operation on the first tag. After the first user triggers the viewing operation on the first tag, the first device acquires the viewing permission authorized to the first user for the first tag in response to the viewing operation triggered by the first user for the first tag. The viewing permission authorized to the first user for the first tag indicates whether the first user has permission to view the associated information of the first tag. If the first user has the permission to view the first tag, the first device displays the associated information of the first tag. In an example, the first tag is a tag corresponding to a certain item, and the associated information of the first tag is information related to the item. With this solution, the first user who has the permission to view the first tag can view the associated information of the first tag, so as to view the information related to the project, thereby managing the information related to the project.

In a nineteenth aspect, a method for processing information is provided according to an embodiment of the present disclosure. The method includes: receiving a tag creation operation triggered by a first user; displaying a tag creation page, where the tag creation page comprises a tag attribute component indicating a permission scope attribute of the newly created tag; and receiving a tag name inputted by the first user and a selection operation on the tag attribute component, and generating a first tag.

In a twentieth aspect, a method for displaying information is provided according to an embodiment of the present disclosure. The method includes: receiving a tag viewing operation triggered by a third user; and associatively displaying a tag and an information block having the tag according to a permission scope attribute of the tag and access permission authorized to the third user for the information block with the tag.

In a twenty-first aspect, an electric device is provided according to an embodiment of the present disclosure. The electric device includes: a memory; and a processor configured to execute instructions stored in the memory, to cause the device to perform the method for information interaction in the nineteenth aspect or the method for displaying information in the twentieth aspect.

In a twenty-second aspect, a computer-readable storage medium is provided according to an embodiment of the present disclosure. The computer-readable storage medium stores instructions instructing a device to perform the method for information interaction in the nineteenth aspect or the method for displaying information in the twentieth aspect.

In a twenty-third aspect, a computer program product is provided according to an embodiment of the present disclosure. The computer program product, when run on a computer, causes the computer to perform the method for information interaction in the nineteenth aspect or the method for displaying information in the twentieth aspect.

According to the embodiment of the present disclosure, the method for processing information is also provided. When creating a new tag, the first user determines the permission scope attribute of the newly created tag according to his own needs. For example, the permission scope attribute is the first attribute value, that is, the newly created tag is a public tag. The permission scope attribute is the second attribute value, that is, the newly created tag is a private tag. The public tag is searchable, viewable or editable by all members of the organization. The private tag is viewable or editable by only collaborators, and the collaborators are determined by the first user. That is, the permission scope attribute of the tag created by the first user is the second attribute value, and the first user specifies members to view or edit the newly created tag, that is, shares the private tag, so as to meet the needs of users in different scenarios, thereby improving user experience.

According to the embodiment of the present disclosure, the method for displaying information is also provided. When the third user wants to view the information block corresponding to the tag, the client terminal associatively displays the tag and the information block according to the permission scope attribute corresponding to the tag and the access permission authorized to the third user for the information block. The permission scope attribute is the first attribute value or the second attribute value. The first attribute value indicates that the tag is a public tag. The second attribute value indicates that the tag is a private tag. That is, the client terminal performs different displays according to the permission scope attribute corresponding to the tag and the access permission of third user to the information block, so as to reflect the permission scope attribute of the tag and whether the third user has access permission to the information block through different displays.

### BRIEF DESCRIPTION OF THE DRAWINGS

The accompanying drawings are used to provide further understanding of the present disclosure, constitute a part of the description, and are used together with the embodiments of the present disclosure to explain the present disclosure, and do not constitute a limitation to the present disclosure. In the drawings:

FIG. 1 is a schematic flowchart of a method for processing information according to an embodiment of the present disclosure;

FIG. 2a is a schematic diagram of a tag adding page according to an embodiment of the present disclosure;

FIG. 2b is a schematic diagram of a tag setting interface according to an embodiment of the present disclosure;

FIG. 2c is a schematic diagram of an associated page of a first tag according to an embodiment of the present disclosure;

FIG. 2d is a schematic diagram of a page according to an embodiment of the present disclosure;

FIG. 2e is a schematic diagram of a tag permission setting interface according to an embodiment of the present disclosure;

FIG. 3 is a schematic structural diagram of a device for processing information according to an embodiment of the present disclosure;

FIG. 4 is a schematic flowchart of a method for information interaction according to an embodiment of the present disclosure;

FIG. 5a is a schematic diagram of a display interface of a client terminal according to an embodiment of the present disclosure;

FIG. 5b is a schematic diagram of a display interface of a client terminal according to another embodiment of the present disclosure;

FIG. 5c is a schematic diagram of a display interface of a client terminal according to another embodiment of the present disclosure;

FIG. 6a is a schematic diagram of a display interface of a client terminal according to another embodiment of the present disclosure;

FIG. 6b is a schematic diagram of a display interface of a client terminal according to another embodiment of the present disclosure;

FIG. 7 is a schematic diagram of a display interface of a client terminal according to another embodiment of the present disclosure;

FIG. 8 is a schematic diagram of a display interface of a client terminal according to another embodiment of the present application;

FIG. 9 is a schematic diagram of a display interface of a client terminal according to another embodiment of the present disclosure;

FIG. 10 is a schematic diagram of a display interface of a client terminal according to another embodiment of the present disclosure;

FIG. 11 is a schematic diagram of a display interface of a client terminal according to another embodiment of the present disclosure;

FIG. 12 is a schematic diagram of a display interface of a client terminal according to another embodiment of the present disclosure;

FIG. 13 is a schematic diagram of a display interface of a client terminal according to another embodiment of the present disclosure;

FIG. 14 is a schematic flow chart of a method for viewing a tag according to an embodiment of the present disclosure;

FIG. 15a is a schematic diagram of a display interface of a client terminal according to another embodiment of the present disclosure;

FIG. 15b is a schematic diagram of a display interface of a client terminal according to another embodiment of the present disclosure;

FIG. 16 is a schematic diagram of a display interface of a client terminal according to another embodiment of the present disclosure;

FIG. 17 is a schematic diagram of a display interface of a client terminal according to another embodiment of the present disclosure;

FIG. 18 is a schematic diagram of a display interface of a client terminal according to another embodiment of the present disclosure;

FIG. 19 is a schematic diagram of a display interface of a client terminal according to another embodiment of the present disclosure;

FIG. 20 is a schematic diagram of a display interface of a client terminal according to another embodiment of the present disclosure;

FIG. 21a a schematic diagram of a display interface of a client terminal according to another embodiment of the present disclosure;

FIG. 21b a schematic diagram of a display interface of a client terminal according to another embodiment of the present disclosure;

FIG. 22a is a schematic diagram of a display interface of a client terminal according to another embodiment of the present disclosure;

FIG. 22b is a schematic diagram of a display interface of a client terminal according to another embodiment of the present disclosure;

FIG. 23 is a schematic diagram of a display interface of a client terminal according to another embodiment of the present disclosure;

FIG. 24 is a schematic diagram of a display interface of a client terminal according to another embodiment of the present disclosure;

FIG. 25 is a schematic diagram of a display interface of a client terminal according to another embodiment of the present disclosure;

FIG. 26 is a schematic diagram of a display interface of a client terminal according to another embodiment of the present disclosure;

FIG. 27 is a schematic structural diagram of a device for information interaction according to an embodiment of the present disclosure;

FIG. 28 is a schematic structural diagram of a device for viewing a tag according to an embodiment of the present disclosure;

FIG. 29 is a schematic flowchart of a method for processing information according to an embodiment of the present disclosure;

FIG. 30 is a schematic diagram of a tag adding page according to an embodiment of the present disclosure;

FIG. 31 is a schematic flowchart of a method for processing information according to an embodiment of the present disclosure;

FIG. 32a is a schematic diagram of an associated page of a first tag according to an embodiment of the present disclosure;

FIG. 32b is a schematic diagram of a page according to an embodiment of the present disclosure;

FIG. 32c is a schematic diagram of a tag adding page according to an embodiment of the present disclosure;

FIG. 32d is a schematic diagram of a tag permission setting interface according to an embodiment of the present disclosure;

FIG. 32e is a schematic diagram of a tag setting interface according to an embodiment of the present disclosure;

FIG. 33 is a schematic structural diagram of a device for processing information according to an embodiment of the present disclosure;

FIG. 34 is a schematic structural diagram of a device for processing information according to an embodiment of the present disclosure;

FIG. 35 is a flowchart of a method for processing information according to an embodiment of the present disclosure;

FIG. 36a is an example diagram of a tag creating page according to an embodiment of the present disclosure;

FIG. 36b is an example diagram of a tag creating page according to another embodiment of the present disclosure;

FIG. 36c is an example diagram of a collaborator adding page according to an embodiment of the present disclosure;

FIG. 36d is an example diagram of a collaborator adding page according to another embodiment of the present disclosure;

FIG. 37a is a diagram showing an example of tag page display according to an embodiment of the present disclosure;

FIG. 37b is an example diagram of a tag modification page according to an embodiment of the present disclosure;

FIG. 38 is a flowchart of a method for displaying information according to an embodiment of the present disclosure;

FIG. 39a is a diagram showing an example of group display according to an embodiment of the present disclosure;

FIG. 39b is a diagram showing an example of message display according to another embodiment of the present disclosure;

FIG. 39c is a diagram showing an example of message display according to the embodiment of the present disclosure;

FIG. 39d is a diagram showing an example of cloud document display according to an embodiment of the present disclosure;

FIG. 39e is a diagram showing an example of cloud document permission setting according to an embodiment of the present disclosure;

FIG. 39f is a diagram showing an example of cloud document permission setting according to another embodiment of the present disclosure;

FIG. 40 is a schematic structural diagram of a device for processing information according to an embodiment of the present disclosure;

FIG. 41 is a schematic structural diagram of a device for displaying information according to an embodiment of the present disclosure; and

FIG. 42 is a structural diagram of an electronic device according to an embodiment of the present disclosure.

### DETAILED DESCRIPTION

The technical solutions in the embodiments of the present disclosure will be clearly and completely described below with reference to the drawings in the embodiments of the present disclosure, so that those skilled in the art can better understand the solutions of the present disclosure. Apparently, the described embodiments are only part but not all of the embodiments of the present disclosure. Any other embodiments obtained from the embodiments of the present disclosure by those skilled in the art without any inventive labor fall within the scope of the application.

It should be understood that the various steps described in the method embodiments of the present disclosure may be performed in different orders, and/or in parallel. Additionally, method embodiments may include additional steps and/or illustrated steps may be omitted. The scope of the present disclosure is not limited in this regard.

As used herein, the terms “including” and “comprising” and variations thereof are non-exclusive, i.e., meaning “including but not limited to”. The term “based on” means “at least partially based on”. The term “an embodiment” means “at least one embodiment”, the term “another embodiment” means “at least one another embodiment”, and the term “some embodiments” means “at least some embodiments”. Relevant definitions of other terms will be given in the description below.

It should be noted that wordings such as “first” and “second” mentioned in this application are only used to distinguish different devices, modules or units, and are not used to limit the sequence or interdependence of functions performed by these devices, modules or units.

It should be noted that the wordings of “a” and “a plurality” used in the present disclosure are illustrative rather than restrictive, and those skilled in the art should understand that these wordings should be understood as “one or more” unless otherwise expressly indicated in the context.

It is found that in some scenarios, development of a project may require the collaboration of multiple organizations (e.g., multiple departments, or multiple teams). Members participating in the project will generate some information related to the project during the development of the project, such as tasks, schedules, messages, documents, and chat groups. Such information may belong to different information domains. For example, tasks, schedules, messages, documents, and chat groups respectively belong to different information domains. In order to integrate information related to the project so that users (e.g., project managers, project participants) can determine the information related to the project, users may tag the information related to the project, to integrate the information related to the project based on the tags.

Currently, when users tag information, there is no special restriction on the tags they use. That is, for a tag such as “Project A R&D”, any user can use this tag to tag the content they want to tag. However, this is not conducive to the integration of the aforementioned project-related information. For example, if a team A and a team B jointly develop the project A, then the team A and the team B can use the tag “Project A R&D” to tag related information, and other users can also use the tag “Project A R&D” to tag related information. Therefore, when using the tag “Project A R&D” for information integration, other content annotated by other users will also be integrated.

Therefore, the existing scheme for using tags use method is not conducive to information integration.

Various non-limiting implementations of the present disclosure will be described in detail below with reference to the accompanying drawings.

Exemplary Method

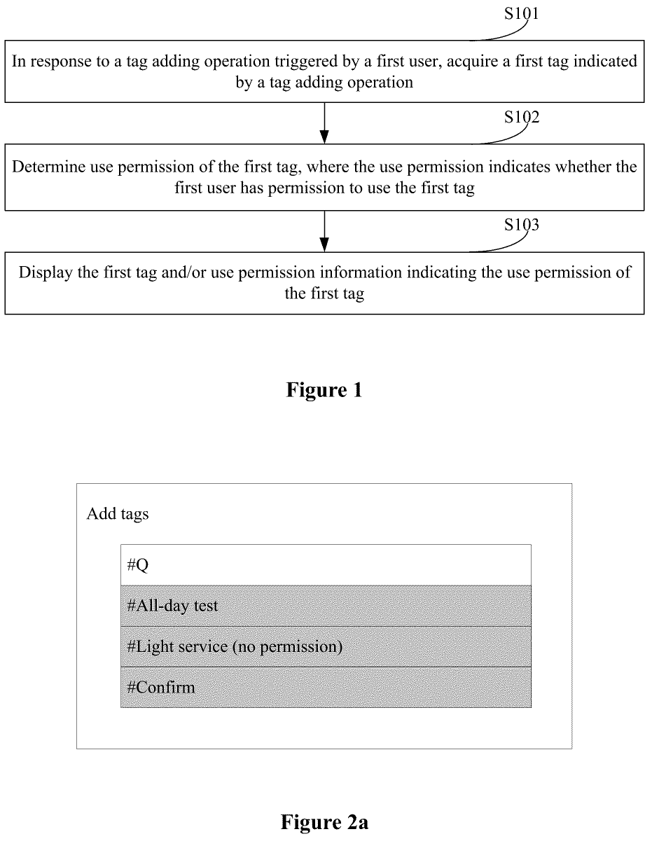

FIG. 1 is a schematic flowchart of a method for processing information according to an embodiment of the present disclosure. The method according to the embodiments of the present disclosure may be performed by a first device. The first device may be a client terminal or a server, which is not specifically limited in this embodiment of the present disclosure.

In this embodiment of the present disclosure, a target application program may be installed on the first device. The first user mentioned in the embodiment of the present disclosure refers to the user corresponding to the account that logs in the target application program on the first device.

Unless otherwise specified, the information mentioned in the embodiments of this application, such as first information, second information, third information or target information, may be one or more of a task, a schedule, a message, a document and a chat group, etc. In some contexts, “information unit” and “information” may be used interchangeably.

The symbol “#” in the embodiments of the present disclosure and the drawings is a tag identifier. The tag identifier is not limited to “#”, and may be other symbols.

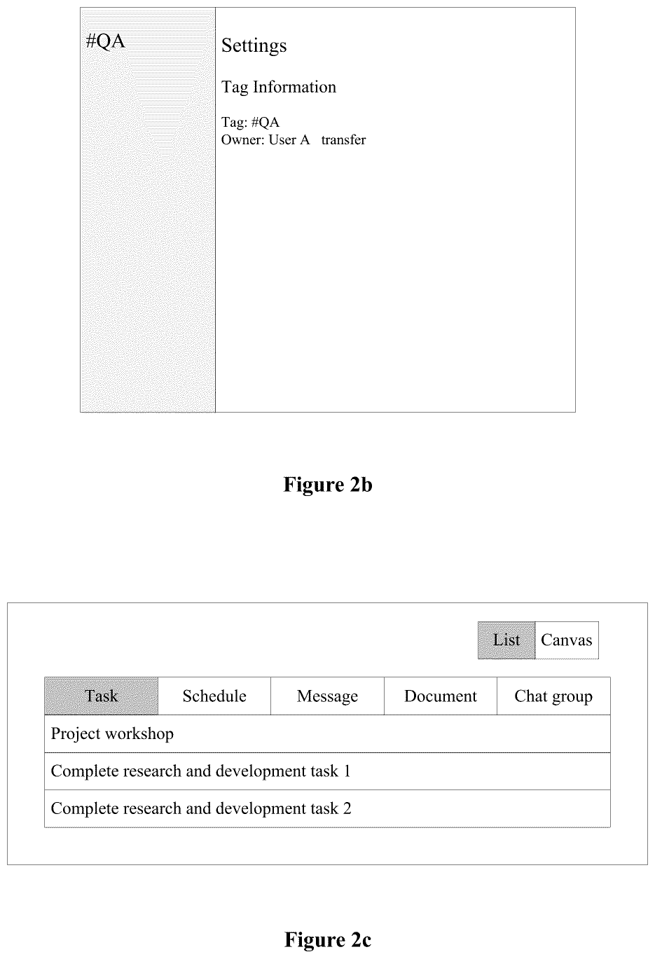

All the drawings in the embodiments of the present disclosure, such as FIG. 2a to FIG. 2e, are only shown for the convenience of understanding the content related to the embodiments of the present disclosure, rather than constitute a limitation to the embodiments of the present disclosure. The pages shown in FIG. 2a to FIG. 2e may include other content, which is not specifically limited in the embodiments of the present disclosure.

In this embodiment, the method may include, for example, the following steps S101 to S103.

In S101, in response to a tag adding operation triggered by the first user, a first tag indicated by the tag adding operation is acquired.

In this embodiment of the present disclosure, a target application program may be installed on the first device. The target application program has the function of adding tags. In an example, the first user may trigger a tag adding operation for certain information, or may trigger a tag adding operation on a tag management homepage. After the first user triggers the tag adding operation, the first device may acquire the first tag indicated by the tag adding operation. In an example, after the first user triggers the tag adding operation, the first device may display a tag adding page. The tag adding page includes a character input area. The first user can input corresponding characters in the character input area. Correspondingly, after acquiring the characters inputted by the first user, the first device may provide, according to the characters inputted by the first user, corresponding tag candidates for the first user, and display the tag candidates on the tag adding page, so that the user can select the tag that he wants to add based on the tag candidates. The first tag may be one of the tag candidates determined by the first device according to the characters inputted by the first user.

The characters mentioned here may include one or more of Chinese characters, English characters, Korean characters, numbers, etc., which are not specifically limited in this embodiment of the present disclosure.

In S102, the use permission of the first tag is acquired. The use permission indicates whether the first user has the permission to use the first tag.

In S103, at least one of the first tag and use permission information for indicating the use permission of the first tag is displayed.

Considering that the traditional way of tag use is not conducive to the integration of information, in the embodiments of the present disclosure, the use permission may be set for the first tag in advance. The use permission of the first tag indicates whether the first user has the permission to use the first tag. Using the first tag refers to adding the first tag, for example, creating the first tag, or tagging information with the first tag.

In view of this, after the first tag is determined, the first device may obtain the use permission of the first tag, and display the first tag and the use permission of the first tag on the tag adding page. In other words, the first tag and/or the use permission information indicating the use permission of the first tag is displayed on the tag adding page.

In an example, when the first user has no permission to use the first tag, the first tag and the use permission information may be displayed to prompt that the first user has no permission to use the first tag. If the first user has the permission to use the first tag, only the first tag is displayed. In other words, if the use permission of the first tag is not displayed on the tag adding page, it is assumed that the first user has the permission to use the first tag.

It can be seen that, in the embodiment of the present disclosure, the first user cannot add the first tag according to his own subjective wishes. Whether the first user can use the first tag depends on the use permission of the first tag. In an example, users in a certain team (such as the team of Project A R&D) may be allowed to use the first tag, while users outside the team are not allowed to use the first tag. In this way, users outside the team can be prevented from adding the first tag to information, thereby facilitating the integration of the information of the project Abased on the first tag. Therefore, this solution can facilitate the information integration.

S101 to S103 may be understood in conjunction with FIG. 2a, which is a schematic diagram of a tag adding page according to an embodiment of the present disclosure. As shown in FIG. 2a, after the first user enters the character “#Q” in the tag adding page, the tag candidates “all-day test”, “light service”, “confirm” and so on are displayed as shown in FIG. 2a. For the tag candidate “light service”, it is also shown that the first user has no permission to use the tag “light service”.

In an example, if the first user has no permission to use the first tag, the use permission information is also used to instruct the first user to apply to the owner of the first tag for permission to use the first tag. The first user may apply to the owner of the first tag for the permission to use the first tag by triggering a corresponding operation. For example, the first user may click on the use permission information to apply to the owner of the first tag for the use permission of the first tag. After the owner of the first tag grants the application of the first user, the first user is allowed to use the first tag.

The owner of the first tag mentioned here may be the creator of the first tag. For example, if the person in charge of a project created the first tag, the owner of the first tag may be the person in charge of the project.

In addition, it is considered that the person in charge of the project may change. If the person in charge of the project is changed, the person in charge before the change should no longer be the owner of the first tag. Therefore, in this embodiment of the present disclosure, the identity of the owner of the first tag can be transferred. The former owner of the first tag may transfer the identity of the owner of the first tag to another user by performing an owner identity transfer operation. In an example, the former owner may perform the tag transfer operation in the setting interface of the first tag, and designate a user as the owner of the first tag. Reference is made to FIG. 2b, which is a schematic diagram of a tag setting interface according to an embodiment of the present disclosure. As shown in FIG. 2b, the former owner of the first tag “QA”, for example, the user A, may trigger the owner identity transfer operation by clicking “Transfer” shown in FIG. 2b, and designate a user as the new owner.

In one example, the first tag may only have one owner. If the first tag has undergone multiple owner identity transfers, the owner of the first tag may be the user specified by the last owner identity transfer operation.

In another example, if the first user has the permission to use the first tag, the first user may trigger a tag adding operation on the first tag to add the first tag. If the tag adding page is the page displayed after the first user triggers the tag adding operation for the target information, the first device may add the first tag to the target information after the first user triggers the tag adding operation for the first tag. If the tag adding page is the page displayed after the first user triggers the tag adding operation on the tag management home page, the first device may create the first tag after the first user triggers the tag adding operation on the first tag. The triggering of the tag adding operation for the first tag mentioned here may be, for example, clicking the first tag in the tag candidates.

In some embodiments, permissions of the first tag may include viewing permission in addition to the use permission. The viewing permission of the first tag indicates whether the first user has the permission to view the associated information of the first tag. In an example, the priority of the use permission of the first tag is higher than the priority of the viewing permission of the first tag. The first user having permission to use the first tag has the permission to view the first tag.

In an example, the first user may trigger a viewing operation on the first tag. The first device may, in response to the viewing operation triggered by the first user for the first tag, display associated information of the first tag on determining that the first user has viewing permission of the first tag. It can be understood that if the use permission information in S103 indicates that the first user has the use permission of the first tag, then the first user certainly have the viewing permission of the first tag. In this case, after the first user triggers the viewing operation on the first tag, the first device may display associated information of the first tag in response to the viewing operation triggered by the first user for the first tag. If the use permission information in S103 indicates that the first user has no use permission of the first tag, the first user may or may not have the viewing permission of the first tag. In this case, after the first user triggers the viewing operation on the first tag, the first device may further determine whether the first user has the viewing permission of the first tag. If it is determined that the first user has the permission to view the first tag, the first device displays the associated information of the first tag.

In an example, the first user may trigger a viewing operation for the first tag on a page including tag sharing information, where the tag indicated by the tag sharing information is the first tag. As an example, the page including the tag sharing information may be an instant messaging session interface. The tag sharing information may be shared by users in the instant messaging session interface to the instant messaging session interface. In another example, the first user may search for the first tag in a tag management interface, and further trigger the viewing operation on the first tag after the first tag is obtained from the search.

After the first user triggers the viewing operation on the first tag, the first device may, in response to the viewing operation triggered by the first user for the first tag, determine the viewing permission authorized to the first user for the first tag. Then, the content to be presented to the first user is determined according to the viewing permission authorized to the first user for the first tag.

In an example, if the first user has the permission to view the first tag, the associated information of the first tag may be presented to the first user.

In an implementation, the associated information of the first tag may be displayed on the associated page of the first tag. Therefore, one implementation of “displaying the associated page of the first tag” is: displaying the associated page of the tag.

For example, the associated page may include summary information of an information unit that has the first tag and that the first user has permission to view. For example, if the first user has the permission to view the second information and the second information has the first tag, the associated page of the first tag may include summary information of the information unit of the second information. Correspondingly, if the first user has no permission to view the first information, in an example, the associated page of the first tag does not include summary information of the first information. In this embodiment of the present disclosure, the summary information of an information unit refers to part of the information in the information unit, for example, part of keywords in the information unit.

In this embodiment of the present disclosure, the information summaries of the information units with the first tag are classified and presented on the associated page of the first tag according to the message domain from which each information unit originates. The information unit with the first tag includes a first information unit. Then the message domain, from which the first information unit originates, indicates the source of the first information unit. In an example, the message domain from which the first information unit originates indicates the service provider corresponding to the first information unit. The service provider mentioned here may be, for example, an instant messaging session service provider or a file service provider.

The information summaries of the information units with the first tag are classified and presented on the associated page of the first tag according to the message domain from which each information unit comes, which can be understood with reference to FIG. 2c, which is a schematic diagram of an associated page of the first tag according to an embodiment of the present disclosure.

As shown in FIG. 2c, the associated page includes five message domains, which are “task”, “schedule”, “message”, “document” and “chat group”. In the associated page shown in FIG. 2c, the message domain “task” is already selected. The page displays information summaries corresponding to 3 tasks, namely “Project Seminar”, “Complete R&D Task 1”, and “Complete R&D Task 2”. It should be noted that although the content corresponding to the message domain “task” shown in FIG. 2c is displayed in a list, FIG. 2c is only shown for the convenience of understanding and does not constitute a limitation to the embodiment of the present disclosure. In an example, the contents included in the associated page of the first tag may alternatively be displayed in the form of canvas. For example, the user may switch the display form of the contents included in the associated page through the controls “list” and “canvas” shown in FIG. 2c.

In an example, the contents included in the associated page are displayed in the form of canvases. The associated page may include one or more canvases. Each canvas is used to display summary information corresponding to one piece of information, for example, summary information corresponding to a piece of second information. In addition, when the contents included in the associated page are displayed in the form of canvases, the first user may group the contents included in the associated page. Correspondingly, the first device may, in response to a grouping operation triggered by the user, group the contents included in the associated page. Specifically, the first user may trigger a grouping operation to determine the content to be added to the group and input a group name. The first device may generate a correspondence between the group name and the content added in the group, and display the correspondence in a canvas on the associated page.

For example, the first user groups a task X and a task Y in the message domain “task” in the associated page into one group, and sets the tag group name of the group as “first group”. Correspondingly, the first device may record the correspondence between the first group and the task X and the correspondence between the first group and the task Y, and present the correspondence between the first group and the task X and the correspondence between the first group and task Y in the form of canvas on the associated page.

In an example, the first user may group multiple pieces of information with a certain characteristic into one group. In this way, even if there is a lot of information with the first tag in the associated page, the first user can quickly find the information that the first user wants to find according to the grouping set by him.

In an example, after the first user groups the contents included in the associated page, other users who have the permission to view the first tag can also view the groups displayed in the form of canvas. Taking the aforementioned “first group” as an example, a second user can view the “first group” displayed in the form of canvas if the second user has the permission to view the first tag. Specifically, for the information belonging to the “first group”, the second user can, for example, view the summary information of the information displayed in the form of canvas if the second user has the permission to view the information. In other words, the canvas corresponding to the “first group” included in the associated page displayed on the client terminal corresponding to the second user includes summary information of the information. If the second user has no permission to view the information, the second user cannot view the summary information of the information displayed in the form of canvas. In other words, the canvas corresponding to the “first group” included in the associated page displayed on the client terminal corresponding to the second user does not include summary information of the information. Alternatively, if the second user has no permission to view the information, the canvas corresponding to the “first group” included in the associated page displayed in the client terminal corresponding to the second user can still display the summary information of the information and/or or prompt information. The prompt information is used to prompt the second user to apply to the owner of the information to view the information. In a first example, the “first group” includes a task X and a task Y, and the second user has the viewing permission of the task X but has no viewing permission of the task Y. Then the associated page displayed on the client terminal of the second user includes the canvas corresponding to the “first group”. In addition, the summary information of the task X is displayed in the canvas but the summary information of the task Y is not displayed.

In a second example, the “first group” includes a task X and a task Y, and the second user has the viewing permission of the task X but has no viewing permission of the task Y. Then the associated page displayed on the client terminal of the second user includes the canvas corresponding to the “first group”. In addition, the canvas displays summary information of the task X, summary information of the task Y, and prompt information. The prompt information is used to prompt the second user to apply to the owner of the task Y for the viewing permission of the task Y.

In an example, for the summary information of the second information displayed on the associated page, the first user may also trigger a preset operation on the summary information of the second information, so as to view the second information. The preset operation triggered by the first user for the summary information of the second information may be, for example, a click operation. In an example, if the first user triggers a preset operation on the summary information of the second information, the first device may display the second information in response to the preset operation triggered by the first user for the summary information of the second information. For example, a page may be separately loaded in the associated page to display the second information. As another example, the second information may be displayed in a certain area on the associated page, such as a sidebar. In another example, the first user triggers the preset operation on the summary information of the second information, then the first device jumps to a page including the second information in response to the preset operation triggered by the first user for the summary information of the second information. For example, when the second information is an instant messaging message, the instant messaging session interface where the instant messaging (IM) message is located is displayed after the first user triggers the preset operation on the information summary of the second information. For another example, the second information is an IM group, and an instant messaging session interface corresponding to the IM group is displayed after the first user triggers a preset operation on the information summary of the second information.

In another example, in addition to the summary information of the second information, the associated page of the first tag may also include summary information of third information not having very strict requirements on confidentiality, even if the first user has no permission to access the third information. The associated page mentioned here refers to the page presented on the client terminal where the first user logs in.

In this case, the first user may trigger the preset operation on the information summary of the third information, so as to apply to the owner of the third information for viewing permission of the third information. In an example, after viewing the information summary of the third information, the first user, if wishes to further view the specific content of the third information, may trigger the preset operation on the information summary of the third information (for example, clicking the information summary of point information), to apply to the owner of the third information for viewing permission of the third information. If the owner of the third information grants the application, the first user can further view the third information. The owner of the third information mentioned here may be, for example, the publisher or creator of the third information.

In an example, after the first user triggers a view operation on the first tag, the first device may display first prompt information if determines that the first user has no viewing permission of the first tag. The first prompt information indicates that the first user has no permission to view the associated information of the first tag. In another example, in addition to indicating that the first user has no permission to view the associated information of the first tag, the first prompt information further instructs the first user to apply to the owner of the first tag for permission to view the first tag. In this case, if the first user wishes to view the associated information of the first tag, a preset operation may be triggered on the first prompt information. After the first user triggers the preset operation on the first prompt information, for example, clicks on the first prompt information, the first device may apply to the owner of the first tag for permission to view the first tag in response to the preset operation triggered by the first user on the first prompt information. If the owner of the first tag grants the application, the first user can view the associated information of the first tag. For example, the first device may display the associated page of the first tag.

It can be understood in conjunction with FIG. 2d, which is a schematic diagram of a page according to an embodiment of the present disclosure. In FIG. 2d, if the first user has no viewing permission of the first tag “QA”, the first device may display the first prompt information of “No permission to view, click here to apply for permission” after the first user triggers the viewing operation on the first tag.

In this embodiment of the present disclosure, the use permission of the first tag and the viewing permission of the first tag may be set by the owner of the first tag. In an example, the owner of the first tag may trigger a permission setting operation on the permission setting interface of the first tag to set the permission of the first tag. After the owner of the first tag triggers a permission setting operation on the permission setting interface of the first tag, the first device determines, in response to the permission setting operation, the use permission of the first tag and/or the viewing permission of the first tag set by the owner of the first tag. After the use permission of the first tag and/or the viewing permission of the first tag set by the owner of the first tag are determined, permission setting information of the first tag is generated.

It can be understood that the permission setting information of the first tag includes the viewing permission and use permission of the first tag. In an example, the priority of the use permission of the first tag is higher than the priority of the viewing permission of the first tag. The first user who has the permission to use the first tag has the permission to view the first tag.

Reference is made to FIG. 2e for understanding. FIG. 2e is a schematic diagram of a tag permission setting interface according to an embodiment of the present disclosure. The owner of the first tag “QA” may set the permission of the first tag through the three permission setting options 201, 202 and 203 provided in FIG. 2e. As described above, the use permission has a higher priority than the viewing permission. Therefore, if the owner of the first tag uses the option 201 to set the permission of the first tag, all members in the organization have both the use permission of the first tag and the viewing permission of the first tag. If the owner of the first tag uses the option 202 or 203 to set the permission of the first tag, the owner of the first tag may further set the designated user.

It is found that how to integrate and manage the information related to the project is a problem desired to be resolved. In order to integrate information related to the project so that users (e.g., project managers, and project participants) can determine the information related to the project, users may tag the information related to the project to integrate the information related to the project based on the tag.

In order to avoid the disclosure of project-related information during the project development, permissions may be set for the project-related tags. Only users authorized with tag permissions can perform corresponding operations on the tag.

At present, the permission of the tag is strongly coupled with the permission of the information with the tag. However, this scheme does not meet the actual needs. For example, information 1 is tagged with a tag 1, and a user 1 has the tag permission of the tag 1, and then the user 1 also has the viewing permission of the information 1. However, this scheme cannot effectively protect information security. This is because although multiple organizations are involved in the development of the same project, different organizations may be responsible for different aspects. Correspondingly, in principle, for information with relatively high confidentiality requirements, only members of organizations that create the information can view the information. For another example, the information 1 is tagged with the tag 1, and the user 1 has no tag permission of the tag 1, and therefore the user 1 is not allowed to view the information 1 correspondingly. However, if the permission setting of the tag 1 is relatively strict, and the information 1 has no special confidentiality requirements, this scheme is not conducive to information sharing.

In view of this, in an implementation manner of the embodiment of the present disclosure, the first device may further perform the following steps A and B.

In step A, permission authorized to the first user for the first tag and viewing permission authorized to the first user for the first information are determined. The first information has the first tag.

In this embodiment of the present disclosure, permission of the first user for the first tag and viewing permission authorized to the first user for the first information are stored locally on the client terminal corresponding to the first user or on the server of the target application program. The first device determines the permission of the first user for the first tag and the viewing permission authorized to the first user for the first information from the client terminal corresponding to the first user locally or from the server, which is not specifically limited in this embodiment of the present disclosure. It can be understood that the target application program is installed on the client terminal corresponding to the first user.

In step B, the content to be presented to the first user is determined according to the permission authorized to the first user for the first tag and the viewing permission authorized to the first user for the first information.

In this embodiment of the present disclosure, permissions for the first tag itself are defined. Information with the first tag, such as the first information, also has corresponding viewing permission. The viewing permission of the first information is independent of the permission of the first tag. The viewing permission of the first information mentioned here indicates whether the first user has the permission to view the first information.

In this embodiment of the present disclosure, the content to be presented to the first user should consider the viewing permission authorized to the first user for the first information and the permission authorized to the first user for the first tag. In this way, information security problems and disadvantages in information sharing caused by determining the content to be presented to the first user by only considering the permission authorized to the first user for the first tag are avoided. The content to be presented to the first user may be presented on the client terminal corresponding to the first user. The client terminal corresponding to the first user mentioned here refers to the client device that logs in the account corresponding to the first user.

In an example, the permission authorized to the first user for the first tag includes the viewing permission authorized to the first user for the first tag. The viewing permission authorized to the first user for the first tag indicates whether the first user has the permission to view the associated information of the first tag. The associated information of the first tag mentioned here refers to information associated with the first tag, for example, information having the first tag.

In an example, the associated information of the first tag may be presented on an associated page of the first tag. In this case, the permission of first user to view the first tag indicates whether the first user has the permission to view the associated page of the first tag. In this case, if the first user has the permission to view the first tag, the first user is allowed to view the associated page of the first tag. If the first user has no permission to view the first tag, the first user is not allowed to view the associated page of the first tag.

In an example, if the first user has the permission to view the first tag but has no permission to view the first information, it is determined that the first page presented to the first user does not include the first information. The first page mentioned here may be an associated page of the first tag or other pages, for example, an instant messaging session interface. In other words, even if the first user has the permission to view the first tag, the content to be presented to the first user does not include the first information if the first user has no permission to view the first information. For example, the first page is the associated page of the first tag, and the associated page does not include the first information. In this manner, the information security of the first information can be effectively protected.

In an example, the first page is, for example, an instant messaging session interface. In this case, the first information may be files published by other users in the instant messaging session indicated by the instant messaging session interface. It can be understood that the first user is included in the instant messaging session indicated by the instant messaging session interface. For this situation, if the first user has no permission to view the files published by other users in the instant messaging session indicated by the instant messaging session interface, then the instant messaging session interface displayed on the client terminal corresponding to the first user does not include the first information. For example, both the first user and the second user are in the instant messaging session interface. If the second user publishes a document and the first user has no permission to view the document, the instant messaging session interface displayed on the client corresponding to the first user does not include the document. In one scenario, the instant messaging session indicated by the instant messaging session interface may only include the first user and the second user, or may include other users, which is not specifically limited in this embodiment of the present disclosure.

In an example, if the first user has permission to view the first tag, the associated page of the first tag may be presented to the first user. For example, the associated page may include summary information of an information unit that has the first tag and that the first user has permission to view. For example, the first user has the permission to view the second information and the second information has the first tag, the associated page of the first tag may include summary information of the information unit of the second information. Correspondingly, if the first user has no permission to view the first information, in an example, the associated page of the first tag does not include summary information of the first information. In this embodiment of the present disclosure, the summary information of an information unit refers to part of the information in the information unit, for example, part of keywords in the information unit.

In another example, the first user has the permission to use the first tag, and the first information is information in an instant messaging session. If the first user is not in the instant messaging session, the first user must not have the permission to view the first information. However, if the first user subsequently joins the instant messaging session including the first information, the first user has the permission to view the first information. In this case, the first information with the first tag in the instant messaging session may be associatively presented to the first user. Associatively presenting the first information with the first tag refers to presenting the first information and presenting a correspondence between the first information and the first tag. The first user determines, based on the associatively presented first information with the first tag, that the first information has the first tag.

As mentioned above, the viewing permission authorized to the first user for the first tag indicates whether the first user has the permission to view the associated information of the first tag. The associated information of the first tag may be presented on the associated page of the first tag. In some embodiments, if the first user has no permission to view the first tag, then no matter whether the first user has the permission to view the first information, the content to be presented to the first user does not include the associated page of the first tag.

In an example, the first user has no permission to view the first tag but has the permission to view the first information, the first device may determine that the content to be presented to the first user includes a page including the first information. In addition, since the first user has no permission to view the first tag, the page including the first information does not present the correspondence between the first information and the first tag. For convenience of description, the “page including the first information” is referred to as the second page. Then the second page may include the first information. The first user can view the first information on the second page. However, the correspondence between the first information and the first tag is not displayed on the second page. In other words, the first user can view the first information through the second page, but fails to confirm that the first information has the first tag through the second page. The second page mentioned here is, for example, an instant messaging session interface including the first user. The first information may include, for example, session messages in the instant messaging session indicated by the instant messaging session interface, and/or files published by other users in the instant messaging session indicated by the instant messaging session interface. The instant messaging session interface mentioned here may be an instant messaging interface including two users, or an instant messaging session interface including more than two users, which is not specifically limited in the embodiment of the present disclosure.

In an example, the first user may trigger a tag viewing operation for the tag sharing information, so as to trigger a viewing operation for a tag indicated by the tag sharing information. After the first user triggers the tag viewing operation on the tag sharing information, the first device may determine, based on the viewing permission authorized to the first user for the tag indicated by the tag sharing information, the content presented in the tag-associated page presented to the first user. The tag sharing information, for example, is a hyperlink or a tag identifier, which is not specifically limited in this embodiment of the present disclosure. The tag viewing operation triggered for the tag sharing information, for example, is a click operation. For details about “determining the content in the tag-associated page presented to the first user based on the viewing permission authorized to the first user for the tag indicated by the tag sharing information”, reference is made to the above relevant descriptions of “the viewing permission authorized to the first user for the first tag” and “content presented on the associated page of the first tag presented to the first user”, and therefore the description is brief here.

Exemplary Device

Based on the method provided in the above embodiments, a device is provided according to the embodiments of the present disclosure, which will be described below with reference to the drawings.

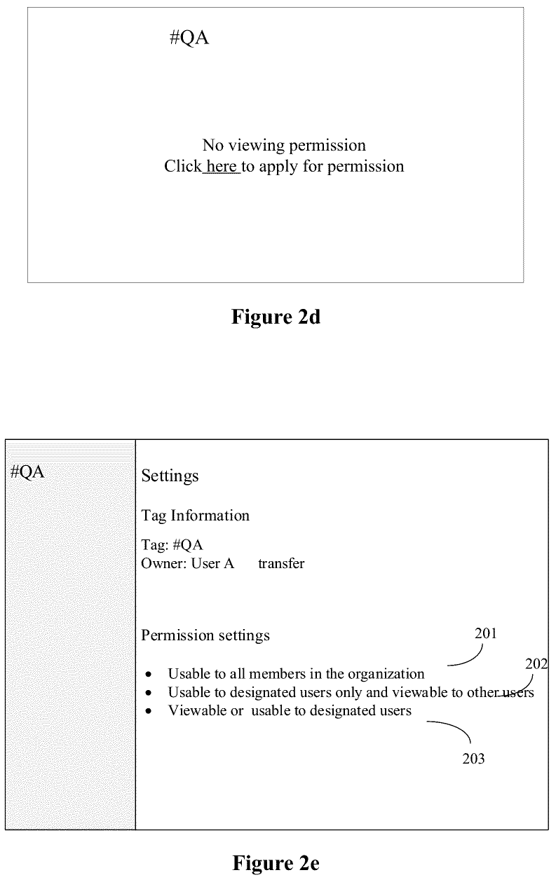

Reference is made to FIG. 3, which is a schematic structural diagram of a device for processing information according to an embodiment of the present disclosure. For example, the device 300 may include: a first acquiring unit 301, a second acquiring unit 302, and a first displaying unit 303.

The first acquiring unit 301 is configured to, in response to a tag adding operation triggered by a first user, acquire a first tag indicated by the tag adding operation.

The second acquiring unit 302 is configured to determine use permission of the first tag. The use permission indicates whether the first user has the permission to use the first tag.

The first displaying unit 303 is configured to display the first tag and/or use permission information indicating the use permission of the first tag.

Optionally, if the use permission information indicates that the first user has no permission to use the first tag, the use permission information is also used to instruct the first user to submit a request to the owner of the first tag to apply for permission to use the first tag.

Optionally, if the use permission information indicates that the first user has the permission to use the first tag, the device further includes a tag adding unit.

The tag adding unit is configured to add the first tag in response to a tag adding operation triggered by the first user for the first tag.

Optionally, the tag adding unit is configured to add the first tag to the target information.

Optionally, the device further includes a third acquiring unit and a second displaying unit.

The third acquiring unit is configured to determine the viewing permission authorized to the first user for the first tag in response to the viewing operation triggered by the first user for the first tag. The viewing permission indicates whether the first user has the permission to view the associated information of the first tag.

The second displaying unit is configured to display associated information of the first tag in response to determining that the first user has viewing permission of the first tag.

Optionally, the second displaying unit is configured to display an associated page of the first tag. The associated page of the first tag includes associated information of the first tag.

Optionally, the associated page of the first tag includes summary information of the information unit with the first tag. The information unit includes second information. The first user has permission to view the second information.

Optionally, the information summaries of the information units with the first tag are classified and presented on the associated page of the first tag according to the message domain from which each information unit originates.

Optionally, each information unit includes a first information unit. The message domain from which the first information unit originates indicates a service provider corresponding to the first information unit.

Optionally, the device further includes a page jumping unit and/or a third displaying unit.

The page jumping unit is configured to jump to a page including the second information in response to a preset operation triggered by the first user for the summary information of the second information.

The third displaying unit is configured to display the second information in response to a preset operation triggered by the first user for the summary information of the second information.

Optionally, the associated page of the first tag further includes summary information of third information having the first tag. The first user has no permission to view the third information. The associated page of the first tag is a page presented on the device logged in by the first user.

Optionally, the device further includes a first application unit.

The first application unit is configured to apply to the owner of the third information for viewing permission of the third information, in response to a preset operation triggered by the first user for the information summary of the third information.

Optionally, the device further includes a fourth displaying unit.

The fourth displaying unit is configured to display first prompt information in response to determining that the first user has no permission to view the first tag. The first prompt information indicates that the first user has no permission to view the associated information of the first tag.

Optionally, the first prompt information is further used to prompt the first user to apply to the owner of the first tag for permission to view the first tag.

Optionally, the device further includes a second application unit.

The second application unit is configured to apply to the owner of the first tag for permission to view the first tag in response to a preset operation triggered by the first user for the first prompt information.

Optionally, the device further includes a generation unit.

The generation unit is configured to generate permission setting information of the first tag in response to a permission setting operation triggered by the owner of the first tag on the permission setting interface of the first tag.

Optionally, the permission setting information of the first tag includes viewing permission of the first tag and use permission of the first tag. The priority of the use permission of the first tag is higher than the priority of the viewing permission of the first tag. If the first user has the permission to use the first tag, the first user also has the permission to view the first tag.

Optionally, the owner of the first tag is the creator of the first tag.

Alternatively, the owner of the first tag is the user specified when the former owner of the first tag performs an owner identity transfer operation.

Optionally, the device further includes a first determination unit and a second determination unit.

The first determination unit is configured to determine the permission authorized to the first user for the first tag and the viewing permission authorized to the first user for the first information. The first information has the first tag.

The second determination unit is configured to determine, based on the permission authorized to the first user for the first tag and the viewing permission authorized to the first user for the first information, the content to be presented to the first user.

Optionally, the second determination unit is configured to determine not to include the first information in the first page presented to the first user if the first user has permission to view the first tag and has no permission to view the first information.

Optionally, the second determination unit is configured to determine not to include an associated page of the first tag in the content to be presented to the first user, if the first user has the permission to view the first tag and has no viewing permission of the first information. The associated page of the first tag includes summary information of the information unit with the first tag. The information unit includes the second information and does not include the first information. The first user has permission to view the second information.

Optionally, the second determination unit is configured to present the first information with the first tag in the instant messaging session to the first user in response to the first user joining the instant messaging session, if the first user has permission to view the first tag.

Optionally, the second determination unit is configured to determine that the content to be presented to the first user does not include the associated page of the first tag, if the first user has no permission to view the first tag and has the permission to view the first information.

Optionally, the second determination unit is configured to determine that the content to be presented to the first user includes a second page, if the first user has no permission to view the first tag and has permission to view the first information. The second page includes the first information. The correspondence between the first information and the first tag is not displayed on the second page.

Optionally, the second page includes an instant messaging session interface of the first user. The first information includes: session messages in the instant messaging session indicated by the instant messaging session interface, and/or files published by other users in the instant messaging session indicated by the instant messaging session interface.

Optionally, the device further includes a third determination unit.

The third determination unit is configured to determine, in response to the tag viewing operation triggered by the first user for the tag sharing information and based on the viewing permission authorized to the first user for the tag indicated by the tag sharing information, the presentation content in the tag-associated page to be presented to the first user.

Since the device 300 corresponds to the method provided in the above method embodiments, the specific implementation of each unit of the device 300 is based on the same idea as the above method embodiments. Therefore, for the specific implementation of each unit of the device 300, reference may be made to the description of the above method embodiments, and details are not repeated here.

According to an embodiment of the present disclosure, a device is also provided, and the device includes a processor and a memory.

The processor is configured to execute instructions stored in the memory, to cause the device to perform the method described in the above method embodiments.

According to an embodiment of the present disclosure, a computer-readable storage medium including instructions is also provided. The instructions instruct a device to perform the method described in the above method embodiments.

According to an embodiment of the present disclosure, a computer program product is also provided. When the computer program product is run on a computer, the computer performs the method described in the above method embodiments.

On the other hand, the data generated by the software increases with the use of time. Therefore, in order to select the desired object from the data, the user has to determine whether the data is the desired object one by one, resulting in difficulty in quickly finding the desired object. For example, the user has to browse a large amount of chat data to find the chat records related to the project A from the chat records. It can be seen that the user finds the target object at a relatively slow speed in the traditional technology.

In order to solve this problem, a bookmark function is provided in related technologies. Users can bookmark data that is to be used, which improves the speed for users to find target objects to a certain extent. However, this scheme displays all bookmarked objects. If the number of bookmarked objects is large, there is still the problem that the user finds the target object at a relatively slow speed. According to the embodiment of the present disclosure, a method for information interaction and a method for viewing a tag are also provided in order to solve the problems in the prior art, which will be described in detail below in conjunction with the accompanying drawings.

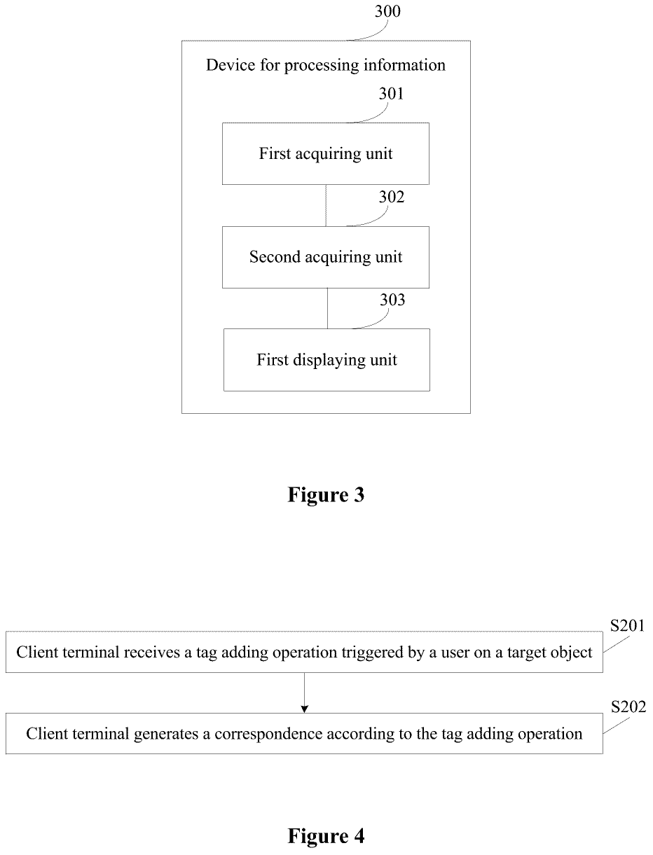

FIG. 4 is a schematic flowchart of a method for information interaction according to an embodiment of the present disclosure. This embodiment is applicable to the scenario of adding tags to target objects. The method is performed by a tagging processing device. The device is realized by software and integrated into the client terminal of the user. The client is integrated in a PC (personal computer) or a mobile terminal. As shown in FIG. 4, the method includes the following steps S201 to S202.

In S201, the client terminal receives a tag adding operation triggered by a user on a target object.

When the user adds a tag to the target object, the user performs an operation on the client terminal, thereby triggering the tag adding operation on the target object. The client terminal receives the tag adding operation triggered by the user.

In the embodiments of the present disclosure, the target object is any operational object that is to be tagged, such as cloud documents, schedules, tasks, instant messaging (IM) messages, and instant messaging groups. The cloud documents are documents or files in other formats that are stored on a server. The user downloads a cloud document from the server to the local. Alternatively, the user opens (for example, in a web browser) a cloud document by accessing the storage address of the cloud document stored on the server. Instant messaging messages are messages sent or received by users through instant messaging software. Instant messaging messages include group chat instant messaging messages and private chat instant messaging messages. Group chat instant messaging messages are messages sent by instant messaging users in an instant messaging group. Private chat instant messaging messages are messages sent by one instant messaging user to another instant messaging user via private chat. The instant messaging group includes at least three instant messaging users. Messages sent in an instant messaging group are seen by any instant messaging user in the group. The private chat means that messages sent between two instant messaging users cannot be seen by a third instant messaging user.

The tag adding operation is a slide operation or any feasible trigger operation on the tag adding control, e.g., clicking on the tag adding control. The slide operation refers to the slide track on the screen that is triggered by the user and is acquired by the client terminal. When the screen of the client terminal is a non-touch screen, the slide operation is an operation in which the user controls the cursor or moves the mouse on the screen through an external device (e.g., a mouse or a tablet) to generate a slide track. When the screen of the client is a touch screen, the slide operation is an operation in which the user moves a finger on the screen to generate a slide track.

When the slide track matches a preset track, the client terminal determines that the user triggers the tag adding operation. For example, the screen of the client terminal is a touch screen and the preset track is a circle, and the client terminal records the slide track of the finger. When detecting that the slide track is a circle, the client terminal determines that the user has triggered the tag addition operation.

The tag adding control is a control for triggering a tag adding operation. When the user triggers the tag adding control, for example, clicks or long presses the tag adding control, the client terminal determines that the user triggers the tag adding operation.

In the embodiments of the present disclosure, the user triggers the tag adding operation on the target object on the interface displaying the target object, or triggers the tag adding operation on the target object on the tag display interface displaying tags, which are respectively introduced below.

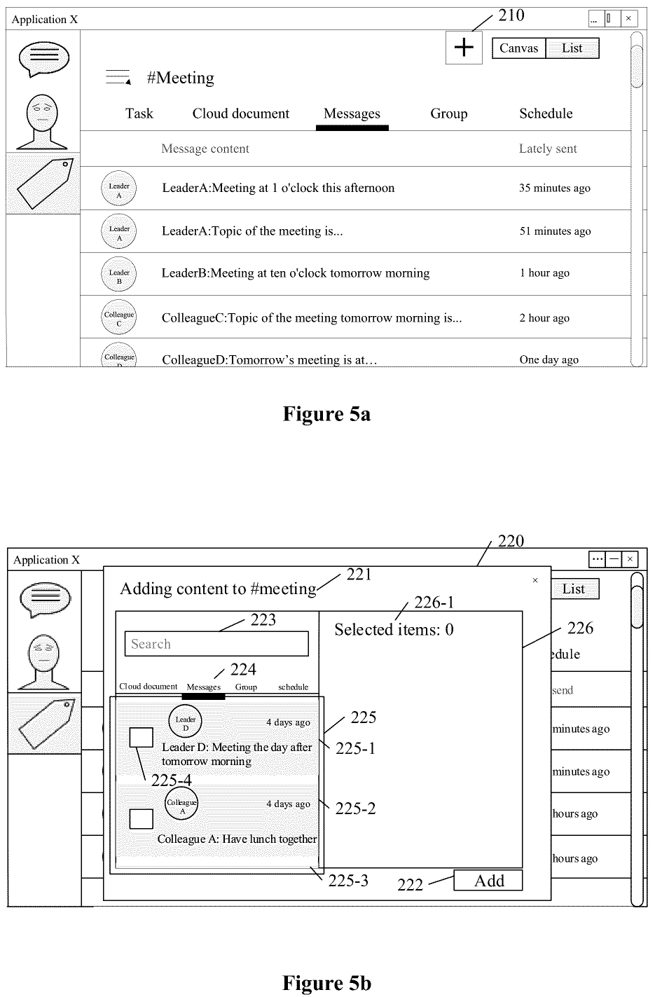

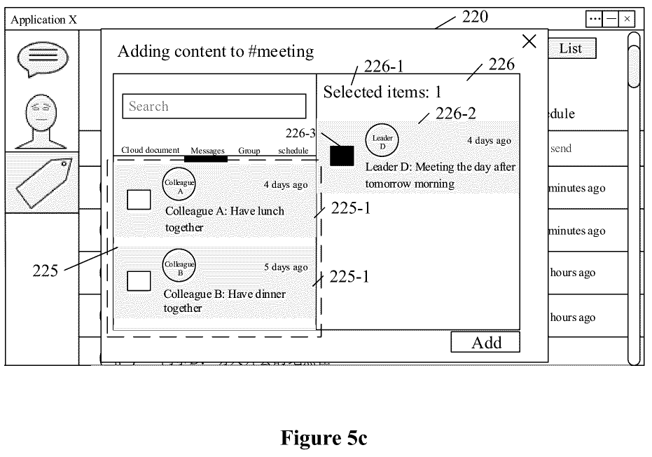

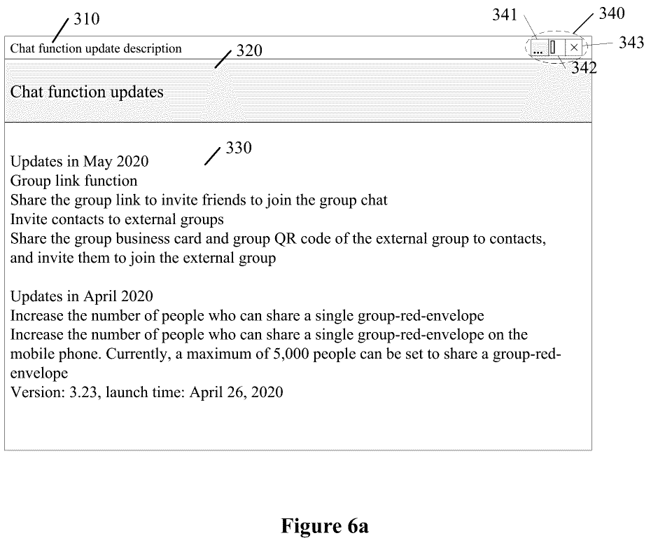

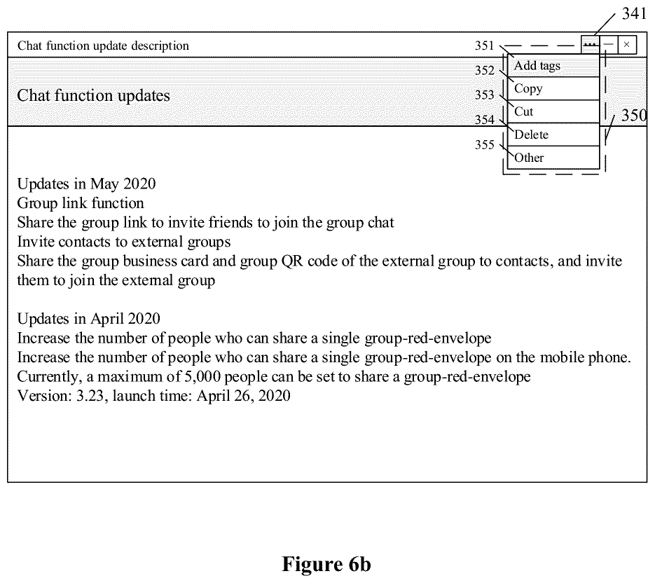

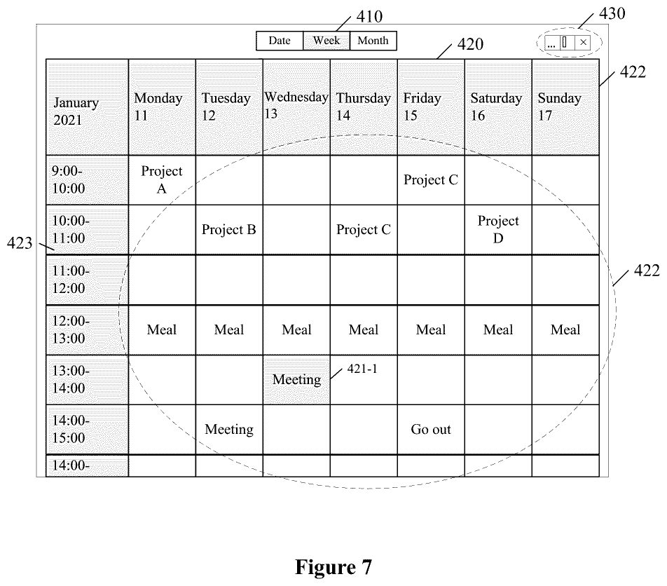

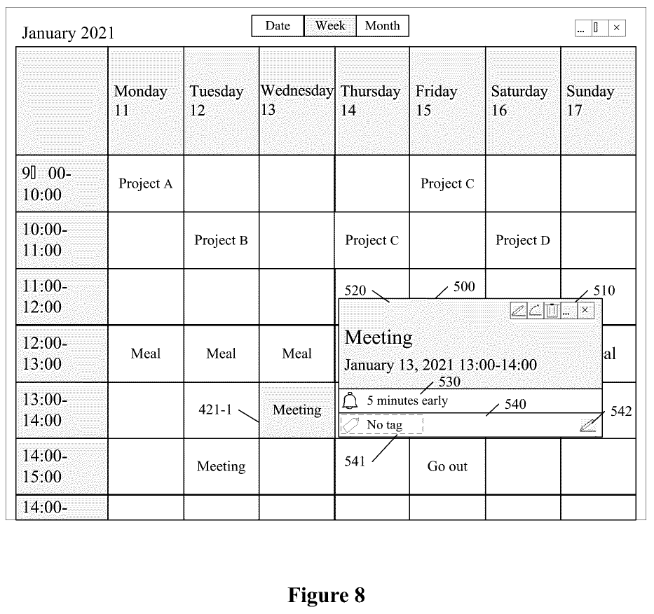

Firstly, the situation that the user triggers the tag addition operation on the target object in the interface displaying the target object is introduced. Depending on the target object, the client terminal displays or hides the tag adding control while displaying the target object. When the client terminal hides the tag adding control, the user controls the client terminal to display the tag adding control through the triggered selection operation or display operation. The selection operation means that the user selects the target object, such as clicking or long-pressing the target object. The display operation refers to that the user clicks the display control displayed on the client terminal. For the introduction of the display operation, reference is made to the introduction of the embodiments shown in FIG. 5, FIG. 6 and FIG. 10. For the introduction of the selection operation, reference is made to the introduction of the embodiments shown in FIG. 7, FIG. 8 and FIG. 9.

After the user triggers the tag adding operation, the client terminal acquires the target tag. In this embodiment of the present disclosure, the target tag is created by the user who triggers the tag adding operation or other users. Before acquiring the target tag, the client terminal determines whether the user has the permission to add a target tag to the target object. For example, a user A created a tag X, and a user B has permission to add the tag X. Then, when the user B wants to add the tag X to the target object, the client terminal determines that the user B has the permission to add the tag X, thereby adding the tag X to the target object.

To acquire the target tag, the client terminal presents multiple candidate tags. However, the user only wants to add one or a few candidate tags for the target object. Then, after the tag adding operation is triggered, the user selects the target tag, that is, selects one or more of the candidate tags as the target tag. Correspondingly, after receiving the tag adding operation triggered by the user, the client terminal receives the user-triggered selection operation, so as to determine the target tag according to the needs of the user, so as to add the target tag to the target object. Optionally, for a detailed introduction about the selection operation, reference is made to the introduction of the embodiments described later, and details are not described here. The candidate tags include tags created by the user, or tags created by other users.

In this embodiment of the present disclosure, at least one candidate tag displayed by the client terminal is arranged according to a preset rule. The preset rule includes one or more of tag creation time, tag access time, and matching degree with the keyword.

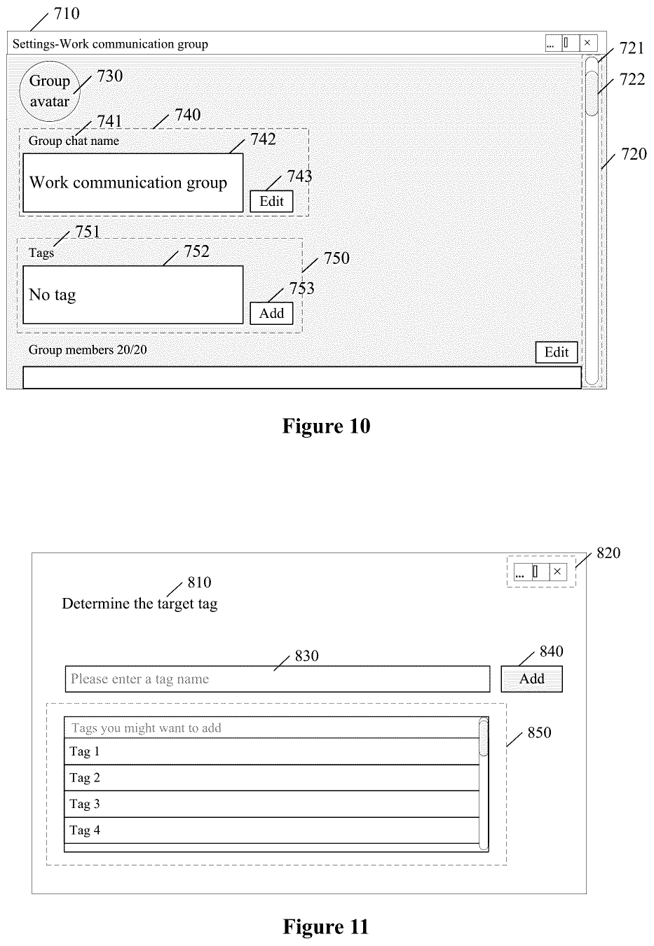

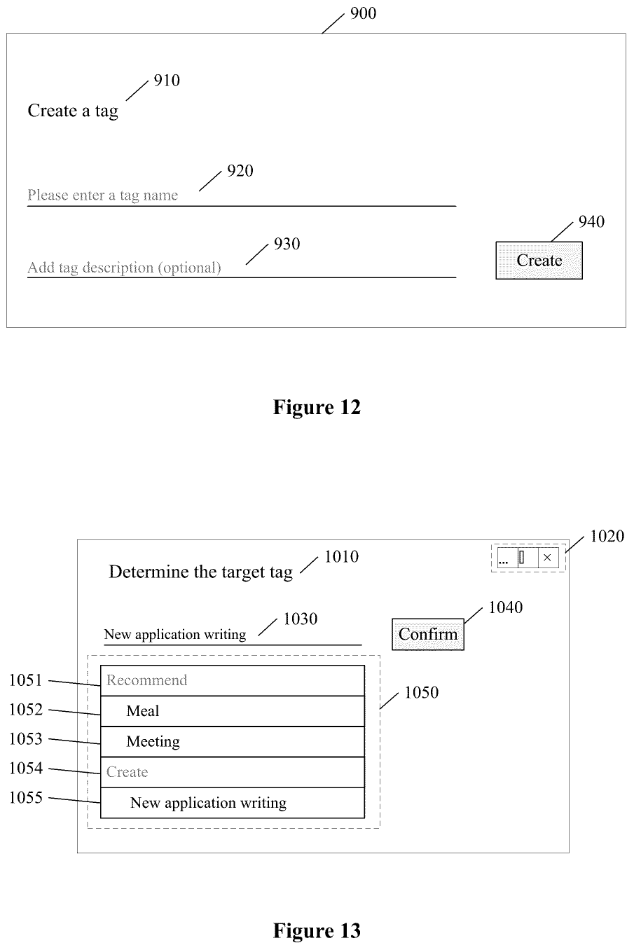

In some possible implementations, the one or more candidate tags presented by the client terminal may not include the target tag. In this case, the user triggers a tag addition operation to create a new tag as the target tag. In this way, the user creates tags autonomously and is not limited by the number of tags presented by the client terminal. Optionally, for a detailed introduction about the selection operation, reference is made to the introduction of the embodiments shown in FIG. 12 and FIG. 13 later, and details are not described here.

The following describes the situation where the user triggers the tag adding operation on the target object in the tag display interface.

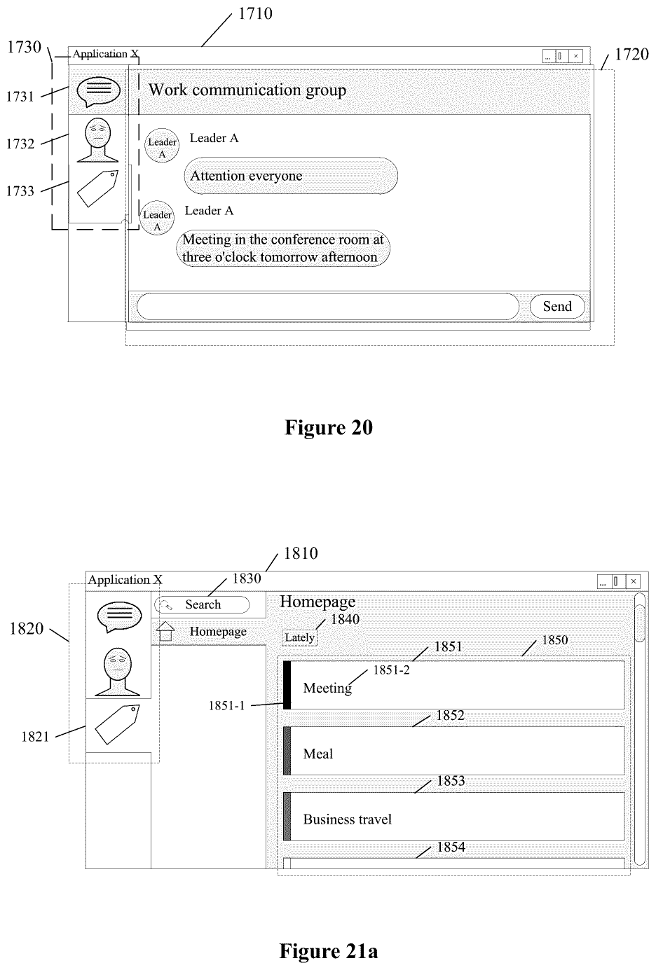

The tag display interface is used to display one or more tags, and the one or more tags correspond to the same or different target objects, so that the user can manage the tags. For the introduction of the tag display interface, reference is made to the introduction of the embodiment shown in FIG. 20, which will not be described in detail here.

Since the tag display interface displays multiple tags, the user determines the target tag corresponding to the tag adding operation before triggering the tag adding operation. For example, the user selects and clicks the target tag from multiple tags displayed on the tag display interface. Correspondingly, the client terminal jumps to a tag details page corresponding to the target tag based on the click operation performed by the user.

On the tag details page corresponding to the target tag, the user selects one or more target objects that need to be added with the target tag, thereby triggering the tag adding operation for these target tags.

In a possible implementation, the user triggers an adding operation to control the client to display at least one candidate object, and then selects one or more candidate objects from the at least one candidate object as the target object. Correspondingly, the client receives the adding operation triggered by the user on the target tag, and displays at least one candidate object according to the adding operation.

As shown in FIG. 5a, when wanting to add an object with the target tag of “meeting”, the user triggers the adding operation by clicking the adding control 210 in the display area. After receiving the adding operation triggered by the user, the client terminal displays the interface shown in FIG. 5b.

FIG. 5b shows an adding operation area 220. The adding operation area 220 includes a title display area 221, an adding control 222, a search box 223, a tag domain display area 224, a candidate object display area 225 and a target object display area 226.

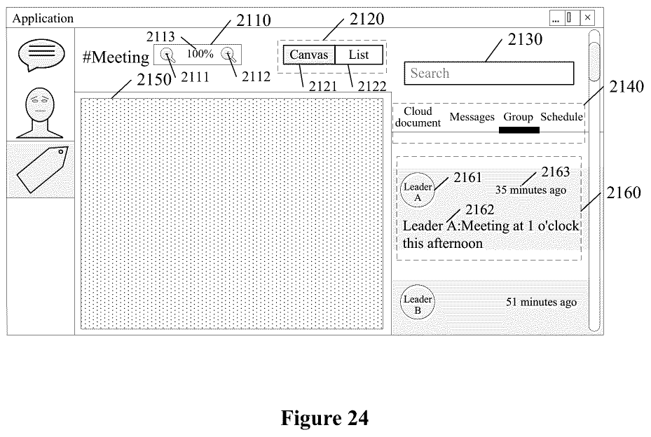

The title display area 221 is configured to prompt the user that the adding operation area 220 is configured to select the target object that needs to be added with the tag “meeting”. The adding control 222 is configured to trigger the tag adding operation. The search box 223 is configured to receive keywords input by the user, and then search for target objects corresponding to the keywords. The tag domain display area 244 is configured to display the tag domain from which the object corresponding to the summary information originates. For a detailed introduction about the tag domain and the tag domain display area 244, reference is made to the embodiment shown in FIG. 23, which is not described in detail here. In the embodiments shown in FIG. 5b and FIG. 5c, the displayed tag domains are instant messaging messages, that is, the objects displayed in the candidate object display area 225 and the target object display area 226 belong to instant messaging messages.

The candidate object display area 225 is configured to display at least one candidate object. In the embodiment shown in FIG. 5b, the candidate objects are displayed in the form of cards. The candidate object display area 225 includes a first candidate object card 225-1, a second candidate object card 225-2, and a third candidate object card 225-3 that is not completely displayed. The candidate object card includes one or more of the basic information of the candidate object, the user to which the candidate object belongs, the receiving time of the candidate object, and the information block of the candidate object. For the introduction of the candidate object card, reference is made to the following introduction of the canvas card, which is not detailed here.

The target object display area 226 is configured to display at least one target object, and the display method is the same as that of the candidate object display area 225. In the embodiment shown in FIG. 5b, the target object display area 226 further includes a statistical information display area 226-1. The statistical information display area 226-1 is configured to display statistical information of target objects, for example, the number of target objects selected by the user.

In the embodiments of the present disclosure, the user selects one or more candidate objects as the target object. For example, in the interface shown in FIG. 5b, the user selects a candidate object displayed in any candidate object card as a target object. In the embodiments of the present disclosure, the user determines the candidate object as the target object by clicking the checkbox of the candidate object card, for example, clicking the checkbox 225-4. Optionally, before being selected as the target object, the checkbox corresponding to the candidate object is white.

After the user determines the candidate object presented in the candidate object card 225-1 as the target object, the interface displayed by the client terminal is as shown in FIG. 5c. Based on the selection operation performed by the user, the client determines that the instant messaging message “meeting in the morning the day after tomorrow” sent by a leader D belongs to the target object to which the tag “meeting” is to be added. Then, the client terminal adds the target object card 226-2 in the target object selection area 226 to display the basic information of the target object of the instant messaging message “meeting in the morning the day after tomorrow”, and modifies the display content of the statistical information display area 226-1. Correspondingly, the content displayed on the first candidate card 225-1 and the second candidate card 225-2 in the candidate object display area 225 change. Optionally, the color of the checkbox of the target tag is different from the color of the checkbox of the candidate tag. For example, in the embodiment shown in FIG. 5c, the color of the checkbox 226-3 of the target tag is black.

After selecting one or more target objects from the candidate objects, the user triggers the tag adding operation by clicking the tag adding control 222. Correspondingly, the client terminal continues to perform S202 after receiving the tag adding operation triggered by the user. For the description of other parts in FIG. 5a, FIG. 5b and FIG. 5c, reference is made to the embodiment shown in FIG. 23, which is not detailed here. It should be noted that, the method described in this embodiment can be combined with the method described in the foregoing embodiments in case of no conflict. Moreover, solutions obtained by combinations are also covered within the protection scope of the embodiments of the present disclosure.

In S202, the client terminal generates a correspondence according to the tag adding operation.

After receiving the tag adding operation triggered by the user on the target object, the client terminal generates the correspondence between the target object and the target tag according to the tag adding operation.

In the embodiments of the present disclosure, the correspondence includes the correspondence between the target tag and the information block of the target object. The information block is generated based on the target object. The information block includes summary information of the target object, for briefly describing the target object. For example, when the target object is a cloud document, the information block of the target object includes summary information of the cloud document. The summary information of the cloud document includes the title, the author, the release time, etc. of the cloud document. When the target object is an instant messaging message, the summary information of the target object includes the sender of the instant messaging message and the first n characters of the instant messaging message, where n is an integer greater than or equal to 1.

The information block further includes display information of the target object. The display information is used in the display of the target object. For example, when the target object is a cloud document, the display information of the target object includes a link of the cloud document. The entire content of the cloud document can be displayed based on this link. When the target object is an instant messaging message, the display information of the target object includes the entire content of the instant messaging message corresponding to the target tag (without opening the window of the instant messaging software), or a calling link of the instant messaging message. The entire content of the instant messaging message corresponding to the target tag can be displayed in the window of the instant messaging software through the calling link.

In the embodiments of the present disclosure, after receiving the tag adding operation triggered by the user and before generating the correspondence between the information block and the tag, the client terminal determines the information block of the target object based on the target object. For example, the client terminal extracts summary information of the target data and/or provides a unified structure package for the target object. After converting the target object into the information block, the client terminal establishes the correspondence between the information block and the tag.

In some embodiments, the correspondence further includes a correspondence between the target tag, the information block of the target object, and the information of the user who triggers the tag adding operation. The information of the user includes one or more of a user name and a tag adding time. In this way, when displaying the target tag or the target object, the user sees not only the target tag and the target object but also which user added the target tag for the target object and when the target tag was added.

In the embodiments of the present disclosure, the correspondence is generated by the client terminal or is generated by a server under the control of the client terminal. When the correspondence is generated by the client terminal, the client terminal performs S103-1 (not shown in the drawings). When the correspondence is generated by the server under the control of the client terminal, the client terminal performs S103-2 (not shown in the drawings).

In S103-1, the client terminal generates a correspondence.

If the correspondence is generated by the client terminal, the client terminal stores the correspondence between the target tag and the information block of the target object. After the correspondence is generated, the client terminal sends the correspondence to the server, so that other client terminals or servers know the correspondence between the target tag and the information block of the target object in certain application scenarios.

In S103-2, the client terminal sends the target object and the target tag to the server.

If the correspondence is generated by the server, the client terminal sends the target object and the target tag to the server. After receiving the target object sent by the client terminal, the server determines the information block of the target object based on the target object, and establishes the correspondence between the information block of the target object and the target tag.

It should be noted that sending the target object and the target tag from the client terminal to the server is only a possible implementation of the present disclosure. In some other embodiments, the client terminal acquires and sends the target tag and the information block of the target object to the server, so that the server generates the correspondence between the target tag and the information block of the target object, which is not limited in this embodiment of the present disclosure.

In some embodiments, after determining the target tag, the client terminal displays prompt information. The prompt information indicates that adding the target tag to the target object is completed. After seeing the prompt information, the user knows that the client terminal has added a target tag for the target object. Optionally, the prompt information is an icon or a text message.

In some embodiments, the user triggers the tag viewing operation after tagging the target object with the target tag. After receiving a user-triggered tag viewing operation on the target object, the client terminal displays the target tag according to the viewing operation. In this way, the user sees the tag added to the target object, thereby determining whether a wrong tag is added to the target object.

In some embodiments, the client terminal further displays a content viewing control after generating the correspondence. When the user clicks on the content viewing control or triggers a viewing operation on the content viewing control in other ways, the client terminal searches for the correspondence according to the viewing operation to determine and display the information block corresponding to the target tag. The information block includes, for example, an information block of the target object. When the information block includes the summary information of the object, the summary information of the object corresponding to the target tag is displayed.

In response to the trigger operation performed by the user on the information block of the target object, the client terminal may jump to an interface including the target object, or may display the target object. In a possible embodiment, in response to the trigger operation performed by the user on the summary information of the target object, the client terminal may jump to the interface of the target object or may display the target object according to the aforementioned display information of the target object.

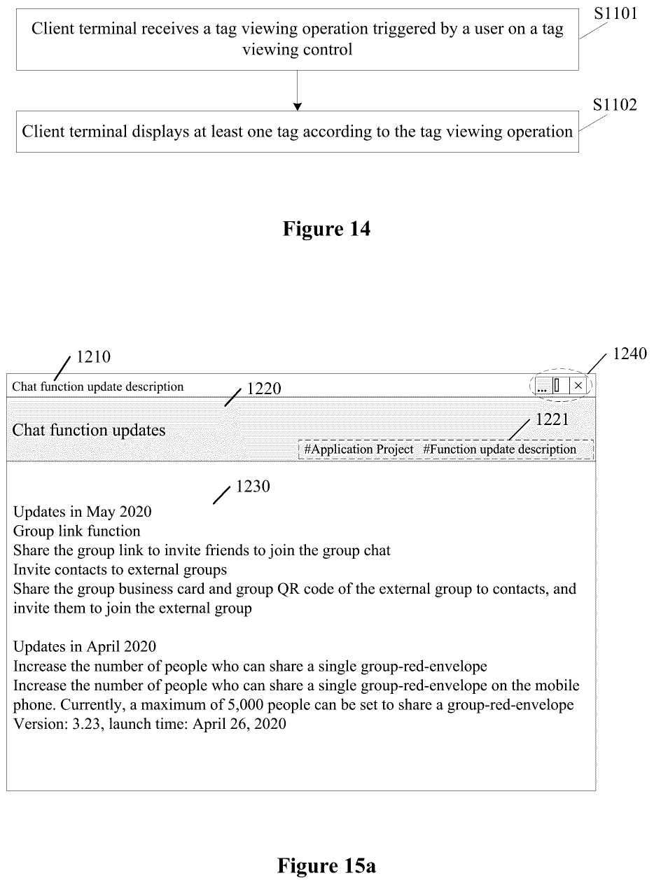

For other methods of displaying the tag of the target object, reference is made to the introduction of the embodiment shown in FIG. 14, which is not described in detail here.

In addition, in the embodiments of the present disclosure, the user can also delete the target tag of the target object. The user triggers a delete operation on the target tag of the target object. After receiving the delete operation, the client terminal deletes the target tag of the target object according to the delete operation, for example, deletes the correspondence between the target tag and the target object.

In the embodiments of the present disclosure, the user can add a tag to the target object. Correspondingly, the client terminal determines, according to the tag adding operation triggered by the user on the target object, the tag that the user wants to add to the target object and then acquires the correspondence between the target tag and the information block of the target object. In this way, when the user wants to view the object corresponding to a tag, the client terminal searches for the object (including the target object) corresponding to the tag according to the correspondence and displays the find object. In this way, the client terminal adds a tag to the target object based on the tag adding operation, thereby distinguishing the target object from other objects, so that the user can quickly find the desired object. Therefore, the user can flexibly manage objects.

In addition, in the embodiments of the present disclosure, the correspondence includes the correspondence between the tag and the information block of the target object. In this way, compared with the traditional bookmark method, the client can further display the summary information of the target object to the user according to the tag and the information block of the target object. In this way, the amount of information that can be seen by the user is increased, so that the user can find the desired object faster.

Further, in the embodiments of the present disclosure, the target object is one of the operational objects to which tags can be added, such as cloud documents, schedules, tasks, instant messaging messages, and instant messaging groups. That is, the user may add the same tag to target objects in different tag domains, and view target objects in different tag domains belonging to the tag. In this way, tags can be assigned across tag domains, improving the flexibility of management. Other introductions about tag domains will be described below and thus are not detailed here.

In the embodiments of the present disclosure, different target objects belonging to different tag domains are extracted as information blocks, and a correspondence between information blocks and tags is generated. In this way, the target objects from different tag domains are extracted as information blocks to ensure homogeneous modeling and tagging consistency of heterogeneous information entities when they flow across business applications and domains. This supports cross-business information aggregation and secondary consumption scenarios. That is, information chunking is the uniform encapsulation of objects from different tag domains (i.e., heterogeneous information entities), so that the required operations can be uniformly tagged without caring about the different structures of the contents of different domains. If there is no encapsulation, heterogeneous entities in different domains may require relatively high integration costs if there is no homogeneous solution.

According to the above introduction, it can be seen that the target object is one of the operational objects to be tagged, such as cloud documents, schedules, tasks, instant messaging messages, and instant messaging groups. In the embodiments of the present disclosure, the manner in which the user triggers the tag adding control varies with different target objects. The following describes how the user triggers the tag adding operation by taking the cloud document, the schedule, the task, the instant messaging message, and the instant messaging group as examples, respectively.

Firstly, how the user triggers the tag adding operation when the target object is a cloud document is introduced. When the cloud document is displayed by the client terminal, the client terminal displays the name, the title, the text and the operation control of the cloud document on the screen.

In a first possible embodiment, the operation control displayed on the client screen includes a tag adding control. When the user clicks the tag adding control or performs other triggering operations on the tag adding control, the client terminal determines that the user has triggered the tag adding operation for the displayed cloud document.

In a second possible embodiment, the tag adding control is hidden in the screen, and the user controls the client terminal to display the tag adding control by triggering a display operation.

As shown in FIG. 6a, when the client terminal displays a cloud document, the display area includes a name display area 310, a title display area 320, a text display area 3230 and an operation control set 340. The name display area 310 is configured to display the name of the cloud document. The title display area 320 is configured to display the title of the text of the cloud document. The text display area 330 is configured to display the text of the cloud document. The operation control set 340 includes a display operation control 341, a minimize operation control 342 and a close operation control 343, without a tag adding control.

The close operation control 343 is used to close the cloud document. For example, when the user clicks the close operation control 343, the client terminal closes the cloud document. The minimize operation control 342 is configured to minimize the cloud document. For example, when the user clicks the minimize operation control 3242, the client terminal minimizes and displays the cloud document. The display operation control 341 is configured to display a hidden operation control. In the embodiment of the present disclosure, the hidden operation control includes an operation trigger control.

In order to add a tag to the cloud document, the user clicks on the display operation control 341, or performs other trigger operations on the display operation control 3241. After detecting that the display operation control 341 is triggered, the client terminal displays the previously hidden operation control on the screen. As shown in FIG. 6b, when the user clicks the display operation control 341, the client terminal displays the previously-hidden control set 350. The previously-hidden control set 350 includes a tag adding control 351, a copy control 352, a cut control 353, a delete control 354 and a jump control 355. The tag adding control 351 is configured to trigger the tag adding operation. The copy control 352 is configured to copy the cloud document. The cut control 353 is configured to copy the cloud document and delete the original cloud document after the cloud document in the clipboard is overwritten. The delete control 354 is configured to delete the cloud document. The jump control 355 is configured to jump to other interfaces, so that the user can perform other operations on the cloud document.

Optionally, there is prompt information on the tag adding control, for prompting the user that the control is for adding a tag. As shown in FIG. 6b, the prompt information of the tag adding control 351 is “add tag”, and the prompt information of the copy control 352 is “copy”.

It should be noted that, the method described in this embodiment can be combined with the method described in the foregoing embodiments if there is no conflict. Moreover, solutions obtained by combinations are also covered within the protection scope of the embodiments of the present disclosure.

The following describes how the user triggers the tag adding operation when the target object is a schedule. When the calendar is displayed by the client terminal, the client terminal uses the calendar as the background, and adds a mark on the position corresponding to the schedule on the calendar according to the time information corresponding to the schedule, so as to remind the user of the schedule information corresponding to the time.

In a first possible embodiment, the client terminal displays a tag adding control on the screen. When the user clicks the tag adding control or performs other trigger operations on the tag adding control, the client terminal determines that the user triggers the tag adding operation on the displayed schedule.

In a second possible embodiment, the tag adding control is hidden in the screen. The user controls the client terminal to display the tag adding control by triggering the selection operation.

As shown in FIG. 7, when the client terminal displays the schedule, the display area 400 includes a display mode control 410, a calendar display area 420 and an operation control set 430. The display mode control 410 is configured to switch the division unit of the calendar. For example, in the embodiment shown in FIG. 7, the date is divided in units of week, and the schedule within a week is displayed in the display area 400. When the user switches the display mode through the display mode control 410, the client terminal also displays the schedule in units of day or month.

When the days are divided into weeks, the calendar display area 420 includes multiple schedule display areas 421, a date marking area 422 and a time marking area 423. The schedule display area 421 includes at least one schedule display element. Each schedule display element corresponds to a date and a time period, and is configured to display the schedule of the time period in the date. Optionally, the schedule display elements belonging to the same column correspond to respective time periods in the same date. The schedule display elements belonging to the same row belong to the same time period in respective dates. The date mark area 422 is configured to mark the date corresponding to each row of schedule display elements. The time marking area 423 is configured to mark the time period corresponding to each row of schedule display elements.

As shown in FIG. 7, the schedule display area 421 includes 7 columns of schedule display elements, which respectively correspond to the seven days from Jan. 11, 2021 to Jan. 17, 2021. The schedule display element in the first column and the first row corresponds to the time period of 9:00-10:00 on Jan. 11, 2021. The schedule display element includes a schedule of “Project A”, indicating that the schedule for 9:00-10:00 on Jan. 11, 2021 is Project A.

To add a tag to the schedule, the user selects the schedule display element corresponding to the schedule to control the client terminal to display the tag adding control. For example, when adding a tag to the schedule “13:00-14:00 p.m., Jan. 13, 2021”, the user selects the schedule display element 421-1. For example, the user clicks on the schedule display element 421-1 on the client screen, thereby triggering the selection operation. After receiving the selection operation of the tag adding control triggered by the user, the client terminal displays the hidden interface. This hidden interface includes a tag adding control. As shown in FIG. 8, when the user selects the schedule display element 421-1, the client terminal displays a hidden interface 500. The hidden interface 500 includes an operation control set 510, a schedule information display area 520, a reminder time display area 530 and a tag adding area 540.

The schedule information display area is configured to display the basic information of the schedule. For example, in the embodiment shown in FIG. 8, the schedule information display area 520 displays that the theme of the schedule is a meeting, and the time is 13:00-14:00 pm on Jan. 13, 2021. The reminder time display area is configured to display the reminder time of the schedule. The reminder time indicates how long the client terminal reminds the user before the schedule starts. For example, in the embodiment shown in FIG. 8, the reminder time display area 520 displays that the client terminal will remind the user five minutes before the start of the schedule. The tag adding area 540 includes a tag display area 541 and a tag adding control 542. The tag display area 541 is configured to display the existing tags of the schedule. The tag adding control 542 is configured to trigger the tag adding operation.

In the embodiments shown in FIG. 7 and FIG. 8, in order to add a tag to the schedule “meeting” corresponding to the schedule display element 421-1, the user first selects the schedule display element 421-1 and then clicks the tag adding control 542 on the hidden interface.

In other embodiments, the user controls the client terminal to add controls by triggering a display operation, which is not described in detail here.

It should be noted that, the method described in this embodiment may be combined with the method described in the foregoing embodiments if no conflict. Moreover, solutions obtained by combinations are also covered within the protection scope of the embodiments of the present disclosure.

The following describes how the user triggers the tag adding operation when the target object is an instant messaging message.

According to the foregoing introduction, the instant messaging message includes one or more of group chat instant messaging messages and private chat instant messaging messages. The following takes the instant messaging message as an example of a group chat instant messaging message for illustration.

In a first possible embodiment, the client terminal displays a tag adding control on the screen. When the user clicks on the tag adding control or performs other triggering operations on the tag adding control, the client terminal determines that the user triggers a tag adding operation on the displayed group message.

In a second possible embodiment, the tag adding control is hidden in the screen, and the user controls the client terminal to display the tag adding control by triggering a selection operation, which will be described in detail below.

When the user views the group chat instant messaging message on the client terminal, the client terminal displays the group chat instant messaging message and related information of the instant messaging group. As shown in FIG. 9, when the client terminal displays group chat instant messaging messages, the display area 600 includes a title display area 610, a message display area 620 and an operation area 640. The title display area 610 is configured to display the basic information of the instant messaging group. For example, in the embodiment shown in FIG. 9, the title display area 610 displays the group name “work communication group” of the instant messaging group and the group portrait. Optionally, the title display area 610 further includes a jump control 611 for jumping to another interface. For the detailed introduction of the jump control 611, reference is made to the description of the following embodiments, which is not detailed here.

The message display area 620 is configured to display group chat instant messaging messages. Optionally, the client terminal displays the text of the message and the corresponding user information together when displaying the group chat instant messaging message. For example, in the embodiment shown in FIG. 9, the group chat instant messaging message 621 includes an avatar display area 621-1, a identification display area 621-2 and a text display area 621-3. The avatar display area 621-1 is configured to display the avatar of the user who sent the group chat instant messaging message. The identification display area 621-2 is configured to display the identification of the user who sent the group chat instant messaging message, for example, the ID or nickname of the user. The text display area 621-3 is configured to display the text of the group chat instant messaging message sent by the user. In the embodiment shown in FIG. 9, the text of the group message 621 is “attention everyone”.

The operation area 640 includes an input box 641 and a send control 642. The input box 641 is configured to input group chat instant messaging messages. The send control 642 is configured to send the group chat instant messaging message to be sent in the input box 641.

To add a tag to a group chat instant messaging message, the user selects the group chat instant messaging message. After receiving the selection operation of the instant messaging message, the client terminal displays the control set. In some embodiments, the control set includes a tag adding control. Correspondingly, the user adds a tag to the selected group chat instant messaging message by triggering the tag adding control. The user may also select multiple instant messaging messages at one time, and adds tags to the multiple instant messaging messages. In this case, after receiving the selection operation performed by the user on multiple instant messaging messages, the client terminal displays the above control set.

In other embodiments, the control set includes no tag adding control. The user controls the client terminal to display the tag adding control by triggering the display operation. Details are given below.

As shown in FIG. 9, to add a tag to the group chat instant messaging message 630, the user first selects the group chat instant messaging message 630. For example, the user clicks the position corresponding to the group chat instant messaging message 630 on the screen. In response to the selection operation of the user, the client terminal displays the control set 640. The control set 640 includes a reply control 641, a like control 642 and a display control 643. The reply control 641 is configured to reply a message. When clicking on the reply control 641, the user replies to the group chat instant messaging message 630. The like control 642 is configured to like the instant messaging message 630 of the group chat. When the user clicks the like control 642, the client terminal likes the group chat instant messaging message 630. The display operation control 643 is configured to display a hidden operation control. When the user clicks the display operation control 643, the client terminal displays the hidden control set 650 to the user.

The hidden control set 650 includes a tag adding control 651, a deleting control 652, a multi-select control 653 and a jump control 654. The tag adding control 651 is configured to trigger a tag adding operation. The delete control 652 is configured to delete the local chat history of the group chat instant messaging message 630 in the client terminal. The multi-selection control 653 is configured to select other group chatting instant messaging messages while selecting the instant messaging group information 630. The jump control 654 is configured to jump to another interface, so that the user can perform other operations on the group chat instant messaging message 630.

Optionally, there is prompt information on the tag adding control to remind the user that the tag adding control is configured to trigger a tag adding operation. As shown in FIG. 9, the prompt information of the tag adding control 651 is “add tag”. The prompt information of the delete control 652 is “delete”.

When the instant messaging message is a private instant messaging message, the user uses the same or similar process to control the client terminal to display the tag adding control and trigger the tag adding operation, which will not be described in detail here.

It should be noted that, the method described in this embodiment may be combined with the method described in the foregoing embodiments without conflict. Moreover, solutions obtained by combinations are also covered within the protection scope of the embodiments of the present disclosure.

The following describes how the user triggers the tag adding operation when the target object is an instant messaging group.

In a first possible embodiment, the client terminal displays a tag adding control on an interface including an instant messaging group, so that the user triggers a tag adding operation through the tag adding control. Here, the interface including the instant messaging group is, for example, an interface displaying group chat instant messaging messages or an interface including information flow of the instant messaging group, which is not limited here.

In a second possible embodiment, the chat interface of the instant messaging group includes no tag adding control. In this case, the user controls the client terminal to display the tag adding interface by triggering the display operation. For example, in the embodiment shown in FIG. 9, the chat interface 600 of the instant messaging chat group includes no tag adding control configured to add a tag to the group. The user clicks the jump control 611 to control the client terminal to display the setting interface of the instant messaging group. The setting interface includes a tag adding control configured to trigger a tag adding operation.

As shown in FIG. 10, when the setting interface of the instant messaging group is displayed, the display area 700 of the client terminal includes a title display area 710, a position change control 720, an avatar change control 730, a name change control 740 and a tag adding control 750.

The title display area 710 is configured to display basic information and basic operation controls of the setting interface. For example, in the embodiment shown in FIG. 10, the title display area 710 shows that the name of the setting interface is “settings-work communication group”, which means that the setting interface is configured to set the relevant information of the instant messaging group whose group name is “work communication group”.

The position change control 720 is configured to change the relative position of the current interface and the display area 700. As shown in FIG. 10, the position change control 720 includes a sliding slot 721 and a slider control 722. The slider control 722 can move up and down in the sliding slot 721 to change the relative position of the setting interface and the display area 700.

The avatar change control 730 is configured to display the avatar of the instant messaging group and change the avatar of the instant messaging group. For example, when wanting to change the group avatar of the instant messaging group “work communication group”, the user clicks on the position corresponding to the avatar change control 730 on the client terminal screen, thereby triggering the avatar replacement operation to change the group avatar of the instant messaging group.

The name change control 740 is configured to display the group name of the instant messaging group, and is also configured to change the name of the instant messaging group. As shown in FIG. 10, the name change control 740 includes annotation information 741, a name display area 742 and an editing control 743. The annotation information 741 is configured to prompt the user that the name display area 742 displays the name of the instant messaging group. The name display area 742 is configured to display the name of the instant messaging group. The editing control 743 is configured to trigger a name change operation. For example, when wanting to modify the group name of the instant messaging group “work communication group”, the user clicks the editing control 743 in the name change control 740 on the client terminal screen to trigger the name change operation to change the group name of the instant messaging group.

The tag adding control 750 is configured to add a tag to an instant messaging group, display a tag corresponding to an instant messaging group, and change a tag corresponding to an instant messaging group. As shown in FIG. 10, the tag adding control 750 includes tag information 751, a tag display area 752 and an editing control 753. The annotation information 751 is configured to prompt the user that the content displayed in the tag display area 752 is the tag corresponding to the instant messaging group. The tag display area 752 is configured to display the tag corresponding to the instant messaging group. Optionally, when the instant messaging group has no tag, the tag display area 742 displays “no tag”. The editing control 753 is configured to trigger a tag adding operation. Optionally, when the instant messaging group has a tag, the editing control 753 is configured to trigger a tag delete operation or a tag change operation.

In some embodiments, the editing control 753 includes an indication message to prompt the user that the editing control 753 is configured to trigger a tag adding operation, or trigger a tag deleting operation or a tag changing operation. For example, when the instant messaging group has no tag, the indication message of the editing control 753 is “add”, to prompt the user that the editing control 753 is configured to trigger the tag adding operation. When the instant messaging group has a tag, the indication message of the editing control 753 is “add”, so as to prompt the user that the editing control 753 is configured to trigger a tag adding operation, a tag changing operation or a tag deleting operation.

It should be noted that, the method described in this embodiment may be combined with the method described in the foregoing embodiments if there is no conflict. Moreover, solutions obtained by combinations are also covered within the protection scope of the embodiments of the present disclosure.

The above describes the method for the user to trigger the tag adding operation on the target object. In the embodiment of the present disclosure, after receiving the tag adding operation triggered by the user, the client terminal receives the selection operation triggered by the user and determines the target tag according to the selection operation.

Before receiving the selection operation triggered by the user, the client terminal displays at least one candidate tag according to the tag adding operation, so that the user can browse the candidate tags on the screen of the client terminal and select a target tag from the candidate tags. For example, the user clicks on the position corresponding to the target tag on the client terminal screen. After detecting that the position corresponding to a candidate tag is clicked, the client terminal determines that the candidate tag is the target tag selected by the user. The client terminal displays at least one candidate tag in a list. The user browses the list displayed on the client terminal, and selects one or more candidate tags from the list according to actual needs as target tags. In this way, the client terminal determines the target tag corresponding to the target object according to the click operation performed by the user, thereby adding the target tag to the target object.

In an actual application scenario, the number of candidate tags may be large, resulting in a long time for the user to select a target tag from the candidate tags. In order to solve this problem, the client terminal displays a tag input box, and determines the target tag according to the user input.

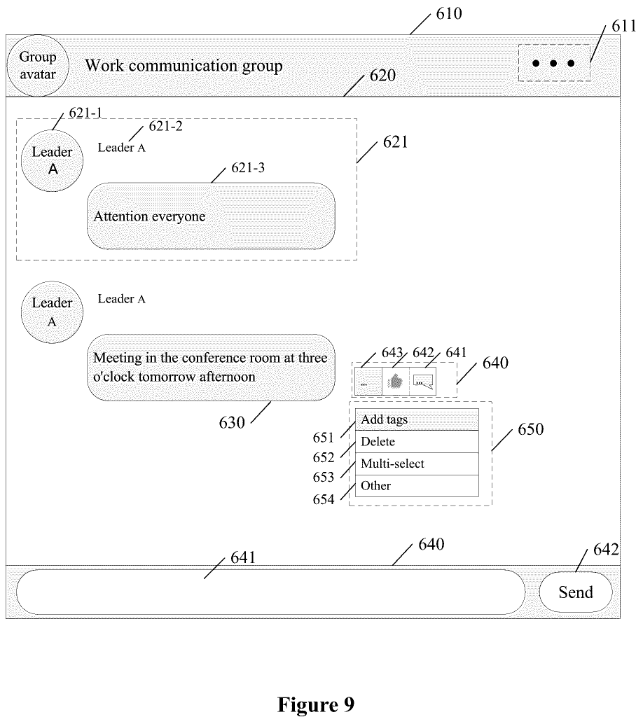

As shown in FIG. 11, when the client terminal displays the tag input box, the display area 800 includes a title display area 810, an operation control set 820, a tag input box 830, a tag adding control 840 and a candidate tag display area 850. The title display area 810 is configured to display basic information of the interface. For example, in the embodiment shown in FIG. 11, the title display area 810 displays “determine target tag”, indicating that the interface is configured to determine the target tag the from candidate tags. The operation control set 820 is similar to the operation control set 240 in FIG. 2, and thus is not described in detail here. The tag input box 830 is configured to receive keywords inputted by the user. The tag adding control 840 is configured to select the target tag.

The candidate tag display area 850 is configured to display at least one candidate tag matching the keyword inputted by the user in the tag input box 830. When there are multiple candidate tags, the multiple candidate tags are sorted in descending order of matching degree with the keyword. As shown in FIG. 11, four candidate tags, namely, a tag 1, a tag 2, a tag 3 and a tag 4, are displayed in the candidate tag display area 850. Then, the tag 1 is the candidate tag with the highest matching degree to the keyword, and the matching degree of the tag 2 to the keyword is lower than the tag 1 and higher than the tag 3 and the tag 4. In other embodiments, the client terminals may sort the candidate tags according to tag creation time or tag access time, which is not limited in this embodiment of the present disclosure.

Optionally, the tag adding control 840 is located in the candidate tag display area. In this way, when the user clicks any candidate tag in the candidate tag display area, the tag adding control 840 is triggered, and the client terminal receives the selection operation performed by the user on the target tag.

If the number of candidate tags is small, the client terminal can display all candidate tags. Correspondingly, the user selects the tag to be added to the target object from the tags displayed on the client terminal, and performs the selection operation to add the tag to the target object.

The client terminal displays candidate tags in the form of cards. When the client terminal displays all candidate tags, the candidate tag display area 850 includes tag cards. Each tag card has its own border and includes name information. The name information displays the name of the tag corresponding to the tag card. For example, the name of the tag corresponding to the tag card is “work”.

The user determines the tag cards to be added according to the name information of the tag cards, and selects these tag cards. After selecting the tag, the user triggers the tag adding control 840, so that the client terminal determines the tag that the user wants to add to the target object.

In the embodiments of the present disclosure, after the user selects a tag card, the client terminal changes the background color of the tag card. For example, the background color of a tag card changes to indicate that the user wants to add that tag to the target object.

It should be noted that, the method described in this embodiment may be combined with the method described in the foregoing embodiments if there is no conflict. Moreover, solutions obtained by combinations are also covered within the protection scope of the embodiments of the present disclosure.

The above embodiments introduce the method for information interaction. In this method for information interaction, the user adds a tag to the target object. How the tag is obtained is introduced below. That is, the tag described above may be obtained through the method for creating a tag described below.

In this embodiment of the present disclosure, the user creates a tag through the tag creation control in the tag creation interface, or creates a tag when adding a tag.

Firstly, it is introduced that the user creates a tag through the tag creation control in the tag creation interface.

In order to create a tag in the tag creation interface, the user first triggers the client terminal to jump to the tag creation interface. For example, the user clicks the jump control or enters a URL to jump to the tag creation interface. After the tag creation interface is displayed, the user enters a tag name in the interface and controls the client terminal or server to create a tag by triggering the tag creation control.

As shown in FIG. 12, the tag creation interface 900 includes a title display area 910, a tag name input box 920, a tag detail input box 930 and a tag creation control 940. The title display area 910 is configured to display basic information of the interface. For example, in the embodiment shown in FIG. 12, the title display area 910 displays “new tag”, indicating that the interface is configured for creating a tag. The tag name input box 920 is configured to receive a tag name inputted by the user. The tag details input box 930 is configured to receive tag details inputted by the user. The tag creation control 940 is configured to trigger a tag creation operation.

After inputting a tag name in the tag name input box 920, the user triggers the tag creation control 940, thereby triggering a tag creation operation. After receiving the tag creation operation triggered by the user, the client terminal acquires the content inputted by the user in the tag name input box 920 as the name of the newly created tag. Optionally, the user may also determine the content inputted in the tag detail input box 930 as a detailed description of the newly created tag.

Optionally, as shown in FIG. 12, before the user enters data, the tag name input box 920 and the tag detail input box 930 each display prompt information to prompt the user what information needs to be input in the input box.

It should be noted that, the method described in this embodiment may be combined with the method described in the foregoing embodiments if there is no conflict. Moreover, solutions obtained by combinations are also covered within the protection scope of the embodiments of the present disclosure.

Next, the method for creating a tag when adding a tag is described.

According to the previous introduction, when selecting a target tag from candidate tags, the user enters keywords into the tag input box and finds the target tag from the candidate tag display area. However, if the candidate tags do not include the target tag, the user cannot find the target tag from the candidate tag display area. Therefore, the user creates a new tag in the process of adding tags. Optionally, the user jumps to another interface through the jump control to create a tag or creates a tag in the current interface. Details are given below.

In a first possible embodiment, the display interface of the tag input box displayed on the client terminal includes a jump control. The jump control is configured to jump to the tag creation interface. Then, after finding that the candidate tags do not include the target tag, the user triggers the jump control to create a new tag in the tag creation interface.

In a second possible embodiment, the candidate tag display area includes a tag creation control, and the user creates a new tag through the tag creation control.

As shown in FIG. 13, when the client terminal displays the tag input box, the display area 1000 includes a title display area 1010, an operation control set 1020, a tag input box 1030, a selection control 1040 and a candidate tag display area 1050. The title display area 1010, the operation control set 1020, the tag input box 1030 and the selection control 1040 are similar to the corresponding areas or controls in FIG. 11, and thus are not described in detail here.

The candidate tag display area 1050 includes a first prompt information display area 1051, a first candidate tag display area 1052, a second candidate tag display area 1053, a first prompt information display area 1054 and a tag creation control 1055. The first prompt information display area 1051 is configured to prompt the user that the contents displayed in the first candidate tag display area 1052 and the second candidate tag display area 1053 are candidate tags. The first candidate tag display area 1052 is configured to display the candidate tag with the highest matching degree to the keyword inputted by the user. The second candidate tag display area 1053 is configured to display the candidate tag with the second highest matching degree to the keyword input by the user. The second prompt information display area 1053 is configured to prompt the user that the tag creation control 1055 is configured to create a new tag. The tag creation control 1055 is configured to trigger a tag creation operation. Optionally, the tag creation control 1055 includes tag preview information. The tag preview information is the name of the newly created tag, which is consistent with the keyword input by the user in the tag input box 1030.

When the user inputs a keyword in the tag input box 1030 and there is no candidate tag completely matching the keyword, the client terminal displays a first prompt information display area 1054 and a tag creation control 1055 in the candidate tag display area 1050. If the user thinks that the existing candidate tags do not have the target tag, a new tag is to be created. The user clicks on the tag creation control 1055, thereby triggering a tag creation operation, and controlling the client terminal or server to create a new tag. The name of the tag is a keyword inputted by the user in the tag input box 1030.

Optionally, in some embodiments, the user creates a new tag through the tag adding control 1040 instead of the tag creation control 1055. The client terminal receives the keyword inputted by the user through the tag input box 1030. The client terminal displays tags consistent with the keyword as candidate tags. When the tag adding control 1040 is triggered, the client terminal adds the tag consistent with the keyword to the target object, and stores the tag as a tag created by the user.

It should be noted that, the method described in this embodiment may be combined with the method described in the foregoing embodiments if there is no conflict. Moreover, solutions obtained by combinations are also covered within the protection scope of the embodiments of the present disclosure.

In the embodiments of the present disclosure, the creator of the target tag may set the operation permission of the target tag, so that users with different operation permissions can perform different operations on the target tag. The operation permission includes editing permission and/or viewing permission. The editing permission includes one or more of permission to modify the target tag, permission to modify the target object with the target tag, and permission to modify the correspondence between the target tag and the target object. The viewing permission includes one or more of permission of being able to see the target tag when viewing the target object, permission of being able to view the target object, and permission of being able to view all target objects with the target tag.

The user triggers the permission setting operation on the target tag on the tag viewing interface, or triggers the permission setting operation on the target tag after adding the target tag to the target object. Correspondingly, the client terminal receives the permission setting operation, and determines the operating user with the target tag according to the permission setting operation.

The operation permission includes three permissions: editable by all members in the organization, editable by added collaborators and viewable by other members in the organization, and editable or viewable by only collaborators. The organization refers to the team to which the user belongs, such as the company, department, or project group to which the user belongs. The collaborators are user-added, such as one or more other users selected by the user in the organization.

The three operation permissions are introduced in detail below.

When the user sets the operation permission of the target tag to be editable by all members in the organization, the client terminal receives the editing operation of any member in the organization, and edits the target tag or the target object with the target tag based on the editing operation of the member. Optionally, the editing operation further includes deleting the tag of the target object, or adding a target tag to the target object.

When the user sets the operation permission of the target tag to be editable by only the collaborator and viewable by other members, the client terminal acquires information of the collaborator determined by the user. When receiving an editing request from another user, the client terminal compares whether the information of the user is the same as that of the collaborator. In response to the fact that the information of the user is the same as the information of the collaborator, the client terminal edits the target tag or target object based on the editing operation performed by the user. If the information of the user is different from the information of the collaborator and the user is a member of the organization, the client terminal displays the target tag or target object and prohibits the user from editing.

When the user sets the operation permission of the target tag to be editable or viewable only by collaborators, the client terminal does not display the target object or target tag unless the user is the creator of the target tag or a collaborator set by the creator. For example, when a target object is displayed, the target tag that the target object has is hidden.

In addition, in this embodiment of the present disclosure, the creator of the target tag can delete the target tag. The user triggers a delete operation on the target tag. After receiving the delete operation, the client terminal deletes the target tag according to the delete operation, for example, deletes the correspondence between the target tag and an object. For a detailed introduction to the delete operation, reference is made to the introduction of the method for viewing tag below, which is not detailed here.

It should be noted that, the method described in this embodiment may be combined with the method described in the foregoing embodiments if there is no conflict. Moreover, solutions obtained by combinations are also covered within the protection scope of the embodiments of the present disclosure.

The method for information interaction according to the embodiment of the present disclosure has been introduced above. Correspondingly, the embodiment of the present disclosure also provides a method for viewing tag, which will be described in detail below.

FIG. 14 is a schematic flow chart of a method for viewing tag according to an embodiment of the present disclosure. The method includes the following steps S1101 to S1102.

In S1101, the client terminal receives a tag viewing operation triggered by a user on a tag viewing control.

In order to view a tag, the user triggers a tag viewing operation on the tag viewing control on the client terminal. Correspondingly, the client terminal receives the tag viewing operation triggered by the user. In the embodiment of the present disclosure, the tag viewing control is related or not related to a target object. These two cases are described separately below.

In a first possible embodiment, the tag viewing control is related to a target object, that is, the tag viewing operation is configured to view a tag corresponding to the target object. Then, after the tag viewing control is triggered, the tag viewing operation received by the client terminal is a tag viewing operation for the target object, and the displayed tag is also the tag of the target object. In this way, the user sees the tag that the target object has.

Optionally, the tag viewing control related to the target object is located on the interface where the target object is located. The client terminal displays the tag viewing control while displaying the target object. Then, when the user views the target object, a corresponding tag viewing operation is triggered. Correspondingly, the client terminal receives the tag viewing operation for the target object, so as to display the tag of the target object to the user. In this way, the user controls the client terminal to display the tag of the target object through the tag viewing control when viewing the target object.

Alternatively, the client terminal displays the tag of the target object in the interface for displaying the target object, that is, simultaneously displays the target object and the tag of the target object. Then, the tag viewing control is configured to jump to an interface displaying the target object. That is, when the user clicks on the tag viewing control on another interface (the interface does not include the target object), the client terminal jumps to the interface corresponding to the target object and displays the tag of the target object. In this way, the user can simultaneously view the target object and the tag of the target object on the same interface.

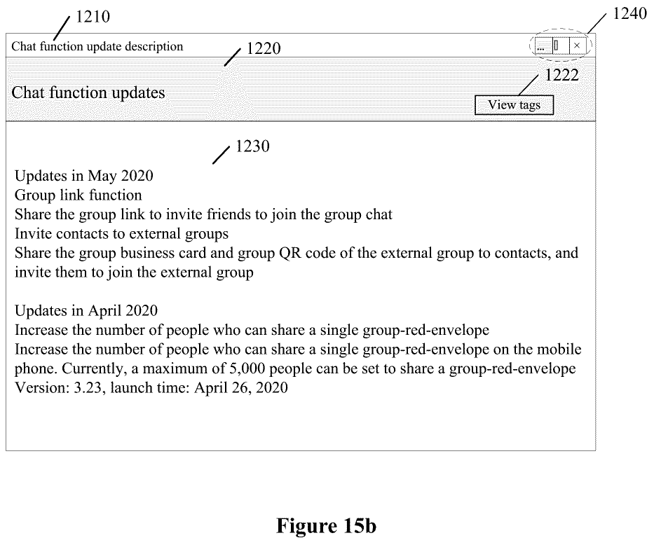

According to the foregoing introduction, the target object in the embodiments of the present disclosure is one of the operational objects that can be tagged, such as cloud documents, schedules, tasks, instant messaging messages, and instant messaging groups. In this embodiment of the present disclosure, the manner in which the user triggers the tag viewing control varies with different target objects. For the introduction of this part, reference is made to the introduction of the corresponding embodiments in FIG. 15 to FIG. 20 below, and which is not described in detail here.

In a second possible embodiment, the tag viewing control is related to a tag instead of being directly related to a target object. Correspondingly, the tag viewing operation is configured to view the tag instead of a tag of a certain target object. That is, when the tag viewing control is triggered by the user, the client terminal jumps to the tag display interface. The tag display interface is configured to display one or more tags. The one or more tags correspond to the same or different target objects. In this way, the user can manage tags.

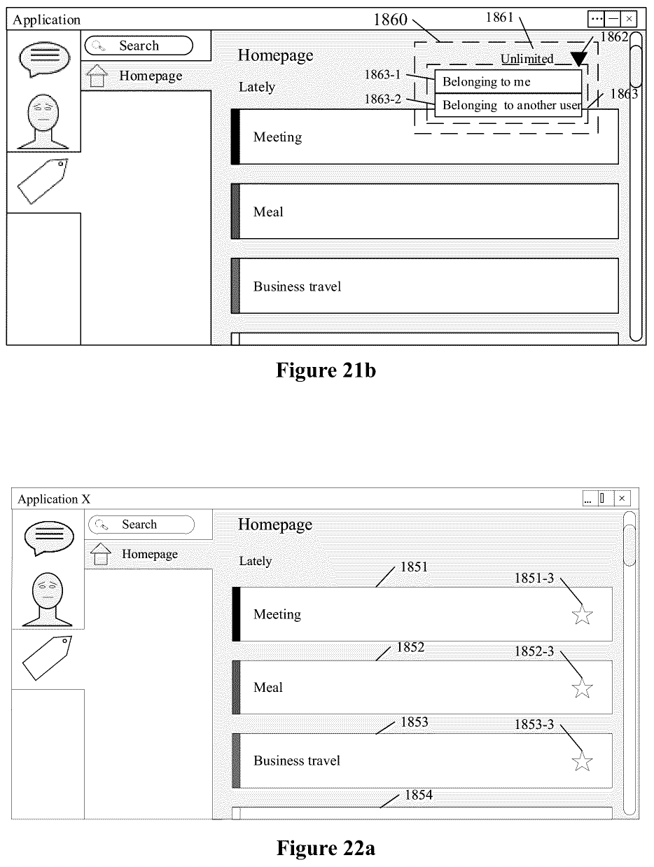

For the introduction of this part, reference is made to the corresponding embodiments in FIG. 21 to FIG. 24 below, and which is not described in detail here.

In S1102, the client terminal displays at least one tag according to the tag viewing operation.

After receiving the tag viewing operation, the client terminal displays at least one tag according to the tag viewing operation, so that the user can view the displayed tag. Optionally, the client terminal displays information of the creator of the tag while displaying the tag. The information of the creator includes the name, the contact information, the team, the position and the like of the creator.

Optionally, when displaying multiple tags, the client terminal first sorts the multiple tags according to a preset rule and then displays the multiple tags in order. The preset rule includes one or more of sorting by tag access time, sorting by tag creation time, and sorting by tag priority. For example, when the preset rule is to sort by the tag creation time, the client terminal obtains the creation time of each tag in the at least one tag, and sorts the at least one tag according to the order of creation time from late to early. The priority of a tag depends on whether the tag is bookmarked or not.

According to the above introduction, it can be seen that the tag viewing operation is configured to view a tag corresponding to a target object, or to view all tags. When the tag viewing operation is configured to view the tag corresponding to the target object, the client terminal displays at least one tag corresponding to the target object. When the tag viewing operation is configured to view all tags, the client terminal displays all tags viewable by the user. Optionally, when the tag viewing operation is configured to view all tags, the client terminal can modify at least one displayed tag, such as viewing tag details, deleting a tag and grouping tags. For details about this part, reference is made to the introduction below, and which is not detailed here.

In this embodiment of the present disclosure, all the tags displayed on the client terminal include tags created by the user, and tags created by other users for which the user has permission to view. The case that the tags displayed on the client terminal include a tag created by the user, and a tag created by other users for which the user has permission to view is described as an example. After receiving the tag viewing operation, the client terminal triggers the server to identify tags created by the user and tags created by other users from all stored tags. Next, the client terminal determines one by one whether the user has the viewing permission corresponding to the tag created by other users, thereby identifying the tag that the user has the viewing permission, and sends the tag created by the user and the tag which is created by other users and for which the user has viewing permission to the client terminal.

In some embodiments, the user has no permission to view the tag desired to be viewed. In this case, the user applies to the user who created the tag for the permission to view the tag. Assuming that the user X does not have the viewing permission of the tag A, the user triggers the operation of applying for the permission of the tag A. After receiving the operation triggered by the user, the client terminal generates a permission application request according to the permission application operation and sends the permission application request to a user Y who created the tag A. The permission application request is configured to apply for viewing permission for the tag A. After seeing the permission application request, the user Y approves the permission application request, so that the user X acquires the viewing permission of the tag A and can see the tag A on the client terminal. Alternatively, the user Y rejects the permission application request, so that the user X cannot see the tag A.

In some embodiments, the user filters the tags. A user triggers a filter trigger action on a filter control. In response to receiving the filter trigger operation triggered by the user, the client terminal triggers the filter operation according to the filter trigger operation and displays the filter result.

Optionally, the filter operation includes filter conditions. Correspondingly, the filter operation triggered by the filter trigger operation filters tags according to the filter conditions. The filter conditions include an attribute value condition of at least one attribute. Then, the filter operation filters the tags presented on the target interface according to the attribute value of the at least one attribute.

In this embodiment of the present disclosure, the at least one attribute includes one of: belonging to the user, belonging to another user, and unlimited belonging. A tag with the attribute of belonging to the user is a tag created by that user. A tag with the attribute of belonging to another user is created by the other user. A tag with unlimited belonging includes both a tag created by the user and a tag created by the other user.

The following describes in detail how the user triggers the tag viewing operation according to whether the tag viewing control is related to the target object.

Firstly, it is introduced that the tag viewing control is related to the target object, that is, the tag viewing control is used to view the tag of the target object.

According to the above introduction, it can be seen that the target object is one of the operational objects that are allowed to be tagged, such as cloud documents, schedules, tasks, instant messaging messages, and instant messaging groups. In the embodiment of the present disclosure, the manner in which the user triggers the tag viewing operation varies with different target objects. Taking cloud documents, schedules, instant messaging messages, and instant messaging groups as examples, the following describes how a user triggers a tag viewing operation.

It should be noted that, after receiving the tag viewing operation, the client terminal may display all the tags of the target object, or may display tags created by the user and/or tags which are created by other users and the user has permission to view among all the tags of the target object. The following describes an example of displaying all the tags of the target object on the client terminal for illustration.

Firstly, the method for the user to trigger the tag viewing operation when the target object is a cloud document is introduced.

In a first possible embodiment, the client terminal displays tags of the cloud document while displaying the cloud document. Correspondingly, the tag viewing control is used to view the tag of the cloud document. After the control is triggered, the client terminal jumps to an interface for displaying the cloud document, and displays the cloud document and the tag of the cloud document.

As shown in FIG. 15a, when the client terminal displays a cloud document, the display area includes a name display area 1210, a title display area 1220, a text display area 1230 and an operation control set 1240. The title display area 1220 includes a tag display area 1221 configured to display the tag of the cloud document.

Optionally, the client terminal displays identification information when displaying the tag, so as to prompt the user that the displayed content is the tag. For example, in the embodiment shown in FIG. 15a, a sign “#” is displayed before each tag. In this way, when viewing a cloud document, the user can determine that the tags corresponding to the cloud document include “software item” and “function update description”.

For other parts in FIG. 15a, reference is made to the introduction of the embodiment shown in FIG. 2 and FIG. 3, and details are not described here.

In a second possible embodiment, when displaying a cloud document, the client terminal displays a tag viewing control interface corresponding to the cloud document. For example, in the embodiment shown in FIG. 15b, the title display area 1220 includes a tag view control 1222. The user triggers a tag display operation by triggering the tag viewing control 1222. Correspondingly, after receiving the tag display operation, the client terminal displays the tag of the cloud document. Optionally, in other embodiments, the client terminal hides the tag viewing control, and then displays the tag viewing control based on the user-triggered display operation and selection operation. For the introduction of the display operation and the selection operation, reference is made to the above, and details are not described here.

It should be noted that, the method described in this embodiment may be combined with the method described in the foregoing embodiments if there is no conflict. Moreover, solutions obtained by combinations are also covered within the protection scope of the embodiments of the present disclosure.

The following describes how the user triggers the tag viewing operation when the target object is a schedule.

In a first possible embodiment, the client terminal displays the tag of the schedule while displaying the schedule. Correspondingly, the tag viewing control is used to view the schedule. After the control is triggered, the client terminal jumps to the interface for displaying the schedule and displays the schedule and the tag of the schedule.

In a second possible embodiment, the client terminal displays the tag viewing control corresponding to the schedule while displaying the schedule, and/or displays the tag viewing control corresponding to the schedule based on a display operation or a selection operation triggered by the user on the interface displaying the schedule. The following describes an example of displaying the tag viewing control corresponding to the schedule by a client terminal based on the selection operation triggered by the user for illustration.

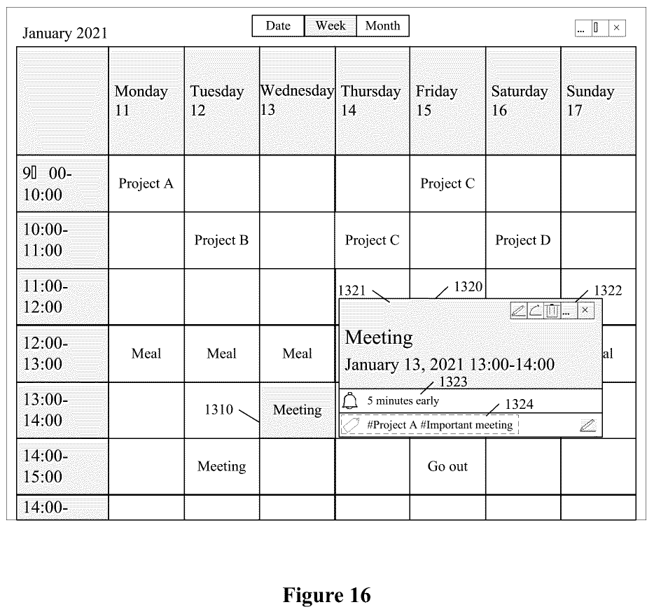

As shown in FIG. 16, the user clicks on the schedule display element 1310 to trigger the selection operation. After the user triggers the selection operation, the client terminal displays the hidden interface 1320. The hidden interface includes an operation control set 1321, a schedule information display area 1322, a reminder time display area 1323 and a tag display area 1324. The tag display area 1324 is configured to display the tag corresponding to the schedule. In the embodiment shown in FIG. 16, the tags corresponding to the schedule include two tags of “project A” and “function update description”.

For other parts in FIG. 16, reference is made to the introduction of the embodiment shown in FIG. 8 and FIG. 9, and details are not described here.

It should be noted that, the method described in this embodiment may be combined with the method described in the foregoing embodiments if there is no conflict. Moreover, solutions obtained by combinations are also covered within the protection scope of the embodiments of the present disclosure.

The following describes how the user triggers the tag viewing operation when the target object is an instant messaging message.

In a first possible embodiment, the client terminal displays the tag of the instant messaging message while displaying the instant messaging message. Correspondingly, the tag viewing control is used to view the instant messaging message. After the control is triggered, the client terminal jumps to an interface for displaying instant messaging messages, and displays the instant messaging messages and the tag attached to the instant messaging message.

In a second possible embodiment, the client terminal displays the tag display control corresponding to the instant messaging message while displaying the instant messaging message, and/or displays the tag display control corresponding to the instant messaging message based on the display operation or selection operation triggered by the user on the interface for displaying the instant messaging message. The following describes an example of displaying the tag display control corresponding to the instant messaging message by the client terminal based on the selection operation and the display operation triggered by the user.

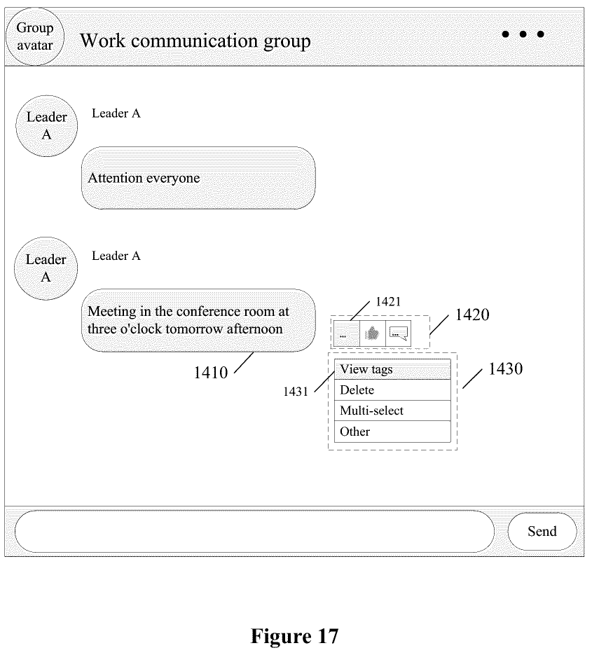

As shown in FIG. 17, to view the tag of a group chat IM message 1410, the user selects the group chat IM message 1410. The client terminal displays the control set 1420 according to the selection operation performed by the user. The control set 1420 includes a display operation control 1421. The user triggers a display operation through the display operation control 1421, and controls the client terminal to display the hidden control set 1430. The hidden control set 1430 includes a tag viewing control 1431.

After the tag viewing control 1431 is triggered, the client terminal displays the tag viewing interface. The tag viewing interface includes the tag that the group chat IM message 1410 has. Optionally, the tag viewing interface is a pop-up dialog box, and the client terminal displays the tag viewing interface in the interface for displaying the group chat IM message. Optionally, the tag viewing interface is an independent interface, and the client terminal jumps to another interface to display the tag of the group chat IM message.

It should be noted that the tag viewing control 1431 in FIG. 17 is the same as the tag adding control 651 in FIG. 9.

It should be noted that, the method described in this embodiment may be combined with the method described in the foregoing embodiments if there is no conflict. Moreover, solutions obtained by combinations are also covered within the protection scope of the embodiments of the present disclosure.

The following describes how the user triggers the tag viewing operation when the target object is an instant messaging group.

In a first possible embodiment, the client terminal displays the tag of the instant messaging group while displaying the instant messaging group. Correspondingly, the tag viewing control is used to view the instant messaging group. After the tag viewing control is triggered, the client terminal jumps to an interface for displaying the instant messaging group, and displays the instant messaging group and the tag of the instant messaging group.

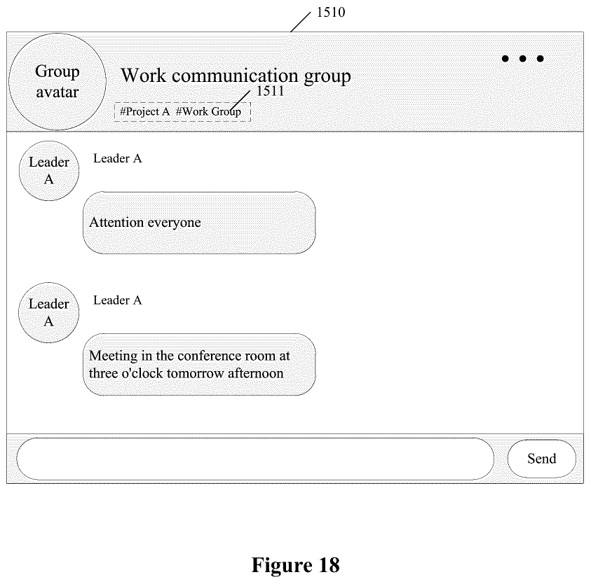

As shown in FIG. 18, when the client terminal displays an instant messaging group, the title display area 1510 includes a tag display area 1511. The tag display area 1511 is configured to display a tag corresponding to the instant messaging group. In the embodiment shown in FIG. 18, the tag of the instant messaging group “work exchange group” include two tags “project A” and “work group”.

In a second possible embodiment, the client terminal displays the tag viewing control corresponding to the instant messaging group while displaying the instant messaging group, and/or displays the tag viewing control corresponding to the instant messaging group based on the display operation or selection operation triggered by the user on the interface displaying the instant messaging group. In the following, the client terminal displays the tag viewing control corresponding to the instant messaging group as an example for illustration.

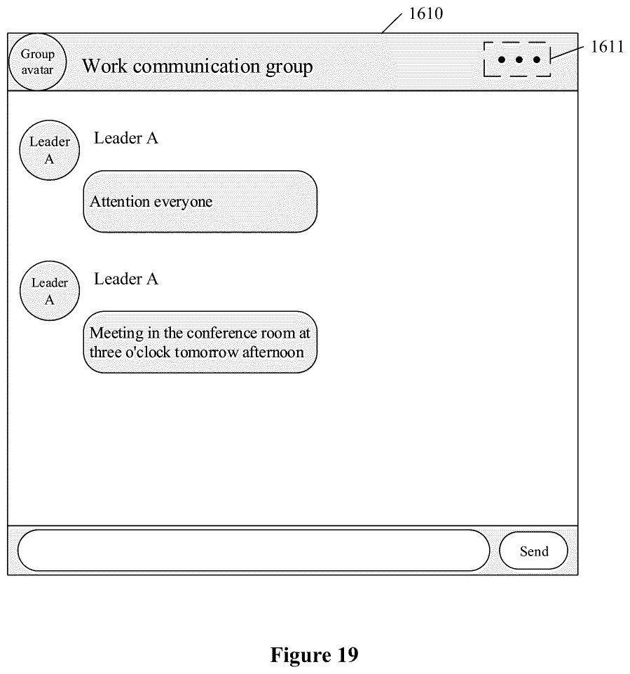

As shown in FIG. 19, when the client terminal displays an instant messaging group, the title display area 1610 includes a jump control 1611. The jump control 1611 functions as a tag viewing control. After the user triggers the jump control 1611, the client terminal receives a tag viewing operation to display the tag of the instant messaging group “work communication group”. Optionally, the client terminal displays the tag of the instant messaging group on the current interface, or jumps to another interface to display the tag of the instant messaging group.

It should be noted that, the method described in this embodiment may be combined with the method described in the foregoing embodiments if there is no conflict. Moreover, solutions obtained by combinations are also covered within the protection scope of the embodiments of the present disclosure.

The above describes the scenario where the tag viewing control is used to view the tag of the target object. The following describes the scenario where the tag viewing control is not directly associated with the target object, that is, the tag viewing control is used to view a tag.

When the tag viewing control is not directly used to view the tag of a target object, the tag viewing control is configured to jump to a tag display interface. In the tag display interface, the client terminal displays at least one tag viewed by the user (for example, with viewing permission). By operating any one of the at least one tag, the user can view the relevant information of the object corresponding to the tag, modify the relevant information of the tag, and modify the correspondence between the tag and the object.

In the embodiment of the present disclosure, the tag viewing control is located on the initial interface or any other interface of the client terminal. Correspondingly, the user triggers the tag viewing operation on the initial interface or any other interface of the client terminal.

As an example for illustration, the user triggers the tag viewing operation on the group chat IM message interface. As shown in FIG. 20, when the client terminal displays the group chat IM message interface, the display area includes a title display area 1710, a message display area 1720 and a control display area 1730. The title display area 1710 is configured to display basic information of the client terminal. For example, in FIG. 20, the title display area 1710 displays that the name of the software running on the client terminal is “software X”. The message display area 1720 is configured to display instant messaging group chat messages. For the introduction of the details in the message display area 1720, reference is made to the above, and which is not described in detail here.

The control display area 1730 is configured to display at least one operation control. In the embodiment shown in FIG. 20, the control display area 1730 includes a message viewing control 1731, an address book viewing control 1732 and a tag viewing control 1733. The message viewing control 1731 is configured to instruct the client terminal to display the instant messaging group chat message when being triggered. In the embodiment shown in FIG. 20, the message viewing control 1731 has been triggered. The address book viewing control 1732 is configured to instruct the client terminal to display the address book when being triggered. In the embodiment shown in FIG. 20, the address book viewing control 1732 is not triggered. The tag viewing control 1733 is configured to instruct the client terminal to display at least one tag when being triggered. In the embodiment shown in FIG. 20, the tag view control 1732 is not triggered.

It should be noted that, the method described in this embodiment may be combined with the method described in the foregoing embodiments if there is no conflict. Moreover, solutions obtained by combinations are also covered within the protection scope of the embodiments of the present disclosure.

After the user triggers the tag viewing control, the client terminal receives the tag viewing operation, and jumps to the tag display interface according to the tag viewing operation. In the tag display interface, the client terminal displays at least one tag. According to the foregoing introduction, it can be seen that the at least one tag includes tags created by the user and tags which are created by other users and for which the user has permission to view. The user is who logs into the client terminal or who is currently operating the client terminal.

As shown in FIG. 21a, when the client terminal displays the tag display interface, the display area includes a title display area 1810, a control display area 1820, a search control 1830, a sorting information display area 1840 and a tag display area 1850.

The title display area 1810 is configured to display basic information of the client terminal. The control display area 1820 includes a tag viewing control 1821. In the embodiment shown in FIG. 21a, the tag viewing control 1821 is already activated. The search control 1830 is configured to receive a keyword inputted by the user, and search for a tag matching the keyword. The sorting information display area 1840 is configured to display the sorting rule of tag cards in the tag display area 1850. In the embodiment shown in FIG. 21a, the content displayed in the sorting information display area 1840 is “lately”, which means that the tags in the tag display area 1850 are sorted by tag access time, and the last accessed tag is listed first.

The tag display area 1850 is configured to display one or more tag cards. Each tag card displays information about a tag. In the embodiment shown in FIG. 21a, the tag display area 1850 includes a first tag card 1851, a second tag card 1852, a third tag card 1853 and a fourth tag card 1854 that is not fully displayed. The first tag card 1851 includes a color identification area 1851-1 and a tag name display area 1851-2. The color displayed in the color identification area 1851-1 indicates the creator of the first tag 1851. The tag name display area 1851-2 is configured to display the name of the first tag 1851. In the embodiment shown in FIG. 21a, the first tag card 1851 is black, which means that the tag “meeting” currently displayed on the first tag card 1851 was created by the user currently logged into the client terminal. In other examples, the color of the color identification area 1851-1 may represent other content, which is not specifically limited in this embodiment of the present disclosure.

According to the foregoing introduction, it can be seen that the user filters at least one tag displayed on the client terminal. In the embodiment of the present disclosure, the tag display interface includes a filter control. The user triggers a filtering trigger operation on the filtering control, thereby controlling the client terminal to filter the tags.

As shown in FIG. 21b, the tag display interface further includes a filter control 1860. The filter control 1860 includes a current attribute display area 1861 and an attribute change control 1862. The current attribute display area 1861 is configured to display the current filter condition. In the embodiment shown in FIG. 21b, the condition for filtering tags by the client terminal is “unlimited belonging”, indicating that the tags displayed by the client terminal include tags created by the user and tags created by other users. The attribute change control 1862 is configured to change the filter condition of the client terminal.

To identify a tag with another attribute from the tags, the user triggers the attribute change control 1862. In response to the user operation, the client terminal displays the attribute display area 1863. The attribute display area 1863 includes a first attribute filtering control 1863-1 and a second attribute filtering control 1863-2. When the first attribute filtering control 1863-1 is triggered, the client terminal identifies a tag created by the user from the tags. When the second attribute filtering control 1863-2 is triggered, the client terminal identifies a tag created by other users from the tags.

It should be noted that, the method described in this embodiment may be combined with the method described in the foregoing embodiments if there is no conflict. Moreover, solutions obtained by combinations are also covered within the protection scope of the embodiments of the present disclosure.

If the number of tags is large, it may take a long time for the user to find the desired tag from the tag display interface. To this end, the user triggers a bookmark operation in the tag display interface, so as to bookmark one or more tags. In this way, when viewing a tag that has been bookmarked, the user can quickly find the tag that has been bookmarked in the bookmark interface.

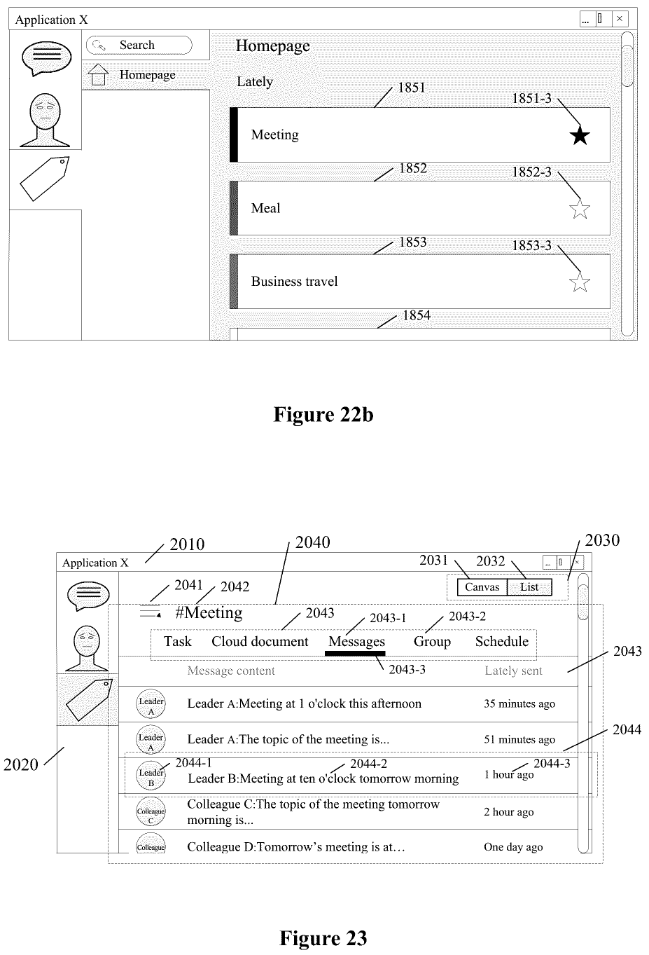

In some embodiments, the user triggers the bookmark operation through the bookmark control. As shown in FIG. 22a, the tag card displayed on the tag display interface includes a bookmark control. For example, a first tag card 1851 includes a first bookmark control 1851-3. The second tag card 1852 includes a second bookmark control 1852-3. The third tag card 1853 includes a second bookmark control 1852-3.

To bookmark a tag, the user clicks the bookmark control on the tag card that displays the tag. For example, to bookmark the tag “meeting”, the user clicks on the first bookmark control 1851-3 in the first tag card 1851. In response to the first bookmark control 1851-3 being clicked, the client terminal determines that the user has triggered a bookmark operation on the tag “meeting”, thereby bookmarking the tag “meeting”.

Optionally, after bookmarking the target tag, the client terminal changes the color of the bookmark control in the tag card where the target tag is located. As shown in FIG. 22b, after collecting the tag “meeting”, the client terminal changes the color of the first bookmark control 1851-3 from white to black to remind the user that the tag “meeting” displayed on the first tag card 1851 “has been bookmarked.

After bookmarking one or more tags, the user can trigger a viewing operation on the bookmarked tags. For example, the user triggers the viewing operation of the bookmarked tags through the viewing control on the home page of the client terminal. Alternatively, the user triggers an operation of viewing the bookmarked tags on the interface of the client terminal for displaying the bookmarked objects. After receiving the viewing operation, the client terminal displays the bookmarked tags.

It should be noted that, the method described in this embodiment may be combined with the method described in the foregoing embodiments if there is no conflict. Moreover, solutions obtained by combinations are also covered within the protection scope of the embodiments of the present disclosure.

In the tag viewing interface, the client terminal displays to the user one or more tags viewable by the user. In order to further view the object corresponding to a tag and other information of this object, the user triggers the viewing operation on this tag. Correspondingly, according to the above introduction, it can be known that after the target object is tagged, the client terminal or server generates the correspondence between the information block of the target object and the tag. Then, after receiving the tag viewing operation, the client terminal displays the information block of the object with the tag.

In this embodiment of the present disclosure, the information block includes summary information. For ease of description, the subsequent embodiments will be described by taking the summary displayed by the client terminal as an example. It should be noted that when the information block of the target object includes other information of the target object, the client terminal also displays the information.

When the information block of the target object includes summary information of the target object, the client terminal displays summary information of at least one object with the tag. For example, the user triggers a viewing operation on the first tag, and the client terminal jumps to the tag detail interface corresponding to the first tag according to the viewing operation. The tag detail interface includes summary information of at least one object.

In the embodiment of the present disclosure, the client terminal first classifies at least one object according to the tag domain, and then displays summary information according to the tag domain classification, so that the user can distinguish different kinds of objects. The tag domain indicates the source or kind of the object. Optionally, the tag domain is the type of object. For example, the object A is a cloud document, then the tag domain corresponding to the object A is cloud document. According to the foregoing discussion, it can be seen that the target objects of adding tags are operation objects such as cloud documents, schedules, tasks, instant messaging messages, and instant messaging groups. Correspondingly, the tag domain includes one or more of cloud document, schedule, task, instant messaging message, and instant messaging group.

In the embodiment of the present disclosure, the client terminal displays summary information of at least one object of the same tag in a list or a canvas card. The following are detailed introductions respectively.

Firstly, the case where the client terminal displays summary information in a list is introduced.

When the client terminal displays summary information in a list, the client terminal sequentially displays summary information of at least one object with a tag. As shown in FIG. 23, when the client terminal displays summary information in a list, the display area includes a title display area 2010, a control display area 2020, a display mode switch control 2030 and a tag display area 2040. For the introduction of the title display area 2010 and the control display area 2020, reference is made to the above, and which is not described in detail here.

The display mode switch control 2030 is configured to switch the switch mode of displaying summary information of the client terminal. For example, the display mode switching control 2030 is configured to switch the display mode from the list to the canvas card, or from the canvas card to the list. In the embodiment shown in FIG. 23, the display mode switch control 2030 includes a canvas card display control 2031 and a list display control 2032. The canvas card display control 2031 is not triggered. The list display control 2032 is triggered, indicating that the client terminal currently displays summary information in a list.

The tag display area 2040 includes a tag switch control 2041, a tag name display area 2042, a tag domain display area 2043 and at least one summary information display area.

The tag switch control 2041 is configured to switch to another tag. To view another tag, the user triggers the tag switch control 2041. The tag name display area 2042 is configured to display the name of the tag. For example, in the embodiment shown in FIG. 23, the user determines according to the tag name display area 2042 that the currently displayed summary information belongs to the tag “meeting”.

The tag domain display area 2043 is configured to display the tag domain from which the object corresponding to the summary information originates, and is further configured to switch to the summary information of objects from other tag domains. As shown in FIG. 23, the tag domain display area 2043 includes a first tag domain name 2043-1, a second tag domain name 2043-2 and annotation information 2043-3. The first tag domain name 2043-1 is “message”, indicating that the object from this tag domain is an instant messaging message. The second tag domain name 2043-2 is “group”, which means that the object from this tag domain is an instant messaging group. The annotation information 2043-3 indicates a tag domain to which the summary information currently displayed on the client terminal belongs. In the embodiment shown in FIG. 23, the annotation information 2043-3 is related to the first tag domain name 2043-1, indicating that the object corresponding to the summary information currently displayed on the client terminal comes from the tag domain of “instant messaging message”.

In some embodiments, the client terminal does not classify summary information according to tag domains. Correspondingly, the tag display area 2040 does not include the tag domain display area 2043.

In this embodiment of the present disclosure, the tag display area 2040 includes one or more summary display areas. Each summary display area is configured to display summary information of an object. The following takes the tag display area 2040 including the summary display area 2044 as an example for illustration.

As shown in FIG. 23, when the summary information displayed by the client terminal is the summary information of an instant messaging message, the summary display area 2044 includes at least one of a summary avatar display area 2044-1, a summary content display area 2044-2 and an object information display area 2044-3. The summary avatar display area 2044-1 is configured to display the avatar of the user who sent the instant messaging message. The summary content display area 2044-2 displays the content of the instant messaging message. Optionally, when the content of the instant messaging message is large, the summary content display area 2044-2 partially displays the instant messaging message, for example, the first ten characters of the message. The object information display area 2044-3 is configured to display other information of the instant messaging message. For example, in the embodiment shown in FIG. 23, the time when the instant messaging message is sent is displayed in the object information display area 2044-3. The object information display area 2044-3 may display other information, such as the instant messaging group to which the instant messaging message belongs.

Optionally, the tag display area further includes instruction information to prompt the user about content displayed in each display area in the summary display area. For example, in the embodiment shown in FIG. 23, the tag display area 2040 includes two indications of “message content” and “lately sent”. The prompt information of “message content” prompts the user that the corresponding position in the summary display area below is used to display the content of the instant messaging message. The prompt information of “lately sent” prompts the user that the summary information displayed in each summary display area below is arranged in the chronologic order of the sending time of the corresponding instant messaging messages.

It should be noted that, the method described in this embodiment may be combined with the method described in the foregoing embodiments if there is no conflict. Moreover, solutions obtained by combinations are also covered within the protection scope of the embodiments of the present disclosure.

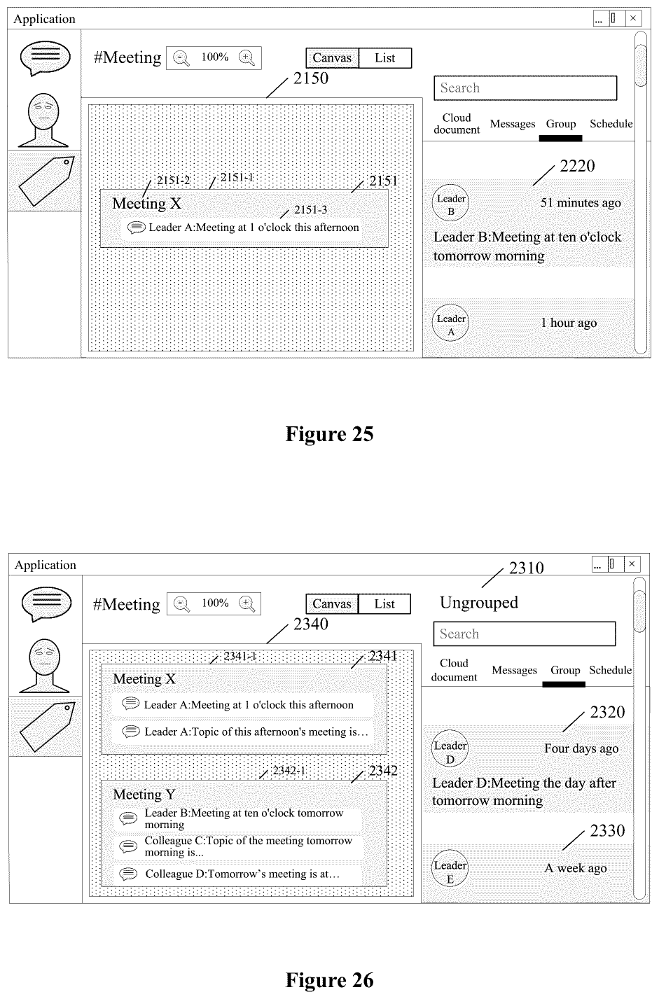

The following describes the situation where the client terminal displays summary information with a canvas card. When the client terminal displays summary information with a canvas card, the client terminal sets a canvas view display area in the display area. As shown in FIG. 24, when the client terminal displays summary information in the form of a canvas card, the display area includes a display scale change control 2110, a display mode switch control 2120, a search control 2130, a tag domain display area 2140, a canvas view 2150 and at least one canvas card. For the description of other parts in FIG. 24, reference is made to the foregoing embodiments, and details are not described here.

The display scale change control 2110 is configured to change the display scale of the canvas view 2150. The display scale change control 2110 includes a zoom-out control 2111, a zoom-in control 2112 and a scale display area 2113. The zoom-out control 2111 is configured to reduce the display scale of the canvas view 2150. The zoom-in control 2112 is configured to amplify the display scale of the canvas view 2150. The scale display area 2113 is configured to display the current display scale of the canvas view 2150.

The display mode switch control 2120 is configured to switch the mode of displaying summary information on the client terminal. In the embodiment shown in FIG. 24, the display mode switch control 2120 includes a canvas card display control 2121 and a list display control 2122. The canvas card display control 2121 has been triggered. The list display control 2122 is not triggered, which means that the client terminal is currently displaying summary information in canvas cards.

The search control 2130 is configured to search for corresponding an object and/or summary information according to a keyword inputted by the user. When wanting certain summary information or an object with a keyword, the user inputs the keyword in the search control 2130. Correspondingly, the client terminal searches for an object and/or summary information matching the keyword.

For the detailed introduction of the tag domain display area 2140, reference is made to the above, and which is not detailed here.

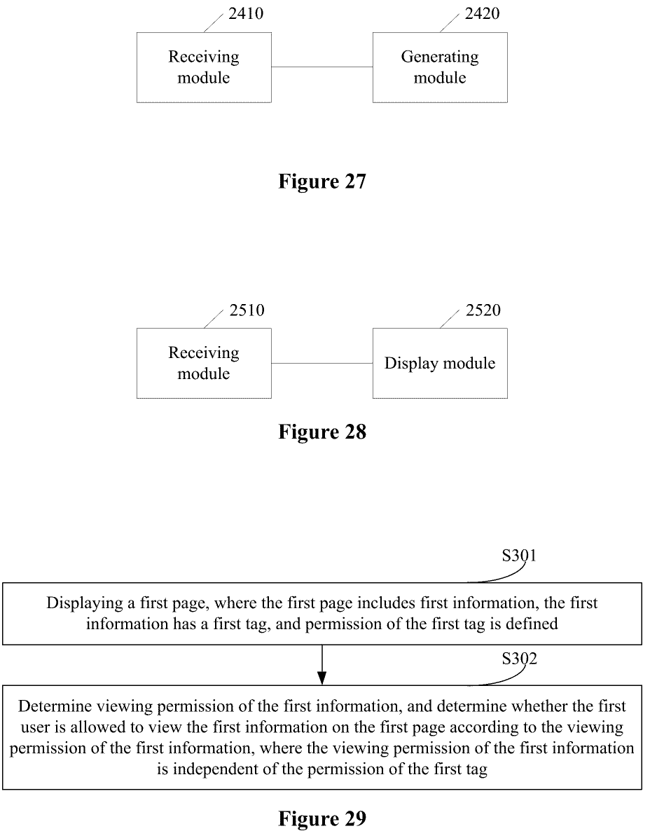

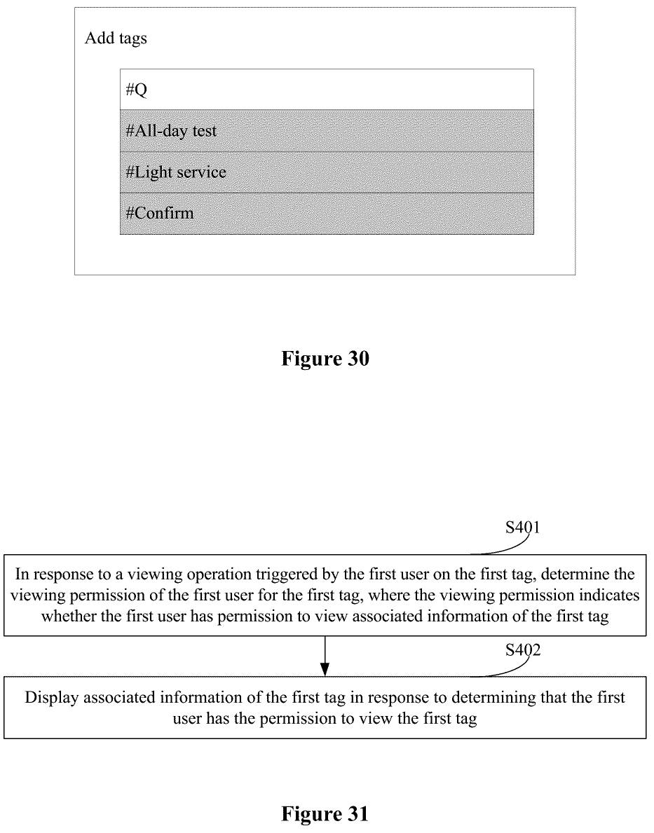

The canvas view 2150 is configured to group information blocks displayed in the canvas card according to an operation performed by the user. For a detailed description of the canvas view 2150, reference is made to the introduction of the embodiments shown in FIG. 25 and FIG. 26, and which is not detailed here.

In this embodiment of the present disclosure, the display area of the client terminal includes one or more tag canvas cards. Each canvas card is configured to display summary information corresponding to an object. The following takes the display area including the canvas card 2160 as an example for illustration.

As shown in FIG. 24, the canvas card 2160 includes a summary avatar display area 2161, a summary content display area 2162 and an object information display area 2163. The summary avatar display area 2061 is configured to display the avatar of the user who sent the instant messaging message. The summary content display area 2162 is configured to display the content of the instant messaging message. The object information display area 2163 is configured to display other information of the instant messaging message. For example, in the embodiment shown in FIG. 24, the object information display area 2163 displays the time when the instant messaging message is sent. It should be noted that FIG. 24 is only used as an example to facilitate the understanding of the canvas card, and does not limit the specific style of the canvas card.

In this embodiment of the present disclosure, there is a separation area between different canvas cards to distinguish summary information corresponding to different objects. As shown in FIG. 24, the background color of the canvas card 2160 is different from other parts. In this way, the user determines according to the color information of the card display area that the card display area 2160 is configured to display summary information.

According to the foregoing introduction, it can be seen that the creator of the tag sets the viewing permission and/or editing permission of the tag. Correspondingly, after receiving the tag viewing operation, the client terminal determines whether the currently logged-in user has the tag viewing permission. If the user has no permission to view the tag, the client terminal does not display the information block of the object with the tag. If the user has the permission to view the tag, the client terminal may not respond to the editing operation performed by the user. For example, in the embodiment shown in FIG. 24, the user only has the viewing permission of the tag “meeting” and does not have the editing permission, the client terminal displays the canvas view shown in FIG. 24 and prohibits the user from grouping information blocks under the canvas view and so on.

It should be noted that, the method described in this embodiment may be combined with the method described in the foregoing embodiments if there is no conflict. Moreover, solutions obtained by combinations are also covered within the protection scope of the embodiments of the present disclosure.

The above describes the method for the client terminal to display the tag and the summary information of at least one object with the tag to the user. Correspondingly, in the interface displaying the summary information, the user operates on the tag or the summary information. In this embodiment of the application, the operations performed by the user on the tag or summary information include viewing details, deleting and grouping. Details are given below.

First, the operation of viewing details is introduced.

In an actual application scenario, the client terminal may fail to display all the information or all the summary information of the object due to the limited size of the display area, so that the user cannot find what he wants to see from the information displayed on the client terminal.

Therefore, the client terminal associates the summary information of the object with the object, or associates the summary information with the interface corresponding to the object. In this way, when the user wants to view the detailed information of the object, the client terminal displays the object or the interface corresponding to the object according to the operation of viewing details triggered by the user.

For example, the objects displayed by the client terminal include the first object. The client terminal records in advance the correspondence between the summary information of the first object and the first object, or records the correspondence between the summary information of the first object and the interface associated with the first object. When wanting to view the detailed information of the first object, the user performs a trigger operation on the summary information of the first object. In response to the trigger operation, the client terminal jumps to an interface associated with the first object, or displays the first object.

The operation of deleting is described below.

When wanting to delete a tag of an object, the user triggers the delete operation on the tag. Correspondingly, according to the received delete operation, the client terminal deletes the association between the object and the tag. Optionally, when the user triggers a delete operation on the tag details page of the first tag, the client terminal receives the delete operation on the first object. Since the current interface corresponds to the first tag, the client terminal determines that the delete operation is aimed at the first object and the first tag, thereby deleting the correspondence between the first object and the first tag.

In the embodiment of the present disclosure, the user can trigger a delete operation on the tag, thereby controlling the client terminal to delete the correspondence between the tag and all objects. For example, in the tag display interface shown in FIG. 18, the user triggers a delete operation on the first tag. After receiving the delete operation, the client terminal deletes the first tag and clears the correspondence between the first tag and all objects. Optionally, the user controls the client terminal to display a tag deletion control by right-clicking or long-pressing the first tag 1851, and triggers a delete operation through the tag deletion control.

The operation of grouping is introduced below.

In practical application scenarios, different objects may have the same tag. If the number of these objects is large, it may be difficult for a user to directly find a desired object. To solve this problem, the user triggers the grouping operation. Correspondingly, according to the grouping operation, the client terminal groups one or more among the one or more objects with the same tag. In this way, the objects with the same characteristics are grouped so that the user can find the desired object more quickly.

Optionally, when generating a group, the client terminal obtains the tag group name. According to the tag group name, the client terminal (or server) generates the correspondence between the tag, the grouped object and the tag group name. In this way, according to the tag group name, the user or client terminal determines the group to which the object belongs. For example, if the user groups the object X and object Y in the tag A into a group, then the user sets the tag group name of the group as “the first group”. Correspondingly, the client terminal or the server records the correspondence between the tag A, the first group and the object X, and the correspondence between the tag A, the first group and the object Y.

For the detailed description about the client terminal obtaining the tag group name, reference is made to the following, and which is not detailed here.

In the following, the process of grouping objects will be introduced by taking the case where the client terminal displays summary information with canvas cards as an example.

When wanting to group objects, the user drags the canvas card where the summary information corresponding to the object is located into the canvas view. The client terminal determines, according to the position of the canvas card in the canvas view, the group to which the object corresponding to the summary information in the canvas card belongs. For example, the client terminal determines, according to the distance between the canvas card and other canvas cards, the group to which the object corresponding to the summary information in the canvas card belongs.

For example, when wanting to add an object to a group, for example, when wanting to add the canvas card 2160 in FIG. 24 to the grouping of “meeting X”, the user selects the canvas card 2160 and drags the canvas card 2160 into the canvas view 2150. After detecting that the canvas card 2160 is newly added in the canvas view 2150 and the border of the canvas view 2160 does not coincide with the border of an existing grouping area, the client terminal determines that the user creates a new group for the canvas card 2160. A new canvas card corresponding to the canvas card 2160 is displayed in the canvas view 2150. The display area of the client terminal is shown in FIG. 25, and the canvas view 2150 includes a first group display area 2151. The border of the first group display area 2151 is 2151-1, including a name display area 2151-2 and a canvas card 2151-3.

The name display area 2151-2 is configured to display the group name corresponding to the first group display area 2151. In the embodiment shown in FIG. 25, the group name of the first group display area 2151 is “meeting X”. Optionally, when creating a new group X, the client terminal displays a name input box and uses the data entered by the user in the name input box as the tag group name. The canvas card 2151-3 is a new canvas card corresponding to the canvas card 2160, and displays the same or similar summary information as the canvas card 2160. It can be seen that, in the embodiment shown in FIG. 25, the canvas card 2151-3 indicates that the instant messaging message “meeting at 1 pm today” sent by the leader A belongs to the group “meeting X” under the tag “meeting”.

In the embodiment of the present disclosure, the client terminal determines the group of the dragged canvas view according to whether the dragged canvas card overlaps with the group display area inside the canvas view. For example, if the user drags the canvas card to overlap with the first group display area 2151, the user adds the new canvas card to “group X”. If the user drags the canvas card into the canvas view 2150 and does not overlap with the first group display area 2151, the user is not intended to add the new canvas card to “group X”.

Optionally, the client terminal determines whether the canvas card overlaps with the group display area by determining whether the border of the canvas card intersects the border of the group display area. For example, if the border of the canvas card dragged into the canvas view 2150 intersects the border 2151-1, the client terminal determines that the canvas card overlaps the first group display area 2151. If the border of the canvas card dragged into the canvas view 2150 does not intersect the border 2151-1, the client terminal determines that the canvas card does not overlap with the first group display area 2151.

Correspondingly, after the canvas card 2160 is moved to the canvas view 2150, the client terminal displays the canvas card 2220 at the position where the canvas card 2160 was originally displayed. The sending time of the instant messaging message corresponding to the canvas card 2220 is second only to the instant messaging message corresponding to the canvas card 2160.

After multiple operations by the user, the display interface of the client terminal may include, as shown in FIG. 26, a group mark 2310, a canvas card 2320, a canvas card 2330 and a canvas 2340. The grouping mark 2310 is configured to prompt the user that the canvas cards 2320 and 2330 on the right side of the display area are not grouped. The canvas card 2320 and the canvas card 2330 are configured to display the summary information of the object with the tag “meeting”.

In the embodiment shown in FIG. 26, the canvas view 2340 includes a first group 2341 and a second group 2342. The first group has the border 2341-1. The second group 2342 has the border 2342-1. The border of a group refers to the outer boundary of the group in the canvas view. Tags within the border belong to the same group. It can be seen from FIG. 26 that the tag “meeting” includes at least two groups, where one group has a tag group name of “Meeting X”, and the other group has a tag group name of “meeting Y”. The group of meeting X includes the instant messaging message “the meeting will be held at 1:00 this afternoon” sent by the leader A and the instant messaging message “Topic of the meeting this afternoon is . . . ” sent by the leader A. The group of meeting Y includes the instant messaging message “Meeting will be held at 10:00 tomorrow morning” sent by a leader B, the instant messaging message “Topic of the meeting tomorrow morning is . . . ” sent by a colleague C and the instant messaging message “tomorrow morning meeting at . . . ” sent by a colleague D.

In some embodiments, the user may divide a group into multiple subgroups, and each subgroup includes one or more objects. The specific division is similar to the aforementioned method and will not be described in detail here. It should be noted that, the method described in this embodiment may be combined with the method described in the foregoing embodiments if there is no conflict. Moreover, solutions obtained by combinations are also covered within the protection scope of the embodiments of the present disclosure.

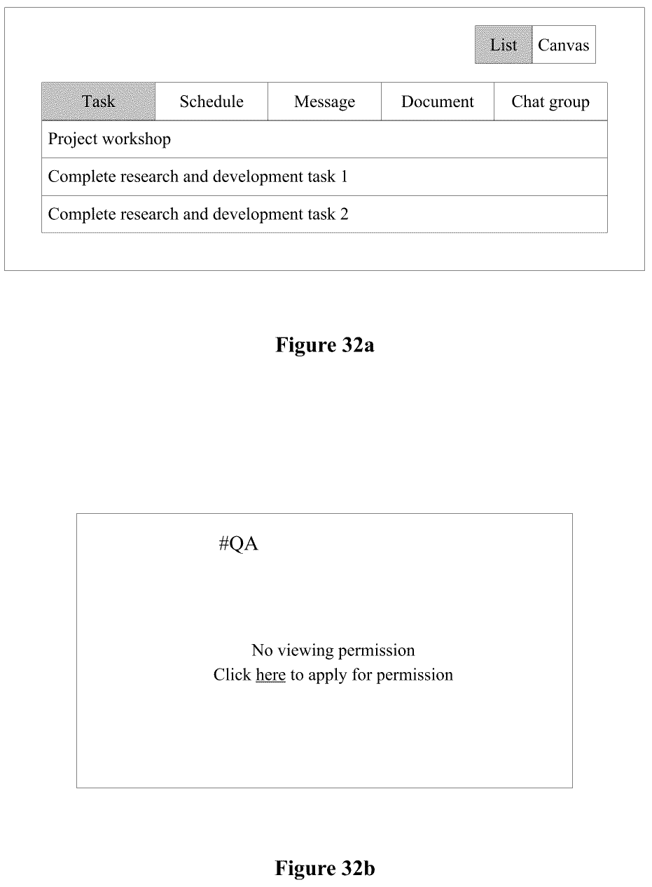

FIG. 27 is a schematic structural diagram of a device for information interaction according to an embodiment of the present disclosure. This embodiment is suitable for adding a target tag to a target object in the client terminal. The device includes: a receiving module 2410 and a generating module 2420.

The receiving module 2410 is configured to receive a tag adding operation triggered by the user on the target object. The generating module 2420 is configured to generate a correspondence according to the tag adding operation. The correspondence includes a correspondence between a target tag and the target object.

The device for information interaction according to the embodiments of the present disclosure may perform the method for information interaction according to the embodiment of the present disclosure, and has corresponding functional modules and beneficial effects for performing the method for information interaction. It should be noted that in the above-mentioned embodiments of the device for information interaction, the included units and modules are only logically divided according to their functions, but are not limited to the above-mentioned divisions, as long as the corresponding functions can be realized. In addition, the names of functional units are only for the convenience of distinguishing each other, and are not used to limit the protection scope of the present disclosure.

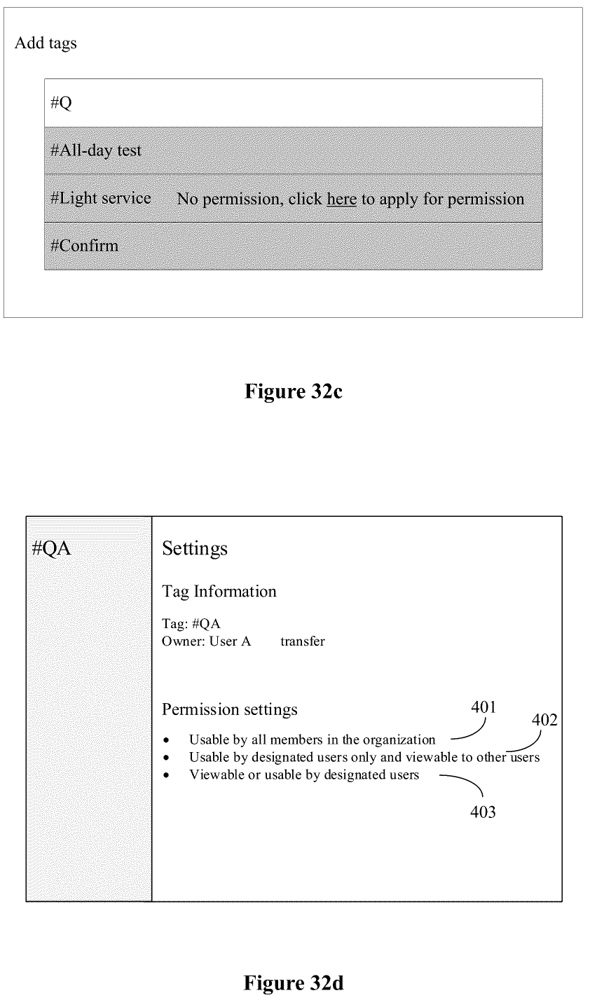

FIG. 28 is a schematic structural diagram of a tag viewing device according to an embodiment of the present disclosure. This embodiment is suitable for viewing a tag in the client terminal. The device includes: a receiving module 2510 and a display module 2520.

The receiving module 2510 is configured to receive a tag viewing operation triggered by the user on the tag viewing control. The display module 2520 is configured to display at least one tag according to the tag viewing operation.

The device for viewing a tag provided in the embodiments of the present disclosure may perform the method for viewing tag provided in embodiments of the present disclosure, and has corresponding functional modules and beneficial effects for performing the method for viewing tag.

It should be noted that, in the above embodiments of the tag viewing device, the included units and modules are only divided according to functional logic, but are not limited to the above division, as long as the corresponding functions can be realized. In addition, the names of the functional units are only for the convenience of distinguishing each other, and are not used to limit the protection scope of the present disclosure.

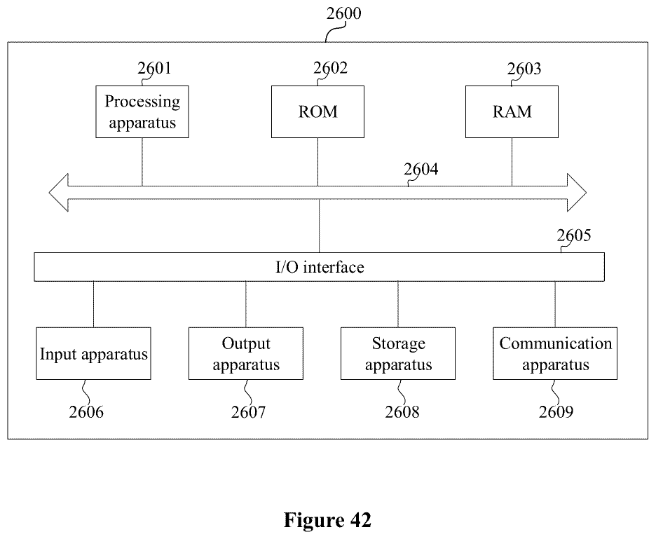

For details about an electronic device according to an embodiment of the present disclosure, reference is made to related content in subsequent FIG. 42. The method for an electronic device to interact with the information provided in the above embodiments and the method for viewing tag belong to the same inventive concept. For technical details not exhaustively described in the embodiments of the present disclosure, reference may be made to the foregoing embodiments. Moreover, the embodiments of the present disclosure have the same beneficial effects as the above-mentioned embodiments.

According to an embodiment of the present disclosure, a computer storage medium is provided, on which a computer program is stored. When the program is executed by the processor, the method for information interaction or the method for viewing tag according to the foregoing embodiments is performed.

According to one or more embodiments of the present disclosure, [Example 1] provides a method for information interaction. The method includes: receiving a tag adding operation triggered by a user on a target object; and generating a correspondence according to the tag adding operation. The correspondence includes a correspondence between a target tag and the target object.

According to one or more embodiments of the present disclosure, [Example 2] provides a method for information interaction. Optionally, the target tag is created by another user other than the user.

According to one or more embodiments of the present disclosure, [Example 3] provides a method for information interaction. Optionally, the receiving a tag adding operation triggered by a user on the target object includes: receiving a tag adding operation triggered by the user on a tag adding control of the target object.

According to one or more embodiments of the present disclosure, [Example 4] provides a method for information interaction. The method further includes: before receiving the tag adding operation triggered by the user on a tag adding control of the target object, receiving a selection operation triggered by the user for the target object; and displaying the tag addition operation according to the selection operation on the target object control.

According to one or more embodiments of the present disclosure, [Example 5] provides a method for information interaction. The method further includes: before receiving the tag adding operation triggered by the user on the tag adding control of the target object, receiving a display operation of the tag adding control triggered by the user; and displaying the tag adding control according to the display operation.

According to one or more embodiments of the present disclosure, [Example 6] provides a method for information interaction. Optionally, the acquiring the target tag determined by the user according to the tag adding operation includes: displaying at least one candidate tag according to the tag adding operation, where the at least one candidate tag includes the target tag; receiving a selection operation of the target tag by the user; and determining the target tag according to the selection operation.

According to one or more embodiments of the present disclosure, [Example 7] provides a method for information interaction. Optionally, the displaying at least one candidate tag according to the tag adding operation includes: displaying a tag input box according to the tag adding operation; receiving a keyword inputted by a user in the tag input box; and displaying at least one candidate tag matching the keyword.

According to one or more embodiments of the present disclosure, [Example 8] provides a method for information interaction. Optionally, the at least one candidate tag is arranged according to a preset rule.

According to one or more embodiments of the present disclosure, [Example 9] provides a method for information interaction. Optionally, the preset rule includes one or more of: tag creation time, tag access time, and matching degree with the keyword.

According to one or more embodiments of the present disclosure, [Example 10] provides a method for information interaction. Optionally, after acquiring the target tag determined by the user according to the tag adding operation, the method further includes: displaying prompt information, where the prompt information indicates that adding the target tag to the target object is finished.

According to one or more embodiments of the present disclosure, [Example 11] provides a method for information interaction. Optionally, after acquiring the target tag determined by the user according to the tag adding operation, the method further includes: receiving a tag viewing operation on the target object triggered by the user; and displaying the target tag according to the viewing operation.

According to one or more embodiments of the present disclosure, [Example 12] provides a method for information interaction. Optionally, after acquiring the target tag determined by the user according to the tag adding operation, the method further includes: displaying a content viewing control; receiving a viewing operation triggered by the user on the content viewing control; and displaying an object corresponding to the target tag according to the viewing operation.

According to one or more embodiments of the present disclosure, [Example 13] provides a method for information interaction. Optionally, the correspondence between the target tag and the target object includes: the correspondence between the target tag and the information block of the target object. The information block is generated based on the target object.

According to one or more embodiments of the present disclosure, [Example 14] provides a method for information interaction. Optionally, the method further includes: jumping to an interface including the target object in response to a trigger operation on the information block; and/or displaying the target object in response to a trigger operation on the information block.

According to one or more embodiments of the present disclosure, [Example 15] provides a method for information interaction. Optionally, before receiving the tag adding operation triggered by the user on the target object, the method includes: receiving the adding operation triggered by the user on the target tag, and displaying at least one candidate object according to the adding operation; and determining a candidate object selected by the user from the at least one candidate object as the target object.

According to one or more embodiments of the present disclosure, [Example 16] provides a method for information interaction. Optionally, the at least one candidate object is classified and presented according to the tag domain from which the candidate object originates.

According to one or more embodiments of the present disclosure, [Example 17] provides a method for information interaction. Optionally, the method further includes: receiving a permission setting operation of the user on the target tag, and determining that the user has operation permission of the target tag according to the permission setting operation. The operation permission includes editing permission and/or viewing permission.

According to one or more embodiments of the present disclosure, [Example 18] provides a method for information interaction. Optionally, the editing permission and/or viewing permission of the target tag includes: editable by all members in the organization; or editable by added collaborators and viewable by other members; or editable or viewable by only added collaborators. The collaborator is a user who collaboratively edits the information block of the target tag.

According to one or more embodiments of the present disclosure, [Example 19] provides a method for information interaction. Optionally, in response to the user setting the permission of the target tag to be editable by the added collaborators and viewable by other members, the method further includes: acquiring information of the collaborators determined by the user.

According to one or more embodiments of the present disclosure, [Example 20] provides a method for information interaction. Optionally, the method further includes: receiving a delete operation of the user on the target tag; and deleting the target tag according to the delete operation.

According to one or more embodiments of the present disclosure, [Example 21] provides a method for information interaction. Optionally, the correspondence includes a correspondence between the target tag, the information block of the target object, and the user information.

According to one or more embodiments of the present disclosure, [Example 22] provides a method for information interaction. Optionally, the target object includes at least one of: a cloud document, a schedule, a task, an instant messaging message and a group chat IM message.

According to one or more embodiments of the present disclosure, [Example 23] provides a method for information interaction. The method includes: receiving a tag adding operation triggered by a user on a target cloud document; acquiring a target tag determined by the user according to the tag adding operation; and generating a correspondence between the target cloud document and the target tag.

For the relevant content of this embodiment, reference is made to the above.

According to one or more embodiments of the present disclosure, [Example 24] provides a method for information interaction. The method includes: receiving a tag adding operation triggered by a user on a target schedule; acquiring a target tag determined by the user according to the tag adding operation; and generating a correspondence between the target tag and the target schedule.

For the relevant content of this embodiment, reference is made to the above.

According to one or more embodiments of the present disclosure, [Example 25] provides a method for information interaction. The method includes: receiving a tag adding operation triggered by a user on a target IM message; acquiring a target tag determined by the user according to the tag adding operation; and generating a correspondence between the target tag and the target IM message.

For the relevant content of this embodiment, reference is made to the above.

According to one or more embodiments of the present disclosure, [Example 26] provides a method for information interaction. Optionally, the target IM message includes a private chat IM message or a group chat IM message.

According to one or more embodiments of the present disclosure, [Example 27] provides a method for information interaction. The method includes: receiving a tag adding operation triggered by a user on a target IM group; acquiring a target tag determined by the user according to the tag adding operation; and generating a correspondence between the target tag and the target IM group.

For the relevant content of this embodiment, reference is made to the above.

According to one or more embodiments of the present disclosure, [Example 28] provides a method for information interaction. The method includes: receiving a tag adding operation triggered by a user on a target task; acquiring a target tag determined by the user according to the tag adding operation; and generating a correspondence between the target tag and the target task.

For the relevant content of this embodiment, reference is made to the above.

According to one or more embodiments of the present disclosure, [Example 29] provides a method for viewing a tag. The method includes: receiving a tag viewing operation triggered by a user on a tag viewing control; and displaying at least one tag according to the tag viewing operation.

According to one or more embodiments of the present disclosure, [Example 30] provides a method for viewing a tag. Optionally, the at least one tag includes one or more of: a tag created by the user; a tag created by a user different from the user and for which the user has viewing permission.

According to one or more embodiments of the present disclosure, [Example 31] provides a method for viewing a tag. Optionally, the method further includes: receiving a filter trigger operation performed by the user on a filter control; and presenting a filter result corresponding to the filter operation triggered by the filter trigger operation.

According to one or more embodiments of the present disclosure, [Example 32] provides a method for a viewing tag. Optionally, the filter operation is configured to filter the tags presented on the target interface according to an attribute value of at least one attribute.

According to one or more embodiments of the present disclosure, [Example 33] provides a method for viewing a tag. Optionally, the at least one attribute includes one or more of: belonging to the user, belonging to another user, and unlimited belonging.

According to one or more embodiments of the present disclosure, [Example 34] provides a method for viewing a tag. Optionally, the receiving the tag viewing operation triggered by the user on the tag viewing control includes: receiving the tag viewing operation triggered by the user on the tag viewing control displayed associatively with the target object. The displaying at least one tag according to the tag viewing operation includes: displaying at least one tag of the target object according to the tag viewing operation.

According to one or more embodiments of the present disclosure, [Example 35] provides a method for viewing a tag. Optionally, the at least one tag includes a first tag. The method further includes: receiving a viewing operation triggered by the user on the first tag, and displaying an information block of at least one object with the first tag.

According to one or more embodiments of the present disclosure, [Example 36] provides a method for viewing a tag. Optionally, the information block of the at least one object with the first tag is classified and presented according to the tag domain from which the object originates.

According to one or more embodiments of the present disclosure, [Example 37] provides a method for viewing a tag. Optionally, the tag domain includes one or more of: a task, a schedule, a cloud document, an instant messaging message, and an instant messaging group.

According to one or more embodiments of the present disclosure, [Example 38] provides a method for viewing a tag. Optionally, the information block of each object in the at least one object is presented in a list or a canvas card.

According to one or more embodiments of the present disclosure, [Example 39] provides a method for viewing a tag. Optionally, the method further includes: receiving a grouping operation of at least one object with the first tag triggered by the user; and grouping one or more objects in the at least one object according to the grouping operation.

According to one or more embodiments of the present disclosure, [Example 40] provides a method for viewing a tag. Optionally, the method further includes: acquiring a tag group name. The tag group name is used to generate a correspondence. The correspondence is the correspondence between the first tag, the object of the group and the tag group name.

According to one or more embodiments of the present disclosure, [Example 41] provides a method for viewing a tag. Optionally, the at least one object includes a first object. The information block of the first object is displayed in the first canvas card. The receiving the user-triggered grouping operation of at least one object on the first tag includes: receiving a dragging operation performed by the user of dragging the first canvas card to the first group in the canvas view.

According to one or more embodiments of the present disclosure, [Example 42] provides a method for viewing a tag. Optionally, the at least one object includes a first object. The method further includes: jumping to an interface of the first object associated with the information block in response to a trigger operation on the information block of the first object; and/or displaying the first object in response to a trigger operation on the information block of the first object.

According to one or more embodiments of the present disclosure, [Example 43] provides a method for viewing a tag. Optionally, the at least one object with of the first tag includes a first object. The method further includes: deleting the correspondence between the first object and the first tag in response to receiving the tag delete operation performed by the user on the first object.

According to one or more embodiments of the present disclosure, [Example 44] provides a method for viewing a tag. Optionally, the displaying at least one tag according to the tag viewing operation includes: displaying the at least one tag and creator information of each tag in the at least one tag according to the tag viewing operation.

According to one or more embodiments of the present disclosure, [Example 45] provides a method for viewing tags. Optionally, the at least one tag includes a second tag. The second tag is created by a user different from the user and the user does not have permission to view it. The method further includes: receiving a permission application operation on the second tag triggered by the user; and sending a permission application request to the user corresponding to the second tag according to the permission application operation. The permission application request is for applying for viewing permission to the second tag.

According to one or more embodiments of the present disclosure, [Example 46] provides a method for viewing tags. Optionally, the method further includes: receiving a bookmark operation triggered by the user on a target tag in the at least one tag; and bookmarking the target tag according to the bookmark operation.

According to one or more embodiments of the present disclosure, [Example 47] provides a method for viewing tags. Optionally, the method further includes: receiving a viewing operation triggered by the user on the bookmarked tag control; and displaying the bookmarked tag in the at least one tag according to the viewing operation.

According to one or more embodiments of the present disclosure, [Example 48] provides a method for viewing tags. Optionally, the at least one tag is sorted according to a preset rule.

According to one or more embodiments of the present disclosure, [Example 49] provides a method for viewing tags. Optionally, the preset rule includes one or more of: tag access time, tag creation time, and tag priority.

According to one or more embodiments of the present disclosure, [Example 50] provides a method for viewing tags. The method includes: receiving a tag viewing operation triggered by a tag viewing control of a target cloud document by a target user; and displaying at least one tag of the target cloud document according to the tag viewing operation.

For the relevant content of this embodiment, reference is made to the above.

According to one or more embodiments of the present disclosure, [Example 51] provides a method for viewing tags. The method includes: receiving a tag viewing operation triggered by a target user on a tag viewing control of a target schedule; and displaying at least one tag of the target schedule according to the tag viewing operation.

For the relevant content of this embodiment, reference is made to the above.

According to one or more embodiments of the present disclosure, [Example 52] provides a method for viewing tags. The method includes: receiving a tag viewing operation triggered by a target user on a tag viewing control of a target task; and displaying at least one tag of the target task according to the tag viewing operation.

For the relevant content of this embodiment, reference is made to the above.

According to one or more embodiments of the present disclosure, [Example 53] provides a method for viewing tags. The method includes: receiving a tag viewing operation triggered by a target user on a tag viewing control of a target IM message; and displaying at least one tag of the target IM message according to the tag viewing operation.

For the relevant content of this embodiment, reference is made to the above.

According to one or more embodiments of the present disclosure, [Example 54] provides a method for viewing tags. The method includes: receiving a tag viewing operation triggered by a target user on a tag viewing control of a target instant messaging IM group; and displaying at least one tag of the target IM group according to the tag viewing operation.

For the relevant content of this embodiment, reference is made to the above.

According to one or more embodiments of the present disclosure, [Example 55] provides a device for information interaction. The device includes: a receiving module configured to receive a tag adding operation triggered by a user on a target object; and a generating module configured to generate a correspondence according to the tag adding operation. The correspondence includes a correspondence between a target tag and the target object.

According to one or more embodiments of the present disclosure, [Example 56] provides a device for viewing a tag. The device includes: a receiving module configured to receive a tag viewing operation triggered by a user on a tag viewing control; and a display module configured to display at least one tag according to the tag viewing operation.

According to one or more embodiments of the present disclosure, [Example 57] provides an electronic device. The electronic device includes: one or more processors, and a memory. The memory is configured to store one or more programs. The one or more processors are configured to execute the one or more programs to implement the method for information interaction or the method for viewing a tag as described in the embodiments of the present disclosure.

According to one or more embodiments of the present disclosure, [Example 58] provides a computer-readable storage medium on which a computer program is stored. When the program is executed by the processor, the method for information interaction or the method for viewing a tag as described in the embodiments of the present disclosure is implemented.

How to integrate and manage the information related to the project is a problem desired to be resolved. In order to integrate information related to the project so that users (e.g., project managers, and project participants) can determine the information related to the project, users may tag the information related to the project to integrate the information related to the project based on the tag.

In order to avoid the disclosure of project-related information during the project development, permissions may be set for the project-related tags. Only users authorized with tag permissions can perform corresponding operations on the tag.

At present, the permission of the tag is strongly coupled with the permission of the information with the tag. However, this scheme does not meet the actual needs. For example, information 1 is tagged with a tag 1, and a user 1 has the tag permission of the tag 1, and then the user 1 also has the viewing permission of the information 1. However, this scheme cannot effectively protect information security. This is because although multiple organizations are involved in the development of the same project, different organizations may be responsible for different focuses. Correspondingly, in principle, only members of organizations that create information with relatively high confidentiality requirements can view the information. For another example, the information 1 is tagged with the tag 1, and the user 1 has no tag permission of the tag 1, and therefore the user 1 is not allowed to view the information 1 correspondingly. However, if the permission setting of the tag 1 is relatively strict, and the information 1 has no special confidentiality requirements, this method is not conducive to information sharing.

In view of this, a method for processing information is provided according to an embodiment of the present disclosure, so as to manage project-related information. Various non-limiting implementations of the present disclosure will be described in detail below with reference to the drawings.

### EXEMPLARY METHOD

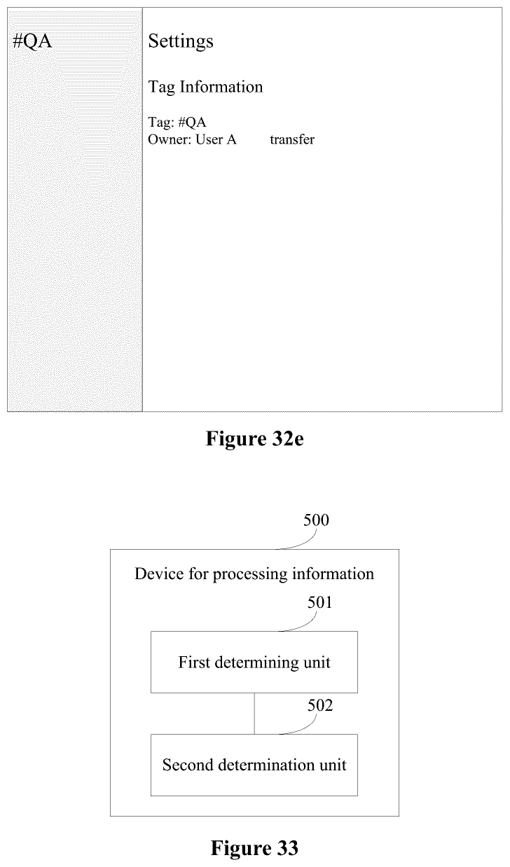

FIG. 29 is a schematic flowchart of a method for processing information according to an embodiment of the present disclosure.

The method according to the embodiment of the present disclosure is performed by a first device. The first device is a client terminal or a server, which is not specifically limited in this embodiment of the present disclosure.

In this embodiment of the present disclosure, a target application program is installed on the first device. The first user mentioned in the embodiment of the present disclosure refers to the user corresponding to the account that logs in the target application program on the first device.

Unless otherwise specified, the information mentioned in the embodiments of this application, such as first information, second information, third information or target information, may be one or more of a task, a schedule, a message, a document and a chat group, etc. The information unit mentioned in the embodiments of the present disclosure is also one of a task, a schedule, a message, a document, and a chat group. In some contexts, “information unit” and “information” may be used interchangeably.

Symbol “#” in the embodiments of the present disclosure and the drawings is a tag identifier. The tag identifier is not limited to “#”, and may be other symbols.

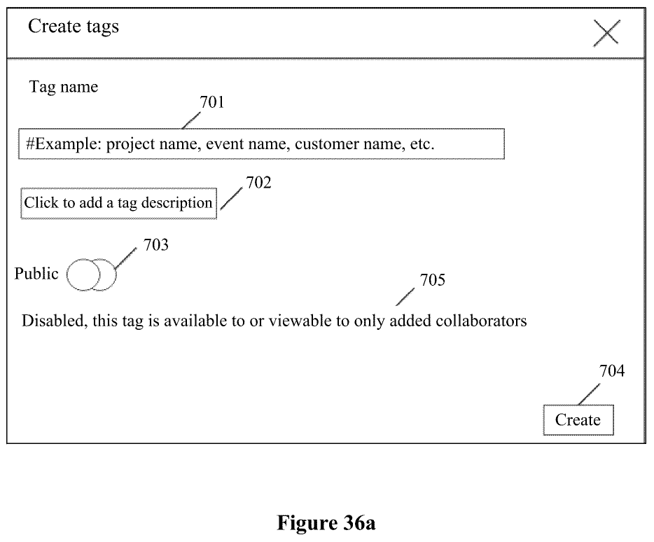

The following method shown in FIG. 29 may be combined and referred to with the method shown in FIG. 31 if there is no conflict.

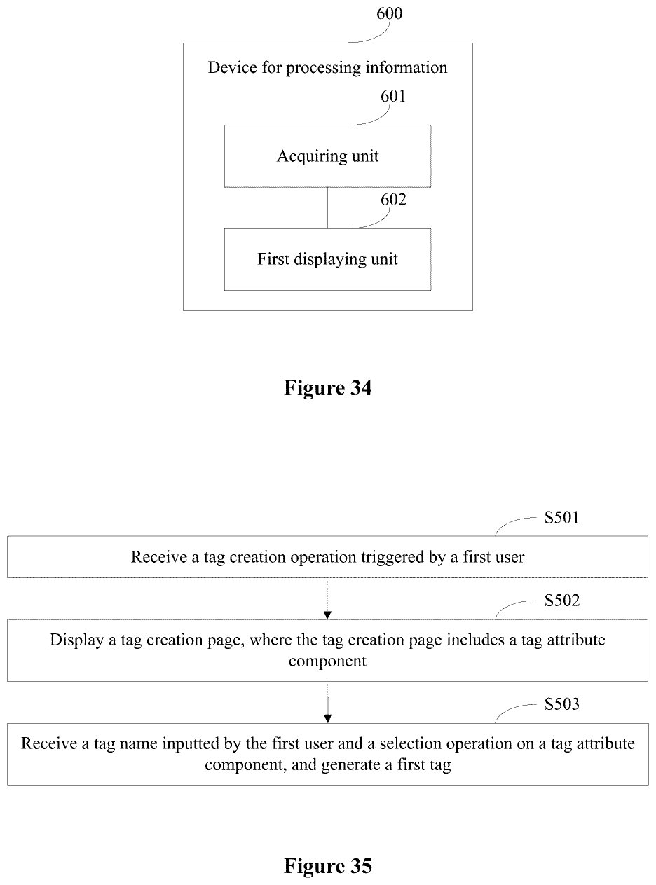

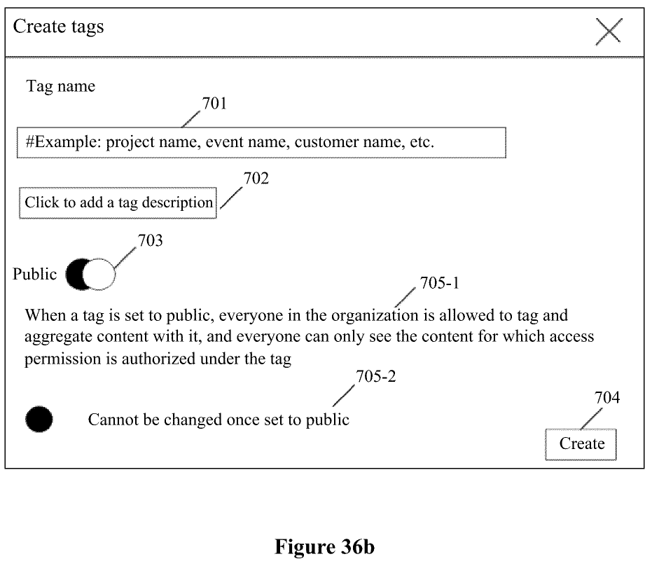

All the drawings in the embodiment of the present disclosure, such as FIG. 30, FIG. 32a to FIG. 32e, are only shown for the convenience of understanding the content related to the embodiment of the present disclosure, rather than constitute a limitation to the embodiments of the present disclosure. The pages shown in FIG. 30 and FIG. 32a to FIG. 32e also include other content, which is not specifically limited in this embodiment of the present disclosure.

In this embodiment, the method includes, for example, the following steps S301 to S302.

In S301, permission authorized to the first user for the first tag and viewing permission authorized to the first user for the first information are determined. The first information has the first tag.

In this embodiment of the present disclosure, permission authorized to the first user for the first tag and viewing permission authorized to the first user for the first information are stored locally on the client terminal corresponding to the first user or on the server of the target application program. The first device determines the permission authorized to the first user for the first tag and viewing permission authorized to the first user for the first information locally from the client terminal corresponding to the first user or from the server, which is not specifically limited in this embodiment of the present disclosure. It can be understood that the target application program is installed on the client terminal corresponding to the first user mentioned here.

In S302, the content to be presented to the first user is determined according to the permission authorized to the first user for the first tag and viewing permission authorized to the first user for the first information.

In this embodiment of the present disclosure, permissions are defined for the first tag itself. Information with the first tag, such as the first information, also is defined with corresponding viewing permission. The viewing permission of the first information is independent of the permission of the first tag. The viewing permission of the first information mentioned here indicates whether the first user has the permission to view the first information. For example, it is determined according to the viewing permission of the first information whether the content of the first information is viewable by the user, and/or which part of the content of the first information is viewable by the user.

In this embodiment of the present disclosure, the content to be presented to the first user should consider the viewing permission authorized to the first user for the first information and the permission authorized to the first user for the first tag. In this way, information security problems and disadvantages in information sharing caused by determining the content to be presented to the first user by only considering the permission authorized to the first user for the first tag are avoided. The content presented to the first user may be presented on the client terminal corresponding to the first user.

In an example, the permission authorized to the first user for the first tag includes the viewing permission authorized to the first user for the first tag. The viewing permission authorized to the first user for the first tag indicates whether the first user has the permission to view the associated information of the first tag. The associated information of the first tag mentioned here refers to information having a correspondence with the first tag. Correspondingly, the permission authorized to the first user to view the associated information of the first tag includes, but is not limited to, whether the client terminal used by the first user can present the first tag. In some application scenarios, the user has the viewing permission of certain information and has no viewing permission of a tag A. Then, if the user views the information on the client terminal used by the user, the information is not displayed in association with the tag A.

In an example, the associated information of the first tag is presented on an associated page of the first tag. In this case, the viewing permission authorized to the first user for the first tag indicates whether the first user has the permission to view the associated page of the first tag. In this case, if the first user has the permission to view the first tag, the first user is allowed to view the associated page of the first tag. If the first user has no permission to view the first tag, the first user is not allowed to view the associated page of the first tag.

In an example, if the first user has the permission to view the first tag but has no permission to view the first information, it is determined that the first page presented to the first user does not include the first information. The first page mentioned here may be an associated page of the first tag or other pages, for example, an instant messaging session interface. In other words, even if the first user has the permission to view the first tag, the content to be presented to the first user does not include the first information if the first user has no permission to view the first information. For example, the first page is the associated page of the first tag, and the associated page does not include the first information. In this manner, the information security of the first information can be effectively protected.

In an example, the first page is, for example, an instant messaging session interface. In this case, the first information may be files published by other users in the instant messaging session indicated by the instant messaging session interface. It can be understood that the first user is included in the instant messaging session indicated by the instant messaging session interface. For this situation, if the first user has no permission to view the files published by other users in the instant messaging session indicated by the instant messaging session interface, then the instant messaging session interface displayed on the client terminal corresponding to the first user does not include the first information. For example, both the first user and the second user are in the instant messaging session interface. If the second user publishes a document and the first user has no permission to view the document, the instant messaging session interface displayed on the client corresponding to the first user does not include the document. In one scenario, the instant messaging session indicated by the instant messaging session interface may only include the first user and the second user, or may also include other users, which is not specifically limited in this embodiment of the present disclosure.

In an example, if the first user has permission to view the first tag, the associated page of the first tag may be presented to the first user. For example, the associated page may include summary information of an information unit that has the first tag and that the first user has permission to view. For example, the first user has the permission to view the second information and the second information has the first tag, and the associated page of the first tag may include summary information of the information unit of the second information. Correspondingly, if the first user has no permission to view the first information, in an example, the associated page of the first tag presented to the first user does not include summary information of the first information. In this embodiment of the present disclosure, the summary information of an information unit refers to part of the information in the information unit, for example, part of keywords in the information unit. In another example, the associated page of the first tag presented to the first user includes summary information and prompt information of the first information. The prompt information prompts that the first user has no permission to view the first information and prompts the first user to apply to the owner of the first information for the permission to view the first information. For this situation, in an example, the first user triggers a preset operation on the summary information of the first information, so as to apply to the owner of the first information for viewing permission of the first information. The preset operation mentioned here is, for example, a click operation.

In an example, for the summary information of the second information displayed on the associated page, the first user may also trigger a preset operation on the summary information of the second information to view the second information. The preset operation triggered by the first user for the summary information of the second information is, for example, a click operation. In an example, the first user triggers the preset operation on the summary information of the second information, and the first device responds to the preset operation triggered by the first user for the summary information of the second information to display the second information. For example, a page is separately loaded in the associated page to display the second information. In another example, the second information is displayed in a certain area on the associated page, such as a sidebar. In another example, the first user triggers the preset operation on the summary information of the second information, then the first device jumps to a page including the second information in response to the preset operation triggered by the first user for the summary information of the second information. For example, when the second information is an instant messaging message, the instant messaging session interface where the instant messaging message is located is displayed after the first user triggers the preset operation on the information summary of the second information. For another example, the second information is an IM group, and an instant messaging session interface corresponding to the IM group is displayed after the first user triggers a preset operation on the information summary of the second information.

In another example, the first user has the permission to use the first tag, and the first information is information in an instant messaging session. If the first user is not in the instant messaging session, the first user must not have the permission to view the first information. However, if the first user subsequently joins the instant messaging session including the first information, the first user has the permission to view the first information in some application scenarios. In this case, the first information and the first tag in the instant messaging session may be associatively presented to the first user. Associatively presenting the first information with the first tag refers to presenting the first information and presenting a correspondence between the first information and the first tag. The first user determines, based on the associatively presented first information with the first tag, that the first information has the first tag.

As mentioned above, the viewing permission authorized to the first user for the first tag indicates whether the first user has the permission to view the associated information of the first tag. The associated information of the first tag may be presented on the associated page of the first tag. In some embodiments, the first user has no permission to view the first tag. Then no matter whether the first user has the permission to view the first information, the content to be presented to the first user does not include the associated page of the first tag.

In an example, the first user has no permission to view the first tag but has the permission to view the first information, the first device may determine that the content to be presented to the first user includes a page including the first information. In addition, since the first user has no permission to view the first tag, the page including the first information does not present the correspondence between the first information and the first tag. For convenience of description, the “page including the first information” is referred to as the second page. Then the second page may include the first information. The first user can view the first information on the second page. However, the correspondence between the first information and the first tag is not displayed on the second page. In other words, the first user can view the first information through the second page, but fails to confirm that the first information has the first tag through the second page. The second page mentioned here is, for example, an instant messaging session interface including the first user. The first information may include, for example, session messages in the instant messaging session indicated by the instant messaging session interface, and/or files published by other users in the instant messaging session indicated by the instant messaging session interface. The instant messaging session interface mentioned here may be an instant messaging interface including two users, or an instant messaging session interface including more than two users, which is not specifically limited in the embodiment of the present disclosure.

It is found that there is no special restriction on the tags when users tag information currently. That is, for a tag such as “Project A R&D”, any users can use this tag to tag the content they want to tag. However, this is not conducive to the integration of the aforementioned project-related information. For example, if a team A and a team B jointly develop the project A, then the team A and the team B can use the tag “Project A R&D” to tag related information, and other users can also use the tag “Project A R&D” to tag related information. Therefore, when using the tag “Project A R&D” for information integration, other content annotated by other users will also be integrated (For example, another user added a tag “Project A R&D” to a piece of information and fails to set access permission to the information, or the access permission set by another user to the information happened to be such that the information is also viewable by members in the Team A and/or the Team B).

In view of this, in this embodiment of the present disclosure, the permission authorized to the first user for the first tag includes not only the viewing permission to the first user for the first tag, but also the use permission authorized to the first user for the first tag. The use permission authorized to the first user for the first tag indicates whether the first user has the permission to add the first tag to the information.

Regarding the use permission and viewing permission of the first tag, it should be noted that, in an example, the priority of the use permission is higher than that of the viewing permission. In other words, if the first user has the permission to use the first tag, the first user must also have the permission to view the first tag. Conversely, if the first user has the permission to view the first tag, the first user does not necessarily have the permission to use the first tag.

For the first tag, the first user is not allowed to add the first tag according to his own subjective will, and whether the first user is allowed to use the first tag depends on the use permission of the first tag.

In an example, if the first user has the permission to use the first tag, the first user can add the first tag to the target information. The following introduces an embodiment in which the first user adds a first tag to the target information.

In an example, the first user triggers a tag adding operation for the target information. After the first user triggers a tag adding operation for the target information, the first device displays a tag adding page. The tag adding page includes a character input area. The first user inputs at least a part of characters included in the first tag in the character input area. Correspondingly, after acquiring the characters inputted by the first user, the first device may provide, according to the characters inputted by the first user, corresponding tag candidates for the first user, and display the tag candidates on the tag adding page, so that the user can select the tag that he wants to add based on the tag candidates. In an example, the tag candidates include the first tag. In this way, the first user triggers a selection operation on the first tag. After the first user triggers a selection operation on the first tag, the first device generates a correspondence between the first tag and the target information, thereby adding the first tag to the target information.

In an example, the first user adds, on the associated page of the first tag, the first tag to the target information. The first user triggers an information block adding operation on the associated page of the first tag. The first device displays at least one candidate information block in response to the information block adding operation triggered by the first user. The first user selects target information from at least one displayed information block, and then triggers a tag adding operation for the target information. After the first user triggers the tag adding operation for the target information, the first device generates a correspondence between the first tag and the target information in response to the first user triggering the tag adding operation on the target information, thereby adding the first tag to the target information. The first user triggers the information block adding operation on the associated page of the first tag, for example, inputs a part of characters included in the target information in the character input area of the associated page.

It can be seen that, in the embodiment of the present disclosure, the first user is allowed to add the first tag to the information only if he has the permission to use the first tag. In an example, users in a team (for example, the team of the R&D project A) are allowed to use the first tag. Users outside of this team are not allowed to use the first tag. In this way, users outside the team are prevented from adding the first tag to the information, thereby facilitating the information integration of the project A based on the first tag. Therefore, this solution is conducive to information integration.

In an example, the first user triggers a viewing operation on the first tag. In an example, the first user may trigger a tag viewing operation for the tag sharing information, so as to trigger a viewing operation for a tag indicated by the tag sharing information. After the first user triggers the tag viewing operation on the tag sharing information, the first device may determine, based on the viewing permission authorized to the first user for the tag indicated by the tag sharing information, the content presented in the tag-associated page presented to the first user. The tag sharing information, for example, is a hyperlink or a tag identifier, which is not specifically limited in this embodiment of the present disclosure. The tag viewing operation triggered for the tag sharing information, for example, is a click operation. For details about “determining the presentation content in the tag-associated page presented to the first user based on the viewing permission authorized to the first user to the tag indicated by the tag sharing information”, reference is made to the above relevant descriptions of “the viewing permission authorized to the first user for the first tag” and “content presented on the associated page of the first tag presented to the first user”, and therefore the description is brief here.

The above tag adding page can be understood in conjunction with FIG. 30, which is a schematic diagram of a tag adding page according to an embodiment of the present disclosure. As shown in FIG. 30, after the first user enters the character “#Q” in the tag adding page, the tag candidates “all-day test”, “light service”, “confirm” and so on are displayed. The first tag is “light service”, and the first user triggers a selection operation for the first tag “light service”. For example, the first user clicks on the first tag “light service”, thereby adding the first tag to the target information.

A method for processing information is also provided according to an embodiment of the present disclosure. The method is described below with reference to the drawings.

FIG. 31 is a schematic flowchart of a method for processing information according to an embodiment of the present disclosure. The method shown in FIG. 31 is performed by the first device. For the first device, reference may be made to the relevant description above, and details are not described here. The method shown in FIG. 31 includes, for example, the following steps S401 to S402.

In S401, in response to a viewing operation triggered by the first user for the first tag, the viewing permission authorized to the first user for the first tag is acquired. The viewing permission indicates whether the first user has permission to view the associated information of the first tag.

In an example, the first user triggers a viewing operation on the first tag. In an example, the first user triggers a viewing operation for the first tag on a page including tag sharing information. The tag sharing information indicates an entry for accessing associated information of the first tag. In an example, the page including the tag sharing information is an instant messaging session interface. The tag sharing information is shared by users in the instant messaging session interface to the instant messaging session interface. In another example, the first user searches for the first tag in the tag management interface, and further triggers a viewing operation on the found first tag after the first tag is obtained from the search.

After the first user triggers the viewing operation on the first tag, the first device acquires the viewing permission authorized to the first user for the first tag in response to the viewing operation by the first user on the first tag. Then, the content to be presented to the first user is determined according to the viewing permission authorized to the first user for the first tag.

In S402, associated information of the first tag is displayed in response to determining that the first user has the permission to view the first tag.

In an example, the first user has the permission to view the first tag, and the associated information of the first tag is presented to the first user.

In an embodiment, the associated information of the first tag is displayed on the associated page of the first tag. Therefore, the associated page of the tag is displayed in S402.

For example, the associated page includes summary information of an information unit that have the first tag and that the first user has permission to view. For example, if the first user has the permission to view the second information and the second information has the first tag, the associated page of the first tag includes summary information of the information unit of the second information. In an example, if the first user has no permission to view the first information, the associated page of the first tag does not include the summary information of the first information. In this embodiment of the present disclosure, the summary information of an information unit refers to part of the information in the information unit, for example, part of keywords in the information unit.

In this embodiment of the present disclosure, the information summaries of the information units with the first tag are classified and presented on the associated page of the first tag according to the message domain from which each information unit originates. The information unit with the first tag includes a first information unit. Then the message domain, from which the first information unit originates, indicates the source of the first information unit. In an example, the message domain from which the first information unit originates indicates the service provider corresponding to the first information unit. The service provider mentioned here may be, for example, an instant messaging session service provider or a file service provider.

The information summaries about the information units with the first tag are classified and presented on the associated page of the first tag according to the message domain from which each information unit comes, which can be understood with reference to FIG. 32a, which is a schematic diagram of an associated page of the first tag according to an embodiment of the present disclosure.

As shown in FIG. 32a, the associated page includes five message domains, which are “task”, “schedule”, “message”, “document” and “chat group”. In the associated page shown in FIG. 32a, the message domain “task” is already selected. The page displays information summaries corresponding to 3 tasks, namely “Project Seminar”, “Complete R&D Task 1”, and “Complete R&D Task 2”. It should be noted that although the content corresponding to the message domain “task” shown in FIG. 32a is displayed in a list, FIG. 32a is only shown for the convenience of understanding and does not constitute a limitation to the embodiment of the present disclosure. In an example, the content corresponding to the message domain “task” may alternatively be displayed in the form of canvas. For example, the user may switch the display form of the content corresponding to each tag through the controls “list” and “canvas” shown in FIG. 4a, which is not described in detail here.

In an example, the first user may trigger a preset operation on the summary information of the second information displayed on the associated page to view the second information. For the relevant description of the first user triggering the preset operation on the summary information of the second information, reference is made to the relevant description part of the method shown in FIG. 29 above, and the description is not repeated here.

In another example, for the third information, in addition to the summary information of the second information, the associated page of the first tag also includes summary information of the third information, even if the first user has no permission to access the third information.

In this case, the first user may trigger the preset operation on the information summary of the third information, so as to apply to the owner of the third information for viewing permission of the third information. In an example, after viewing the information summary of the third information, the first user, if wishes to further view the specific content of the third information, may trigger the preset operation on the information summary of the third information (for example, clicking the information summary of point information), to apply to the owner of the third information for viewing permission of the third information. If the owner of the third information grants the application, the first user can further view the third information. The owner of the third information mentioned here may be, for example, the publisher or creator of the third information.

In this way, for the third information whose confidentiality requirements are not very strict, the summary information of the third information is displayed on the associated page of the first tag and an entry for the first user to apply for viewing the third information is provided, thereby facilitating information sharing.

As described above, the first device determines the content to be presented to the first user according to the viewing permission authorized to the first user for the first tag. In an example, when determining that the first user has no permission to view the first tag, the first device displays first prompt information. The first prompt information indicates that the first user has no permission to view the associated information of the first tag. In another example, in addition to indicating that the first user has no permission to view the associated information of the first tag, the first prompt information further instructs the first user to apply to the owner of the first tag for permission to view the first tag. In this case, if wishing to view the associated information of the first tag, the first user triggers a preset operation on the first prompt information. The first user triggers the preset operation for the first prompt information. For example, after the first user clicks on the first prompt information, the first device applies to the owner of the first tag for permission to view the first tag in response to the preset operation triggered by the first user for the first prompt information. If the owner of the first tag grants the application, the first user can view the associated information of the first tag. For example, the first device displays the associated page of the first tag.

It can be understood in conjunction with FIG. 32b, which is a schematic diagram of a page according to an embodiment of the present disclosure. In FIG. 32b, if the first user does not have the viewing permission of the first tag “QA”, the first device displays the first prompt information “No permission to view, click here to apply for permission” after the first user triggers the viewing operation on the first tag.

As mentioned above, in addition to the permission to view the first tag, the permission authorized to the first user for the first tag also includes the permission to use the first tag.

In an embodiment, if the first user has the permission to use the first tag, the first user can add the first tag to the target information. For an embodiment in which the first user adds a first tag to the target information, reference may be made to the relevant description in the method shown in FIG. 29 above, and descriptions are not repeated here.

In another embodiment, the first user has no permission to use the first tag, and the first device displays the second prompt information on the tag adding page. The second prompt information indicates that the first user has no permission to use the first tag. For example, the first user inputs at least a part of the characters included in the first tag on the tag adding page. The first device displays corresponding tag candidates on the tag adding page. The first tag is one of the tag candidates. In this case, if the first user has no permission to use the first tag, the second prompt information is displayed on the tag adding page. In another example, in addition to indicating that the first user has no permission to use the first tag, the second prompt information also instructs the first user to apply to the owner of the first tag for the permission to use the first tag. In this case, if wishing to use the first tag, the first user triggers a preset operation for the second prompt information. The first user triggers the preset operation on the second prompt information. For example, after the first user clicks on the second prompt information, the first device applies, in response to the preset operation triggered by the first user for the second prompt information, to the owner of the first tag for the permission to use the first tag. If the owner of the first tag grants the application, the first user can add the first tag to the target information.

It can be understood with reference to FIG. 32c, which is a schematic diagram of a tag adding page according to an embodiment of the present disclosure. As shown in FIG. 32c, the tag candidates such as “all-day test”, “light service”, and “confirm” are displayed as shown in FIG. 32c after the first user enters the character “#Q” in the tag adding page. For the first tag candidate “light service”, a second prompt information: “No permission, click here to apply for permission” is also displayed.

In this embodiment of the present disclosure, the use permission of the first tag and the viewing permission of the first tag may be set by the owner of the first tag. In an example, the owner of the first tag may trigger a permission setting operation on the permission setting interface of the first tag to set the permission of the first tag. After the owner of the first tag triggers a permission setting operation on the permission setting interface of the first tag, the first device determines, in response to the permission setting operation, the use permission of the first tag and/or the viewing permission of the first tag set by the owner of the first tag. After the use permission of the first tag and/or the viewing permission of the first tag set by the owner of the first tag are determined, permission setting information of the first tag is generated.

Reference is made to FIG. 32d for understanding. FIG. 32d is a schematic diagram of a tag permission setting interface according to an embodiment of the present disclosure. The owner of the first tag “QA” may set the permission of the first tag through the three permission setting options 401, 402 and 403 provided in FIG. 32d. As described above, the use permission has a higher priority than the viewing permission. Therefore, if the owner of the first tag uses the option 401 to set the permission of the first tag, all members in the organization have both the use permission of the first tag and the viewing permission of the first tag. If the owner of the first tag uses the option 402 or 403 to set the permission of the first tag, the owner of the first tag may further set the designated user.

The owner of the first tag mentioned in the embodiment of this application is the creator of the first tag. For example, if the person in charge of a project creates the first tag, then the owner of the first tag is the person in charge of the project.

In addition, it is considered that the person in charge of the project may change. If the person in charge of the project is changed, the person in charge before the change should no longer be the owner of the first tag. Therefore, in this embodiment of the present disclosure, the identity of the owner of the first tag can be transferred. The former owner of the first tag may transfer the identity of the owner of the first tag to another user by performing an owner identity transfer operation. In an example, the former owner may perform the tag transfer operation in the setting interface of the first tag, and designate a user as the owner of the first tag. Reference is made to FIG. 32e, which is a schematic diagram of a tag setting interface according to an embodiment of the present disclosure. As shown in FIG. 32e, the former owner of the first tag “QA”, for example, the user A, may trigger the owner identity transfer operation by clicking “Transfer” shown in FIG. 32e, and designate a user as the new owner.

### Exemplary Device

Based on the methods provided in the above embodiments, a device is also provided according to the embodiments of the present disclosure. This device is introduced below in conjunction with the drawing.

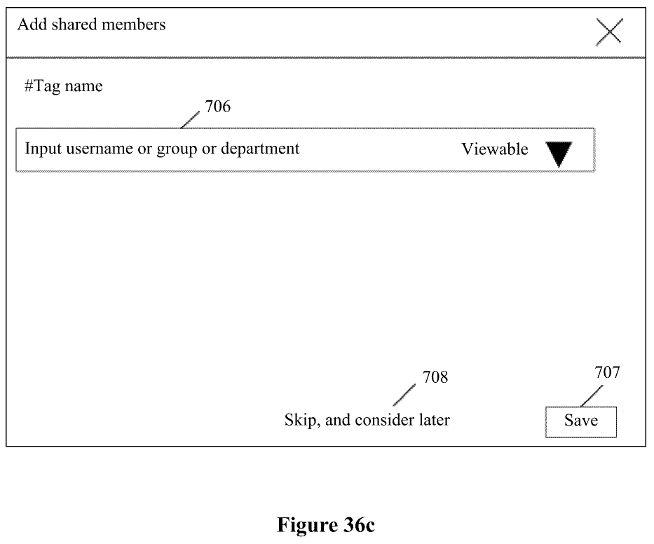

Reference is made to FIG. 33, which is a schematic structural diagram of a device for processing information according to an embodiment of the present disclosure. The device 500 includes, for example, a first determining unit 501 and a second determining unit 502.

The first determining unit 501 is configured to determine permission authorized to the first user for the first tag and viewing permission authorized to the first user for the first information. The first information has the first tag.

The second determination unit 502 is configured to determine the content to be presented to the first user according to the permission authorized to the first user for the first tag and the viewing permission authorized to the first user for the first information.

Optionally, the permission authorized to the first user for the first tag includes: the viewing permission authorized to the first user for the first information. The viewing permission authorized to the first user for the first information indicates whether the first user has the permission to view the associated information of the first tag.

Optionally, the viewing permission authorized to the first user for the first information indicates whether the first user has the permission to view the associated page of the first tag. The associated page of the first tag is configured to present the associated information of the first tag.

Optionally, the second determining unit 502 is configured to determine that the first page to be presented to the first user does not include the first information, if the first user has the permission to view the first tag but has no permission to view the first information.

Optionally, the second determining unit 502 is configured to determine that the content to be presented to the first user includes an associated page of the first tag, if the first user has the permission to view the first tag but has no permission to view the first information.

The associated page of the first tag includes summary information of the information unit with the first tag. The information unit includes second information. The first user has permission to view the second information.

Optionally, the device further includes: a jumping unit or a displaying unit. The jumping unit is configured to jump to a page including the second information in response to a preset operation triggered by the first user for the summary information of the second information. The displaying unit is configured to display the second information in response to a preset operation triggered by the first user for the summary information of the second information.

Optionally, the first page is an instant messaging session interface, and the first information is files published by another user in the instant messaging session indicated by the instant messaging session interface.

Optionally, the second determining unit 502 is configured to associatively present to the first user the first information with the first tag in the instant messaging session, in response to the first user joining an instant messaging session, if the first user has permission to view the first tag.

Optionally, the second determining unit 502 is configured to determine that the content to be presented to the first user does not include the associated page of the first tag, if the first user has no permission to view the first tag but has the permission to view the first information.

Optionally, the second determining unit 502 is configured to determine that the content to be presented to the first user includes a second page, if the first user has no permission to view the first tag but has the permission to view the first information. The second page includes the first information. The association between the first information and the first tag is not displayed on the second page.

Optionally, the second page includes an instant messaging session interface of the first user. The first information includes: session messages in the instant messaging session indicated by the instant messaging session interface, and/or files published by other users in the instant messaging session indicated by the instant messaging session interface.

Optionally, the device further includes a third determining unit. The third determining unit is configured to determine, based on the viewing permission authorized to the first user to the tag indicated by the tag sharing information, the content presented in the associated page of the tag presented to the first user, in response to the tag viewing operation triggered by the first user for the tag sharing information.

Optionally, the permission authorized to the first user for the first tag includes: the permission authorized to the first user to use the first tag. The permission authorized to the first user to use the first tag indicates whether the first user has the permission to add the first tag to information.

Optionally, the permission authorized to the first user to use the first tag has a higher priority than the viewing permission authorized to the first user for the first tag. If the first user has the permission to use the first tag, the first user also has the permission to view the first tag.

Optionally, the device includes an adding unit. The adding unit is configured to add, in response to the first user having permission to use the first tag, the first tag to the target information by: receiving a tag adding operation triggered by the first user for the target information; and generating a correspondence between the first tag and the target information according to the tag adding operation.

The above device 500 corresponds to the method corresponding to FIG. 29 provided in the above method embodiments. Therefore, for details the device 500, reference may be made to the above description of the method shown in FIG. 29, and the description is not repeated here.

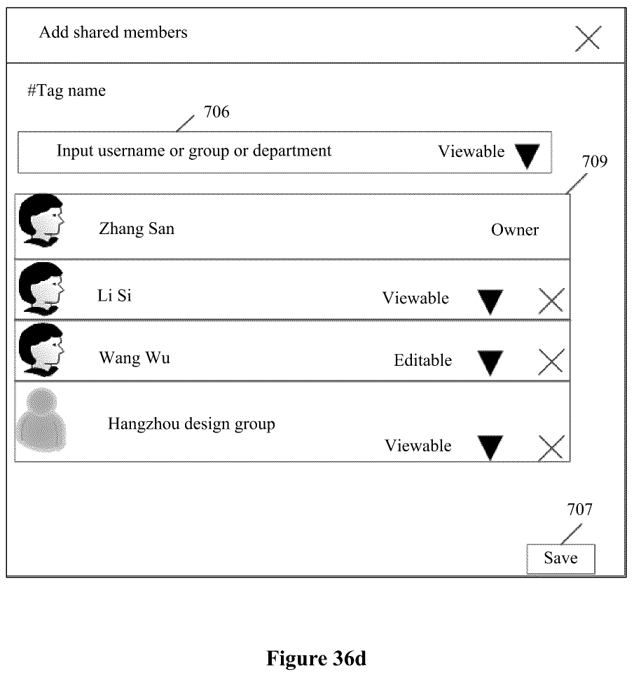

FIG. 34 is a schematic structural diagram of a device for processing information according to an embodiment of the present disclosure. The device 600 includes, for example, an acquiring unit 601 and a first displaying unit 602.

The acquiring unit 601 is configured to acquire the viewing permission authorized to the first user for the first tag in response to a viewing operation triggered by the first user for the first tag. The viewing permission indicates whether the first user has the permission to view the associated information of the first tag.

The first displaying unit 602 is configured to display the associated information of the first tag in response to determining that the first user has the permission to view the first tag.

Optionally, the first displaying unit 602 is configured to display an associated page of the first tag. The associated page of the first tag includes associated information of the first tag.

Optionally, the associated page of the first tag includes summary information of the information unit with the first tag. The information unit includes second information. The first user has permission to view the second information.

Optionally, the information summaries of the information units with the first tag are classified and presented on the associated page of the first tag according to the message domain from which each information unit originates.

Optionally, the information units include a first information unit. The message domain from which the first information unit originates indicates the service provider corresponding to the first information unit.

Optionally, the device further includes a jumping unit and/or a second displaying unit. The jumping unit is configured to jump to a page including the second information in response to a preset operation triggered by the first user for the summary information of the second information. The second displaying unit is configured to display the second information in response to the preset operation triggered by the first user for summary information of the second information.

Optionally, the associated page of the first tag further includes summary information of third information with the first tag. The first user has no permission to view the third information. The associated page of the first tag is a page presented on a device corresponding to the first user.

Optionally, the device further includes a first application unit. The first application unit is configured to apply to the owner of the third information for viewing permission of the third information in response to the preset operation triggered by the first user for the information summary of the third information.

Optionally, the device further includes a third displaying unit. The third displaying unit is configured to display first prompt information in response to determining that the first user has no permission to view the first tag. The first prompt information indicates that the first user has no permission to view the associated information of the first tag.

Optionally, the first prompt information further prompts the first user to apply to the owner of the first tag for permission to view the first tag.

Optionally, the device further includes a second application unit. The second application unit is configured to apply to the owner of the first tag for permission to view the first tag in response to a preset operation triggered by the first user for the first prompt information.

Optionally, the device includes an adding unit. The adding unit is configured to add, in response to the first user having permission to use the first tag, the first tag to the target information by: receiving a tag adding operation triggered by the first user for the target information; and generating a correspondence between the first tag and the target information according to the tag adding operation.

Optionally, the device further includes a fourth displaying unit. The fourth displaying unit is configured to display second prompt information on the tag adding page if the first user has no permission to use the first tag. The second prompt information indicates that the first user has no permission to use the first tag.

Optionally, the second prompt message further prompts the first user to apply to the owner of the first tag for the permission to use the first tag.

Optionally, the device further includes a third application unit. The third application unit is configured to apply to the owner of the first tag for the permission to use the first tag in response to the preset operation triggered by the first user for the second prompt information.

Optionally, the device further includes a generating unit. The generating unit is configured to generate permission setting information of the first tag in response to a permission setting operation triggered by the owner of the first tag on the permission setting interface of the first tag.

Optionally, the owner of the first tag includes the creator of the first tag, or a user specified when the former owner of the first tag performs an owner identity transfer operation.

The above device 600 corresponds to the method corresponding to FIG. 31 provided in the above method embodiments. Therefore, for details of the device 600, reference may be made to the above description of the method shown in FIG. 31, and the description is not repeated here.

A device is also provided according to the embodiment of the present disclosure. The device includes a processor and memory. The processor is configured to execute instructions stored in the memory, so that the device implements the methods provided in the above method embodiments.

According to an embodiment of the present disclosure, a computer-readable storage medium including instructions is also provided. The instruction instructs the device to implement the method provided by the above method embodiment.

According to the embodiment of the present disclosure, a computer program product is also provided. When the computer program product is run on the computer, the computer implements the method provided by the above method embodiments.

Other embodiments of the present disclosure will be readily apparent to those skilled in the art from consideration of the specification and practice of the invention disclosed herein. This application is intended to cover any variations, uses, or adaptations of this application. These modifications, uses or adaptations follow the general principles of the present disclosure and include common knowledge or conventional technical means in the technical field not disclosed in this specification. The specification and examples are to be considered exemplary only, with a true scope and spirit of the present disclosure indicated by the following claims.

It should be understood that the present disclosure is not limited to the precise constructions which have been described above and shown in the drawings, and various modifications and changes may be made without departing from the scope thereof. The scope of the present disclosure is limited only by the appended claims.

The above descriptions are only preferred embodiments of the present disclosure, and are not intended to limit the present disclosure. Any modifications, equivalent replacements, improvements, etc. made within the spirit and principles of this application shall be included within the protection scope of this application.

With the emergence of different application programs, a tagging function is provided in related technologies to integrate information from different information domains. That is, the tagged information is integrated into the tagged page by tagging information in different information domains. By sharing a tag, other users can view information with that tag through that tag. For example, development of a project may require the collaboration of multiple organizations (e.g., multiple departments, or multiple teams). Members participating in the project will generate some information related to the project during the development of the project, such as tasks, schedules, messages, documents, and chat groups. Such information may belong to different information domains. For example, tasks, schedules, messages, documents, and chat groups respectively belong to different information domains. Users tag information in different information domains so as to share information among different organizations based on tags. Different information domains correspond to different or the same server.

However, at present, when a user creates a new tag or displays information blocks under a tag, the processing strategy is relatively simple, which cannot meet the needs of users in different application scenarios. Based on this, a method for processing information and a method for displaying information are also provided according to the embodiments of the present disclosure, and are described in detail below with reference to the drawings.

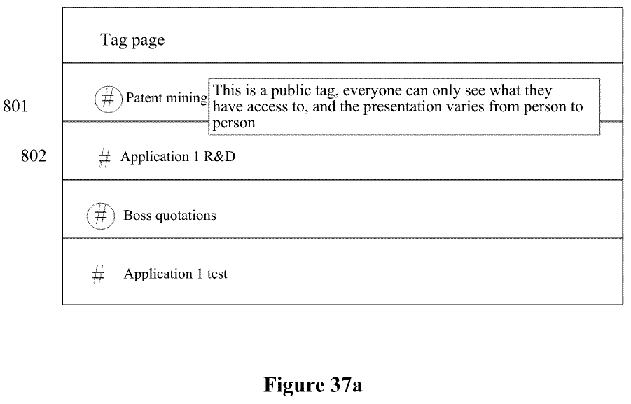

FIG. 35 is a schematic flowchart of a method for processing information according to an embodiment of the present disclosure. This embodiment is applicable to the scenario of creating a new tag. The method is performed by a processing device for creating a new tag. The device is implemented by software and integrated into the client terminal of the user. The client terminal is integrated in a PC (personal computer) or a mobile terminal. As shown in FIG. 35, the method includes the following steps S501 to S503.

In S501, a tag creation operation triggered by a first user is received.

In this embodiment, the first user creates a new tag according to his own needs, and triggers the tag creation operation through the client terminal.

The first user triggers a tag creation operation on the tag page through the client terminal. That is, when only creating a new tag, the first user triggers a tag creation operation on the tag page, thereby causing the client terminal to enter the tag creation page. Alternatively, the first user triggers the tag creation operation through the tag component. That is, when it is necessary to add a tag to the target object, that is, to add a tag to an information block, the first user enters the tag creation page by triggering the tag component.

In S502, the tag creation page is displayed. The tag creation page includes a tag attribute component.

After receiving the tag creation operation triggered by the first user, the client terminal jumps to the tag creation page, so that the first user can create a tag according to the information displayed on the tag creation page. The tag creation page may include a tag attribute component. The tag attribute component indicates the permission scope attribute of the newly created tag. Tags with different permission scope attributes have different corresponding permission scopes. For example, the permission scope attribute has a first attribute value or a second attribute value. The first attribute value indicates that the tag is a public tag. The second attribute value indicates that the tag is a private tag. That is, the permission scope corresponding to the first attribute value is greater than the permission scope corresponding to the second attribute value. The public tag is typically editable by all members belonging to the same organization as the first user. The private tag is viewable or editable by only collaborators. The collaborators are added or specified by the tag creator. The organization indicates the team to which the user belongs, for example, the company, department or project group to which the user belongs.

It should be noted that, for the convenience of subsequent description, for example, the permission scope attribute in this embodiment has a first attribute value and a second attribute value. The first attribute value indicates that the tag is a public tag. The second attribute value indicates that the tag is a private tag. The above correspondence does not constitute a limitation on the specific application of the permission scope attribute.

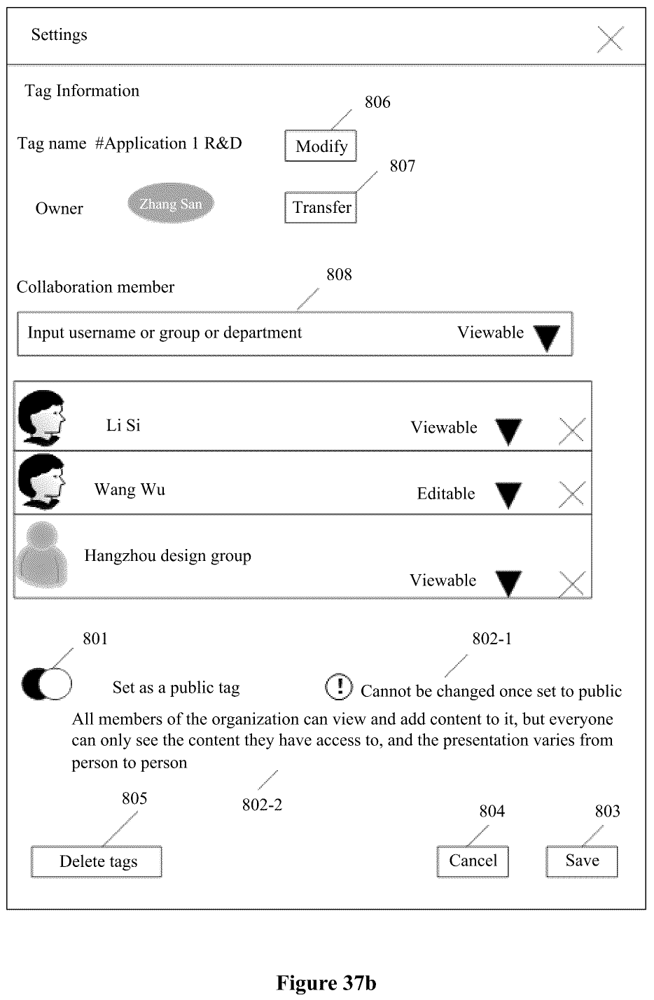

For example, in the example shown in FIG. 36a, the tag creation page includes a tag name input box 701, a tag description adding component 702, a tag attribute component 703, and a creating component 704. In addition, below the tag attribute component 703, a prompt area 705 is also included. The prompt area is configured to prompt the first user whether to open the public attribute indicated by the tag attribute component 703. When the first user chooses to open, the tag creation page is updated, as shown in FIG. 36b. The prompt area 705 includes a first prompt area 705-1 and a second prompt area 705-2. The first prompt area 705-1 is configured to prompt the configuration corresponding to the public tag, for example, “After the public attribute is enabled, everyone in the organization is allowed to tag and aggregate content with it, and everyone can only see the content that for which has access permission is authorized under the tag, and the presentation varies from person to person.”. The second prompt area 705-2 is configured to prompt that the tag cannot be changed after being set as public, so as to remind the user to choose carefully. That is, when the first user selects the tag attribute component 703 as public, a prompt message is displayed. The prompt information indicates that the first tag cannot be changed after being set as public. The prompt information is displayed in the tag name input box 701 to prompt the user to input what information in the input box. Optionally, the first user also triggers the tag description component 702 to add a detailed description related to the tag.

Optionally, in response to the permission scope attribute of the first tag being the first attribute value, all users belonging to the same organization as the user who created the first tag are granted the editing permission of the first tag. The organization indicates the team to which the user belongs, for example, the company, department or project group to which the user belongs. Alternatively, in response to the permission scope attribute of the first tag being the first attribute value, other users who have a preset association with the user who created the first tag are granted the editing permission of the first tag. The other users who have the preset association with the user who created the first tag are collaborators added by the user who created the first tag. For example, if the first tag is a public tag, the first tag is editable to all members in the organization. Further, if the first tag is a public tag, a collaborator adding component is added on the tag creation page in order to meet user needs. The first user specifies some members as collaborators through this component, only the added collaborators have permission to edit the first tag, and other members in the organization have permission to only view the first tag. The edit permission means that the user is allowed to edit the first tag or the information block with the first tag. Optionally, the editing operation includes deleting the tag of the information block, or adding a first tag to the information block. The viewing permission indicates the client terminal to display the first tag or the information block to the user, and prohibits the user from editing.

If the first user does not enable the public attribute indicated by the tag attribute component 703 on the tag creation page shown in FIG. 36a, a sharing member adding page shown in FIG. 36c is jumped to after the first user triggers the creation component 704. The page includes a tag name inputted by the first user, a sharing member addition input box 706 (collaborator adding component), a skip component 708 and a saving component 707. The first user determines whether to add a collaborator according to his own needs. If it is determined that no collaborator needs to be added, the skip component 708 is triggered to directly save the tag name inputted by the first user. If it is determined that a collaborator needs to be added, the collaborator is added in the input box 706. The client terminal receives target user information inputted by the first user in the collaborator adding component, and determines the target user corresponding to the target user information as the collaborator. The client terminal receives the permission setting operation by first user on the collaborator, and determines the operation permission authorized to the collaborator for the first tag according to the permission setting operation. The collaborator that can be added includes, but is not limited to, an individual user, a group, or a department. That is, the target user information is a user name, a group name or a department name. In addition, the operation permission corresponding to the collaborator is set. This operation permission includes that the tag is editable by the added collaborator and other members can view. The other members are users who belong to the same organization as the user who created the first tag and are not collaborators. Alternatively, the tag is viewable or editable by only the added collaborator. It should be noted that, when the added collaborator is a group, the tag is viewable or editable by all members of the group. When the added collaborator is a department, the tag is viewable or editable by all members of the department.

When the first user adds a collaborator, the sharing member adding page includes a member display area 709, as shown in FIG. 36d. In this area, the tag owner Zhang San, Li Si who has the permission to view the tag, Wang Wu who has the permission to edit the tag, and the group Hangzhou Design Group who has the permission to view the tag are displayed in this area. It can be seen from FIG. 36d that the permission can be set for each added collaborator. For example, the corresponding permission is selected through the drop-down instructions. The added collaborator may also be removed. After determining the added collaborator, the first user triggers the saving component 707 to save the created tag and information about the added collaborator.

Optionally, under normal circumstances, no matter whether the first user creates a new tag on the tag page or through the tagging component, the default value of the permission scope attribute of the newly created tag is the second attribute value, namely a private tag, so as to ensure the user privacy in a case that the user forgets to choose.

In S503, a tag name inputted by the first user and a selection operation on a tag attribute component are received, and a first tag is generated.

After the first user inputs a tag name and selects a tag attribute component, the client terminal generates the first tag based on the operation of the first user. Optionally, in order to prevent the created tag from having the same name as the existing tag, the client terminal first performs a validity determination after receiving the tag name inputted by the first user. When there is no duplicate tag name inputted by the first user, the first tag is generated. For example, when the first user inputs a tag name in the tag name input box 701, the client terminal verifies the validity of the inputted tag name, so as to prevent the new tag from having the same name as the existing tag. When the tag name inputted by the first user is valid, the client terminal creates the first tag corresponding to the tag name in response to receiving the trigger of the creation component 704 by the first user.

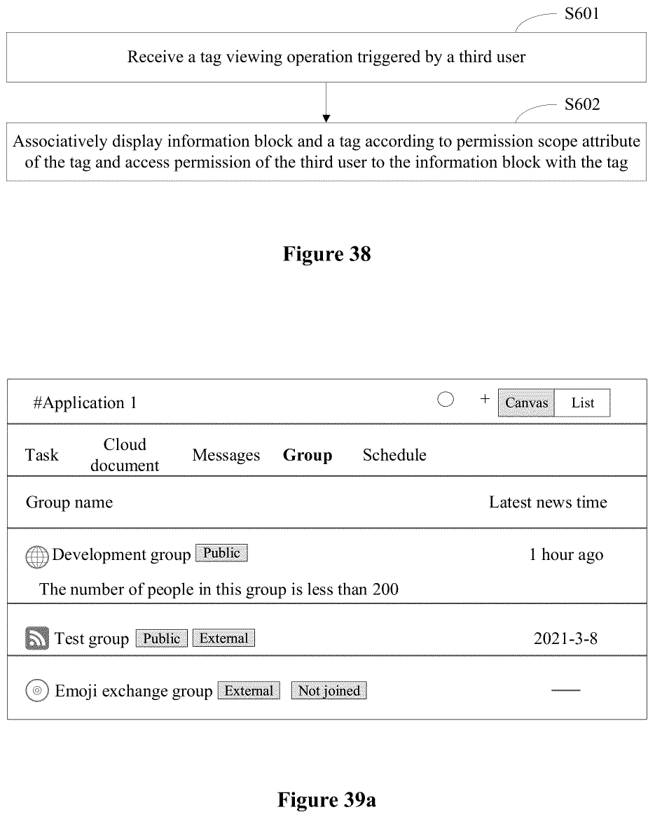

Optionally, in order to facilitate the user to intuitively distinguish tags with different permission scope attributes, the client terminal determines the display mode of the first tag according to the permission scope attribute of the first tag. When the permission scope attribute of the first tag is the first attribute value, that is, when the first tag is a public tag, the first tag is displayed in the first display mode on the tag page. When the permission scope attribute of the first tag is the second attribute value, that is, when the first tag is a private tag, the second tag is displayed in the second display mode on the tag page. The first display mode and the second display mode are in different colors. For example, the symbol “#” of the public tag is displayed in red, and the symbol “#” of the private tag is displayed in black. Alternatively, the first display mode and the second display mode are different display icons. For example, as shown in FIG. 37a, the public tag corresponds to the first display icon 801, and the private tag corresponds to the second display icon 802. Optionally, on the tag page, a prompt is also given for the public tag, as shown in FIG. 37a, to remind the user that “this tag is a public tag, everyone can only see the content for which access permission is authorized, and the presentation varies from person to person”. It should be noted that in various scenarios such as the tagging page, the tagging component, the search, and the mention, tags with different permission scope attributes are displayed differently.

Optionally, in the case that the first tag is a private tag, the tag attribute of the first tag may be changed, so as to be changed into a public tag. When the permission scope attribute of the first tag is the second attribute value, a tag attribute modification operation triggered by the first user for the first tag is received. The tag attribute modification component is displayed. The tag attribute modification component indicates to modify the permission scope attribute of the first tag from the second attribute value to the first attribute value. A trigger operation of the tag attribute modification component by the first user is received, and the permission scope attribute of the first tag is determined as the first attribute value.

For example, as shown in FIG. 37b, the first user enters the setting page by triggering the setting component of the tag page corresponding to the first tag. The setting page includes a tag attribute modification component 801. The first user modifies the tag attribute of the first tag to a public tag by triggering the component. Further, the setting page also includes two prompt areas, namely prompt areas 802-1 and 802-2. The prompt area 802-1 prompts the user that after modifying the tag to a public tag, no change can be made again, that is, the public tag cannot be changed to a private tag, so as to remind the user to operate carefully. The prompt area 802-2 prompts the default configuration corresponding to the public tag, that is, all members in the organization is allowed to view and use the tag to tag the information block, so as to add content to the tag page corresponding to the tag. After the first user triggers the saving component 803 of the setting page, the modification takes effect. That is, the first tag is changed to a public tag. Further, the information of the originally added collaborator is no longer valid. In response to updating the permission scope attribute of the first tag from the second attribute value to the first attribute value, the permission scope of the first tag is updated. For example, when the permission scope attribute of the first tag is the second attribute value, only the collaborators have the editing permission. After the permission scope attribute of the first tag is updated to the first attribute value, all users belonging to the same organization as the user who created the first tag have editing permission. In addition, the display mode of the first tag changes to be the first display mode. And if the first user does not want to change the tag attribute of the first tag, the cancel control 804 may be triggered to leave the setting page.

It should be noted that after a tag is opened as a public tag, the access permission of the information block with the tag is not changed. Everyone is still only allowed to see information blocks for which access permission is authorized, and is not allowed to see information blocks for which access permission is not authorized. The display of information blocks is described in subsequent embodiments, and is not described in detail here.

Optionally, no matter whether the first tag is a public tag or a private tag, the first tag can be edited when the user is the owner of the first tag. A delete operation performed by the first user for the first tag is received. The first user is the owner of the first tag. The first tag is deleted according to the delete operation. As shown in FIG. 37b, the setting page further includes a delete tag component 805, and the first user deletes the first tag by triggering this component.

Optionally, the client terminal further receives the modification to the tag name of the first tag by the first user. As shown in FIG. 37b, the first user modifies the tag name by triggering the modification component 806.

Optionally, the client terminal further receives the modification to the owner by the first user. The first user is the current owner of the first tag. As shown in FIG. 37b, Zhang San transfers the identity of the owner to another member by triggering the transfer component 807. Further, the first user adda another collaborator through the collaborator adding component 808.

When creating a new tag, the first user determines the permission scope attribute of the newly created tag according to his own needs. For example, the permission scope attribute is the first attribute value, that is, the newly created tag is a public tag. The permission scope attribute is the second attribute value, that is, the newly created tag is a private tag. The public tag is searchable, viewable or editable by all members of the organization. The private tag is viewable or editable by only collaborators, and the collaborators are determined by the first user. That is, the permission scope attribute of the tag created by the first user is the second attribute value, and the first user specifies members to view or edit the newly created tag, that is, shares the private tag, so as to meet the needs of users in different scenarios, thereby improving user experience.

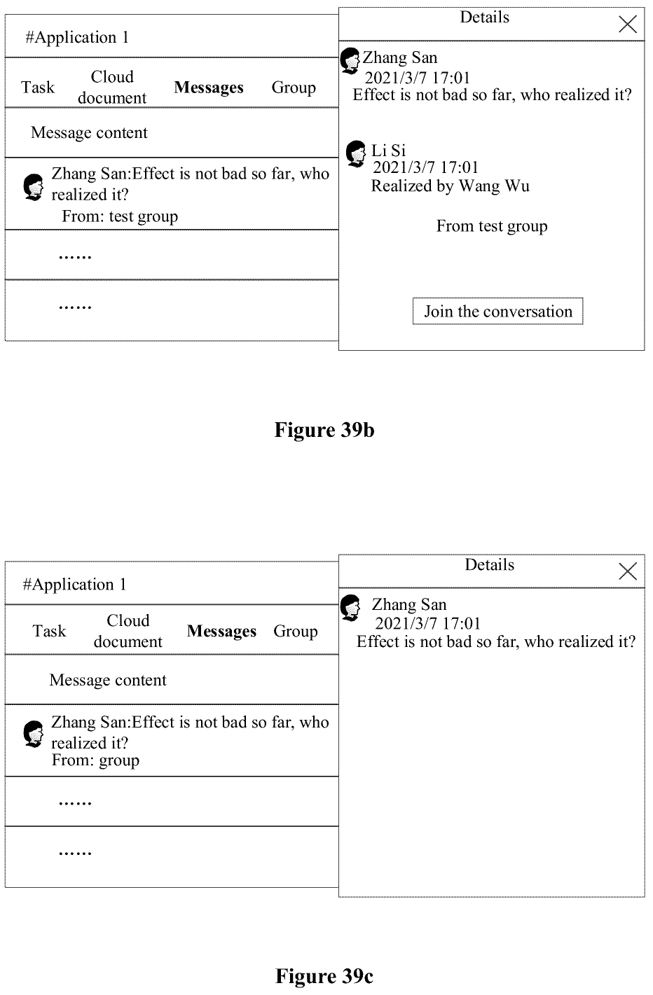

The above method describes how the user sets or creates tags with different attributes according to his own needs, so as to meet the different needs of the users. For tags with different attributes, different displays are performed according to the permission scope attribute of the tag and the access permission of the user to the information blocks when the tag includes one or more information blocks. Description will be given below in conjunction with the drawings. FIG. 38 is a flowchart of an information method according to an embodiment of the present disclosure. As shown in FIG. 38, the method includes the following steps S601 to S602.

In S601, a tag viewing operation triggered by a third user is received.

It can be known from the foregoing that when permission scope attributes corresponding to the tags are different, the tags are displayed in different display modes. For example, when the tag is a public tag, the tag is displayed in the first display mode. When the tag is a private tag, the tag is displayed in the second display mode. After the client terminal receives the tag viewing operation triggered by the third user, the tag is displayed in a corresponding mode. The third user is a user who creates a tag, or a user who has the permission to view or edit the tag.

In S602, the information block and the tag are associatively displayed according to the permission scope attribute of the tag and the access permission authorized to the third user for the information block with the tag.

Optionally, when the third user has access permission to the information block with the tag, the snapshot information of the information block is displayed on the tag page regardless of whether the tag is a public tag or a private tag. In response to the trigger operation by the third user on the information block, the complete information of the information block is displayed. The client terminal displays the complete information of the information block through the sidebar. Further, the first operation component for the information block is also displayed to support various operations of the information block by the third user. The first operation component is configured to edit the association between the information block and the tag. The first operation component includes a removal component configured to release the association between the information block and the tag.

Optionally, the client terminal receives a trigger operation by a third user for removing the component, and deletes the association between the information block and the tag. The client terminal deletes the information block from the tag page corresponding to the tag, or deletes the tag from the corresponding page of the information block. The third user is a user who has editing permissions to the tag and access permission to the information block.

Optionally, if the permission scope attribute of the tag is the first attribute value (public tag) and the third user has no access permission to the information block, no information about the information block is displayed. That is, the information block is insensitive and invisible.

Optionally, if the permission scope attribute of the tag is the second attribute value (private tag) and the third user has no access permission to the information block, the snapshot information of the information block is displayed. The snapshot information is not updated with the content of the information block. In addition, a second operation component for this information block is also displayed. The second operation component is configured to apply for permission to access information. That is, it supports the operation that the third user applies for the access permission to the information block.

The information block is one of objects such as the cloud document, the schedule, the task, the instant messaging (Instant Messaging, IM) message, and the instant messaging IM group. When the information blocks are different objects, the complete information, snapshot information and supported operation corresponding to the information blocks are different. For ease of understanding, different information blocks are described one by one below.

1. Display of IM Groups

(1) The Tag Corresponding to the IM Group is a Public Tag

If the information block is an IM group and the third user has access permission to the IM group, the displayed complete information includes the first identification information, attribute information, latest message time, etc. of the IM group. The first identification information includes a group avatar, a group name, a group description, and the like. The attribute information includes public group, private group, external group, and the like. The supported operations are operations such as joining a group and removing the group. When the third user has no access permission to the IM group, no information is displayed. The public group refers to a group that is visible to all users in the same organization, the private group refers to a group that is visible to specific users, and an external group refers to a group belonging to an organization different from the organization to which the third user belongs.

(2) The Tag Corresponding to the IM Group is a Private Tag

When the tag corresponding to the IM group is a private tag and the third user has access permission to the IM group, the complete information of the IM group is displayed.

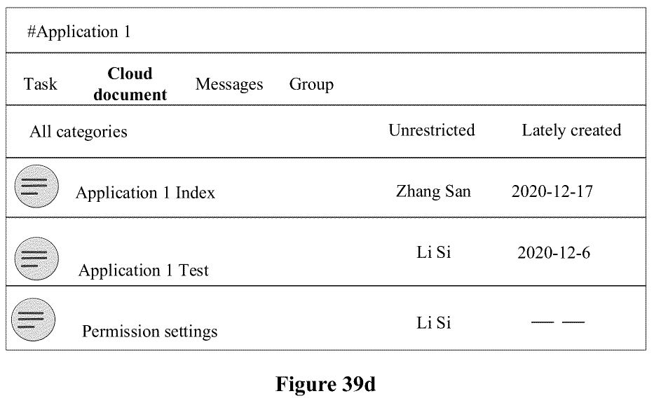

When the tag corresponding to the IM group is a private tag and the user has no access permission to the IM group, the snapshot information corresponding to the IM group and the time when the IM group is tagged are displayed. The snapshot information includes first identification information and/or attribute information of the IM group. For example, the three groups shown in FIG. 39a are respectively the development group, the test group and the emoticon exchange group. The development group belongs to the public group. The test group belongs to the public group and the external group. The emoticon exchange group is a public group and the third user has not joined the group. For the group that the third user has joined, the latest message time of the group is displayed. For an IM group to which the third user has not joined, the latest message time corresponding to the group is not displayed, even if the IM group is a public group. In this case, the client terminal displays preset placeholder. For example, as shown in FIG. 39a, the latest message time is displayed with a horizontal line “-”.

In this case, if the third user has not joined the IM group and the IM group is a public group, the client terminal receives a trigger operation by the third user on the IM group to add the third user to the IM group. That is, the third user is supported to directly join the IM group. When the IM group is a private group, the client terminal receives a trigger operation by the third user on the IM group and sends a group joining request to the corresponding group owner of the IM group. In response to the group owner receiving the group joining request, the third user is added to the IM group. That is, when the IM group is a private group, the third user joins the group through verification by the group owner. When the IM group is a public group, the function of “click the IM group to directly enter the group” is enabled and the function of “click the IM group to initiate a group application” is disabled, so that the third user is to join the group by clicking the IM group. When the IM group is a private group, the function of “click on the IM group to initiate a group application” is enabled and the function of “click on the IM group to directly enter the group” is disabled, so that the third user is to join the group by application. The reason why the function of “click on the IM group to directly enter the group” is disabled when the IM group is a private group is to increase the exposure of the IM group after tagging the IM group. Allowing to click on the IM group to directly enter the group may lower the entry threshold and increase information security risks.

Optionally, the client terminal also receives a removal operation triggered by the fourth user on the IM group, and deletes the association between the IM group and the tag, for example, removes the IM group from the tag page where the tag is displayed. The fourth user is a user who has editing permission to the tag and has access permission to the IM group, or the fourth user is an administrator of the tag corresponding to the IM group.

Optionally, after the fourth user withdraws from the IM group, the client terminal displays differently. One is that the IM group is no longer displayed on the tag page corresponding to the fourth user. That is, the IM group is not visible to the fourth user. Another is to display the snapshot information of the IM group on the tag page corresponding to the fourth user.

Optionally, after the IM group is disbanded, the client terminal removes all information related to the IM group from the tag page, including the snapshot information of the IM group, in response to the disbandment of the IM group.

2. Display of IM Messages

(1) The Tag Corresponding to the IM Message is a Public Tag

In a case that the third user has no access permissions to the IM message, no information is displayed. That is, the IM message is not visible to the third user.

When the third user has access permission to the information block, the complete information is displayed. This complete information includes the name and the avatar of the sender, the content of the message, the time when the content was sent, etc. If the message is from an IM group, the complete information also includes the group name. The client terminal receives the trigger operation by the third user on the IM message, and displays the complete chat message through the sidebar. For example, as shown in FIG. 39b, the third user triggers an IM message to enter a detail page, so as to view a complete chat message on the detail page. In addition, the detail page also includes a session joining component, so that the third user is to enter a session page through the component.

Optionally, when the IM message includes an attachment, summary information of the attachment is displayed. The summary information includes the number of attachments and the category identification of all attachments or some attachments. For example, the categories of attachments are identified as .doc, .xlsl, and .ppt.

Optionally, the client terminal receives a removal operation performed by the third user on the IM message, and deletes the association between the IM message and the tag. For example, the IM message is removed from the tag, and the IM message is no longer displayed on the tag page corresponding to the tag. The third user is an administrator of the tag or a user who has access permission to the IM message and editing permission to the tag. The detail page corresponding to the IM message also includes a removal component. The third user removes the IM message by triggering the removal component.

Optionally, when the third user changes from having access permission to not having access permission, the client terminal displays the snapshot information of the IM message in response to the permission change of the third user. For example, users A, B and C belong to the same session group. The user A tags message M and withdraws from the chat group. In this case, the user A only sees the snapshot information of the message M on the tag page. In addition, the client terminal hides the session joining component and the removal component, and the third user is not allowed to perform the session joining operation and the removal operation. In addition, if the IM message comes from a group, the client terminal hides the information of the group and only prompt that the message comes from the group. The relevant description of the snapshot information of the IM message will be described in the following embodiments.

(2) The Tag Corresponding to the IM Message is a Private Tag

When the third user has access permission to the IM, the client terminal displays the complete information of the IM message.

When the third user does not have the access permission to the IM message, the client terminal displays the snapshot information. The snapshot information includes the name and the avatar of the sender, the message content, and the sending time. If the message comes from a group, it only prompts that the message comes from a group without displaying specific information such as the group name. The third user can view the snapshot information through the sidebar by triggering the IM message, but fails to see the complete chat message. For example, as shown in FIG. 39c, the third user only sees the current message that is tagged through the sidebar.

Optionally, after the IM message is recalled, the client terminal deletes the IM message and the snapshot information corresponding to the IM message from the page where the tag is located. If there is a forwarded message generated based on the IM message, the forwarded message and the snapshot information corresponding to the forwarded message are retained. The forwarded message corresponds to the same tag as the IM message. For example, a message M2 is generated after a message M1 is forwarded. Both M1 and M2 are tagged with tag1. If the message M1 is recalled, M1 and snapshot information m1 on the tag page are deleted. The message M2 and the snapshot information m2 are retained.

Optionally, the client terminal further receives the delete operation by the fourth user on the IM message, and deletes the IM message and the snapshot information from the tag page corresponding to the fourth user. That is, the above delete operation only deletes messages from the client terminal corresponding to the fourth user but no delete messages from the server. For example, if the user A deletes the message M, the message M and snapshot information m are no longer seen in the tag page corresponding to the user.

Optionally, when the IM message comes from the group and the group is disbanded, the client terminal deletes the IM message and snapshot information from the tag page where the tag is located, so that all users with access permissions will no longer see the IM message and snapshot information.

3. Displays of Cloud Documents

(1) The Tag Corresponding to the Cloud Document is a Public Tag

When the third user has no access permission to the cloud document, no information about the cloud document is displayed.

When the third user has access permission to the cloud document, the complete information of the cloud document is displayed. The complete information includes a document title, an owner, a tagging time, a document update time, a creation time, etc. The supported operations are sharing, etc. In addition, the third user views the content of the cloud document by triggering the link of the cloud document.

Optionally, the client terminal receives a removal operation triggered by the fourth user on the cloud document, and deletes the association between the cloud document and the tag. For example, the client terminal removes the cloud document from the tag page where the tag is located. The fourth user is a user who has editing permission to the tag and access permission to the cloud document. The page where the cloud document is located includes a removal component, and the fourth user may remove the cloud document by triggering the removal component.

Optionally, in response to the fourth user changing from having access permission to not having access permission, the client terminal generates snapshot information corresponding to the cloud document, and displays the snapshot information on a tag page corresponding to the third user. In addition, the client terminal hides the removal component in the tag page.

(2) The Tag Corresponding to the Cloud Document is a Private Tag

When the third user has access permission to the cloud document, the complete information of the cloud document is displayed.

When the third user has no access permission to the cloud document, the snapshot information of the cloud document is displayed in response to a viewing operation triggered by the third user. The snapshot information includes the title and/or owner of the cloud document. In addition, the client terminal hides the creation time and/or latest modification time of the cloud document.

Optionally, prompt information is also displayed on the tag page displaying the cloud document. The prompt information prompts that the third user has no access permission to the cloud document. As shown in FIG. 39d, the page of the cloud document prompts that the user does not have permission to access the target document, and the creation time of the document is not displayed.

Optionally, the client terminal may provide the third user with a function of acquiring access permission. The client terminal receives a trigger operation by the third user on the cloud document, and displays an access permission application component. The client terminal receives the trigger operation by the third user on the access permission application component, and sends an access request to the owner of the cloud document. In response to the access permission granted by the owner to the third user, the client terminal displays the complete information and specific content of the cloud document to the third user. In practice, the client terminal jumps to the webpage of the browser after receiving the trigger operation by the third user on the cloud document. The web page displays the access permission application component. Alternatively, the client terminal opens the pop-up window after receiving the trigger operation by the third user on the cloud document. The access permission application component is displayed in the pop-up window.

Optionally, the client terminal provides the third user with the function of acquiring a link of the cloud document. The client terminal receives a trigger operation by the third user on the cloud document, and sends a request for access permission to the owner of the cloud document. In response to the sharing operation by the owner on the link of the cloud document, the third user views the document through the link. For example, as shown in FIG. 39e, when the third user is a non-collaborator of the tag and the owner of the cloud document has not enabled the “link sharing” function, the third user is not allowed to read the cloud document through the document link. After the owner of the cloud document enable the “link sharing” function, as shown in FIG. 39f, the third user, even a non-collaborator of the tag, is allowed to read the cloud document through the document link.

Optionally, the client terminal receives a removal operation triggered by a fourth user on the cloud document to delete the association between the cloud document and the tag, for example, remove the cloud document from the tag page where the tag is located. The fourth user is a user who has editing permission to the tag and access permission to the cloud document.

Optionally, when the fourth user changes from having access permission to having no access permission, the client terminal generates snapshot information corresponding to the cloud document, and displays the snapshot information in the tag page corresponding to the fourth user. In addition, the removal component for the cloud document is hidden in the tag page corresponding to the fourth user.

4. Display of Schedules

(1) The Tag Corresponding to the Schedule is a Public Tag

When the third user has no access permission to the schedule, no information related to the schedule is displayed.

When the third user has the access permission to the schedule, the client terminal displays complete information on the schedule, that is, details of the schedule, in response to the third user triggering a viewing operation on the schedule on the tag page. The complete information includes the subject of the schedule, execution time of the schedule, creator of the schedule, participants of the schedule, meeting description of the schedule, conference room for the schedule, calendar for the schedule, reminder time of the schedule, etc. The third user views all the details of the schedule by opening the sidebar.

(2) The Tag Corresponding to the Schedule is a Private Tag

When the tag corresponding to the schedule is a private tag, the schedules are divided according to attributes into public schedules and private schedules. When the schedule is a public schedule, if the third user is a participant of the schedule, that is, has access permission, the third user is allowed to view all details of the schedule through the sidebar. If the third user is not a participant of the schedule, that is, has no access permission, then the snapshot information corresponding to the schedule is displayed. The snapshot information includes one or more of the subject of the schedule, the execution time of the schedule, and the creator of the schedule. In addition, on the schedule page corresponding to the third user, other detailed information of the schedule such as location information corresponding to the schedule, participants, reminder time, calendar to which the schedule belongs, and schedule description is hidden. The third user views the snapshot information of the schedule by opening the sidebar.

When the schedule is a public schedule and a fifth user is not a participant, the client terminal determines whether to allow the fifth user (collaborator of the tag) to join the schedule according to the permission authorized to the user who adds a tag to the schedule. The client terminal determines whether the fourth user who adds a tag to the schedule has sharing permission on the schedule. When the fourth user has the sharing permission, the client terminal displays the adding component on the snapshot information page. After receiving the trigger operation of the joining component by the fifth user, the client terminal adds the fifth user as a participant of the schedule. When the fourth user does not have the permission to invite participants, the client terminal prompts that the schedule is not allowed to join the schedule. The fifth user is a user who is allowed to view the schedule on a tag page corresponding to the tag.

When the schedule is a private schedule, if the third user is a participant of the schedule, then the third user is allowed to view all the details of the schedule. If the third user is not a participant of the schedule, it is prompted that the schedule is a private schedule. In addition, the third user is not allowed to view the snapshot information of the schedule. That is, it does not support opening the sidebar to view details of the schedule. Further, the client terminal does not support other users to join the schedule.

Optionally, regardless of whether the schedule is a public schedule or a private schedule, in response to the schedule being deleted, the client terminal deletes the schedule and the snapshot information corresponding to the schedule from the tag page where the tag is located. The deleted schedule may be a single schedule in a recurring schedule. In this case, the client terminal deletes the single schedule and the snapshot information corresponding to the single schedule from the tag page where the tag is located, and keeps other recurring schedule and snapshot information.

Optionally, when the calendar to which the schedule belongs is deleted, the client terminal deletes all the schedules belonging to the calendar and the snapshot information corresponding to the schedules from the tag page corresponding to the tag.

Optionally, in response to the fourth user changing from a participant of the schedule to a non-participant, the client terminal generates snapshot information of the schedule, and displays the snapshot information on a tag page corresponding to the fourth user.

5. Display of Tasks

(1) The Tag Corresponding to the Task is a Public Tag

When the third user has no access permission to the task, no information related to the task is displayed.

When the third user has the access permission to the task, complete information of the task is displayed on the tag page corresponding to the third user. The complete information includes the creator, executor, description, etc. of the task. The third user views the complete information of the task by opening the sidebar. The third user who is neither the creator nor the executor of the task can become a follower of the task through a task follower component displayed on the task page, so as to be allowed to view the progress of the task and the like. The progress update information of the task is displayed on the tag page corresponding to the third user.

(2) The Tag Corresponding to the Task is a Private Tag

When the tag corresponding to the task is a private tag and the third user has the access permission to the task, the third user is allowed to view all information of the task. It should be noted that, the client terminal is configured to only allow users with the identity of the task creator or task executor to edit the task in order to ensure the integrity of the information.

Optionally, users who are not creators or executors can manually become followers of the task, so as to be allowed to follow the progress of the task in real time. If the third user is not the creator or executor of the task, the client terminal displays the task follower component for the third user. After receiving a trigger operation of the task follower component by the third user, the client terminal adds the third user as a follower of the task.

In addition, a method for searching for the above information block is provided in an embodiment of the present disclosure. If the user has the access permission to the information block, the user is allowed to search for the information block not only in the search component corresponding to the tag page but also in the search component corresponding to the entire client terminal. That is, the information block visible to the user can be searched for. For example, before clicking to view the cloud document, the user is not allowed to search for the information block in the search component. After viewing the cloud document, the user is allowed to search for the information in the search component.

Optionally, the user is allowed to search for the snapshot information corresponding to the information block in the search component corresponding to the tag page, and is not allowed to search for the snapshot information corresponding to the information block in the search component corresponding to the client terminal.

Based on the foregoing method embodiments, a device for processing information and a device for displaying information are provided according to embodiments of the present disclosure, which will be described below with reference to the drawings.

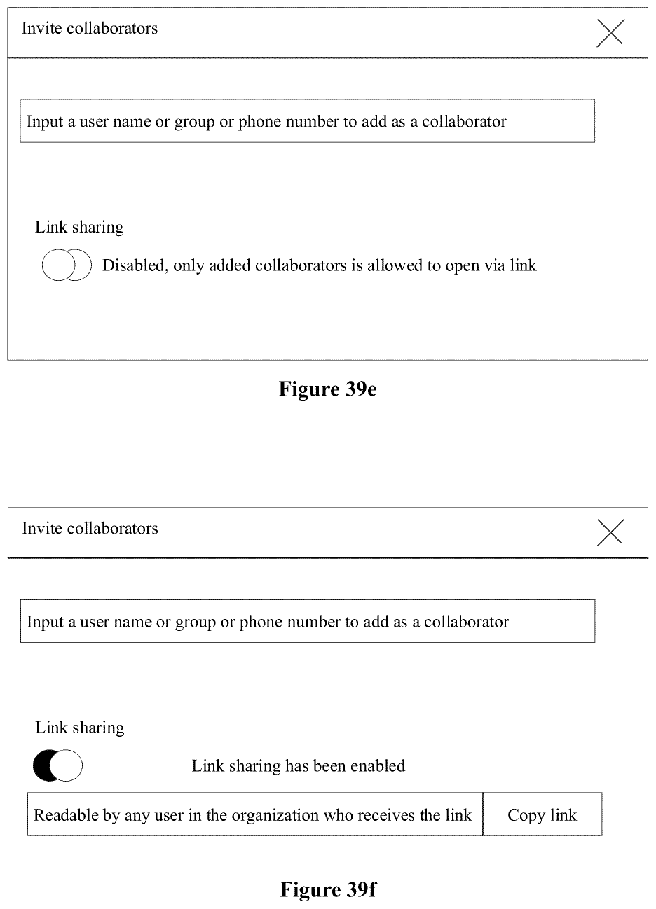

FIG. 40 is a structural diagram of a device for processing information according to an embodiment of the present disclosure. As shown in FIG. 40, the device includes a first receiving unit 901, a first displaying unit 902, a second receiving unit 903 and a generating unit 904.

The first receiving unit 901 is configured to receive a tag creation operation triggered by a first user. The first displaying unit 902 is configured to display a tag creation page. The tag creation page includes a tag attribute component. The tag attribute component indicates the permission scope attribute of the newly created tag. The second receiving unit 903 is configured to receive a tag name inputted by the first user and a selection operation on the tag attribute component. The generating unit 904 is configured to generate a first tag.

In an embodiment, the device further includes: a first determining unit configured to determine a display mode of the first tag according to the permission scope attribute of the first tag.

In one embodiment, the device further includes: a first permission granting unit configured to grant, in response to the permission scope attribute of the first tag being the first attribute value, editing permission of the first tag to all users belonging to the same organization as the user who created the first tag.

In an embodiment, the device further includes: a second permission granting unit configured to grant, in response to the permission scope attribute of the first tag being the first attribute value, editing permission to the first tag to other users who have a preset association with the user who created the first tag.

In an embodiment, the device further includes: a second displaying unit configured to display a collaborator adding component in response to the permission scope attribute of the first tag being the second attribute value.

In an embodiment, the device further includes: a third receiving unit, a second determining unit, and a third determining unit. The third receiving unit is configured to receive target user information inputted by the first user in the collaborator adding component. The second determining unit is configured to determine the target user corresponding to the target user information as a collaborator. The fourth receiving unit is configured to receive a permission setting operation performed by the first user for the collaborator. The third determining unit is configured to determine the operation permission authorized to the collaborator for the first tag according to the permission setting operation.

In an embodiment, the third determination unit is configured to grant the collaborator the editing permission of the first tag.

In an embodiment, the target user information includes at least one of: a user name, a group name and a department name.

In an embodiment, the first receiving unit is configured to receive a tag creation operation triggered by the first user for the tag page, or receive a tag creation operation triggered by the first user through a tagging component.

In an embodiment, the permission scope attribute of the first tag is the second attribute value, and the device includes: a fifth receiving unit, a third displaying unit, a sixth receiving unit, and a fourth determining unit. The fifth receiving unit is configured to receive a tag attribute modification operation triggered by the first user for the first tag. The third displaying unit is configured to display the tag attribute modification component. The tag attribute modifying component indicates to modify the permission scope attribute of the first tag from the second attribute value to the first attribute value. The sixth receiving unit is configured to receive a trigger operation by the first user on the tag attribute modification component. The fourth determining unit is configured to determine the permission scope attribute of the first tag as the first attribute value.

In an embodiment, the device further includes: an update unit configured to update the permission scope of the first tag, in response to updating the permission scope attribute of the first tag from the second attribute value to the first attribute value.

In an embodiment, the first tag is displayed in a first display mode.

In an embodiment, the permission scope attribute of the first tag defaults to the second attribute value.

In an embodiment, the device further includes: a fourth displaying unit configured to display prompt information in response to the permission scope attribute of the first tag being the first attribute value. The prompt information indicates that the permission scope attribute of the first tag cannot be changed after being set to the first attribute value.

In an embodiment, the device further includes: a seventh receiving unit and a deleting unit. The seventh receiving unit is configured to receive a delete operation of the first tag by the second user. The second user is the owner of the first tag. The deleting unit is configured to delete the first tag according to the deleting operation.

It should be noted that, for implementation of each unit in this embodiment, reference is made to the method embodiment shown in FIG. 35, and this embodiment is not described in detail here.

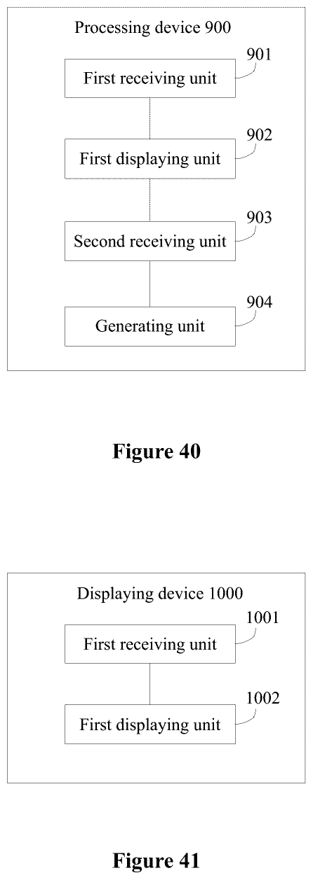

FIG. 41 is a structural diagram of a device for displaying information according to an embodiment of the present disclosure. As shown in FIG. 41, the device includes: a first receiving unit 1001 and a first displaying unit 1002. The first receiving unit 1001 is configured to receive a tag viewing operation triggered by a third user. The first displaying unit 1002 is configured to associatively display an information block and the tag according to the permission scope attribute of the tag and access permission authorized to the third user for the information block with the tag.

In an embodiment, the first displaying unit is configured to: display snapshot information of the information block when the third user has access permission to the information block; and display complete information of the information block in response to a trigger operation performed by the third user for the information block.

In an embodiment, the device further includes a second displaying unit. The second displaying unit is configured to display a first operation component for the information block in response to the third user having editing permission of the tag. The first operation component is configured to edit the association between the information block and the tag.

In an embodiment, the device further includes: a second receiving unit and a first deleting unit. The second receiving unit is configured to receive a trigger operation by the third user on a removal component. The first deleting unit is configured to delete the association between the information block and the tag.

In an embodiment, the first deleting unit is configured to delete the information block from the tag page corresponding to the tag.

In one embodiment, the first displaying unit is configured to display snapshot information of the information block when the permission scope attribute of the tag is the second attribute value and the third user has no access permission to the snapshot information of the information block.

In an embodiment, the snapshot information is not updated following the update of the content corresponding to the information block.

In an embodiment, the device further includes a third displaying unit. The third displaying unit is configured to display a second operation component for the information block. The second operating component is configured to apply for permission to access the information block.

In one embodiment, the information block is an IM group. The snapshot information includes first identification information and/or attribute information of the IM group.

In an embodiment, the attribute information includes one or more of a public group, a private group, and an external group.

In an embodiment, the snapshot information further includes second identification information. The second identification information indicates that the third user has not joined the IM group.

In an embodiment, the group attribute is a public group, and the device further includes a third receiving unit. The third receiving unit is configured to receive a trigger operation of the third user on the IM group, and add the third user to the IM group.

In an embodiment, the group attribute is a private group, and the device further includes a fourth receiving unit and a joining unit. The fourth receiving unit is configured to: receive a trigger operation of the third user on the IM group, and send a group joining request to a group owner corresponding to the IM group. The joining unit is configured to add the third user to the IM group in response to the group owner accepting the group joining request.

In an embodiment, the device further includes a fifth receiving unit. The fifth receiving unit is configured to receive a removal operation triggered by the fourth user on the IM group, and delete the association between the IM group and the tag. The fourth user has editing permission to the tag and access permission to the IM group.

In an embodiment, the device further includes a fourth displaying unit. The fourth displaying unit is configured to display snapshot information of the IM group on a tag page corresponding to the fourth user in response to the fourth user withdrawing from the IM group.

In an embodiment, the device further includes a second deleting unit. The second deleting unit is configured to delete the IM group and the snapshot information from the tag page corresponding to the tag in response to disbandment of the IM group.

In an embodiment, the information block is an IM message. The snapshot information includes one or more of a sender name, an avatar, message content and a sending time of the IM message.

In an embodiment, the IM message is a group chat message, and there is corresponding prompt information in the information block. The prompt information indicates that the IM message is from a group.

In an embodiment, the prompt information includes identification information of the group.

In an embodiment, the first displaying unit is configured to receive a trigger operation performed by the third user on the information block and display the snapshot information through a sidebar when the permission scope attribute of the tag is the second attribute value and the third user has no access permission to the information block.

In an embodiment, the information block is an IM message. The displaying the complete information of the information block includes: receiving a trigger operation performed by the third user on the information block, and displaying the complete information through a sidebar.

In an embodiment, the device further includes: a fifth displaying unit configured to display summary information of an attachment in response to the IM message including the attachment.

In one embodiment, the summary information includes the number of attachments and category identifications of the attachments.

In an embodiment, the device further includes a sixth receiving unit and a removal unit. The sixth receiving unit is configured to receive a removal operation of the IM message by the third user. The removing unit is configured to remove the IM message from the tag. The third user has access permission to the IM message and has editing permission to the tag.

In an embodiment, the device further includes a seventh receiving unit and a page entering unit. The seventh receiving unit is configured to receive a trigger operation of the third user on a session joining component. The page entering unit is configured to switch to the session page. The session joining component is located on the page displaying the complete information.

In an embodiment, the device further includes a sixth displaying unit. The sixth displaying unit is configured to display snapshot information of the IM message in response to the third user changing from having the access permission to the IM message to not having the access permission to the IM message.

In an embodiment, the device further includes a third deleting unit. The third deleting unit is configured to delete the IM message and the snapshot information corresponding to the IM message from the tag page where the tag is located in response to the IM message being recalled.

In an embodiment, the device further includes a retaining unit. The retaining unit is configured to retain a forwarded message generated based on the IM message and snapshot information corresponding to the forwarded message in response to the IM message being recalled. The forwarded message corresponds to the same tag as the IM message.

In an embodiment, the device further includes an eighth receiving unit and a fourth deleting unit. The eighth receiving unit is configured to receive a delete operation of a fourth user on the IM message. The fourth deleting unit is configured to delete the IM message and the snapshot information corresponding to the IM message from the tag page corresponding to the fourth user.

In an embodiment, the IM message is from a group, and the device further includes a fifth deleting unit. The fifth deleting unit is configured to delete the IM message and the snapshot information corresponding to the IM message from the tag page where the tag is located, in response to the group being disbanded.

In an embodiment, the information block is a cloud document, and the device further includes a first prompting unit. The first prompting unit is configured to prompt that the third user has no access permission to the cloud document.

In an embodiment, the device further includes a ninth receiving unit, a seventh displaying unit, a tenth receiving unit and a first sending unit. The ninth receiving unit is configured to receive a trigger operation on the cloud document by the third user. The seventh displaying unit is configured to display an access permission application component. The tenth receiving unit is configured to receive a trigger operation of the third user on the access permission application component. The first sending unit is configured to send an access request to the owner of the cloud document.

In an embodiment, the device further includes an eleventh receiving unit and a second sending unit. The eleventh receiving unit is configured to receive a trigger operation by a third user on the cloud document. The second sending unit is configured to send a request for acquiring access permission to the owner of the cloud document.

In an embodiment, the device further includes a twelfth receiving unit and a sixth deleting unit. The twelfth receiving unit is configured to receive a removal operation triggered by a fourth user on the cloud document. The sixth deleting unit is configured to delete the association between the cloud document and the tag. The fourth user has editing permission to the tag and has access permission to the cloud document.

In an embodiment, the device further includes an eighth displaying unit. The eighth displaying unit is configured to display snapshot information of the cloud document in response to a change of the fourth user from having the access permission to the cloud document to not having the access permission to the cloud document.

In an embodiment, the device further includes a hidden unit. The hidden unit is configured to hide a removal component for the cloud document in the tag page corresponding to the fourth user.

In an embodiment, the information block is a schedule. The first displaying unit is configured to display snapshot information corresponding to the schedule when a permission scope attribute of the tag is the second attribute value and the third user has no access permission to the information block, and the schedule is a public schedule and the third user is not a participant of the schedule.

In an embodiment, the device further includes: a first determining unit, a thirteenth receiving unit, a first adding unit and a second prompting unit. The first determination unit is configured to determine whether the fourth user who added the tag to the schedule has sharing permission to the schedule. The thirteenth receiving unit is configured to receive a trigger operation by a fifth user on an adding component when the fourth user has sharing permission. The first adding unit is configured to add the fifth user as a participant of the schedule. The fifth user is allowed to view the schedule on a tag page corresponding to the tag. The second prompting unit is configured to prompt that the fourth user is not allowed to join the schedule when the fourth user does not have sharing permission.

In an embodiment, the information block is a schedule, and the device further includes a third prompting unit. The third prompting unit is configured to prompt that the schedule is a private schedule when the schedule is private and the third user is not a participant of the schedule.

In an embodiment, the device further includes a seventh deleting unit. The seventh deleting unit is configured to delete the schedule and the snapshot information corresponding to the schedule from the tag page corresponding to the tag in response to the schedule being deleted.

In an embodiment, the schedule is a single schedule in a recurring schedule.

In an embodiment, the device further includes an eighth deleting unit. The eighth deleting unit is configured to delete the schedule and the snapshot information corresponding to the schedule from the tag page corresponding to the tag in response to the calendar to which the schedule belongs being deleted.

In an embodiment, the device further includes a ninth displaying unit. The ninth displaying unit is configured to display snapshot information of the schedule in response to the fourth user changing from a participant of the schedule to a non-participant.

In an embodiment, the information block is a task, and the device further includes a tenth displaying unit, a fourteenth receiving unit and a second adding unit. The tenth displaying unit is configured to display a task follower component when the third user is not the creator or executor of the task. The third user has access permission to the task. The fourteenth receiving unit is configured to receive a trigger operation of the third user on the task follower component. The second adding unit is configured to add the third user as a follower of the task.

In an embodiment, the device further includes an eleventh displaying unit. The eleventh displaying unit is configured to display progress update information of the task on the tag page corresponding to the third user.

It should be noted that, for the implementation of each unit in this embodiment, reference is made to the embodiment described in FIG. 38, and this embodiment is not described in detail here.

FIG. 42 shows a schematic structural diagram of an electronic device (such as a terminal device or a server running a client terminal) 2600 suitable for implementing the embodiments of the present disclosure. The terminal device in the embodiments of the present disclosure includes but is not limited to mobile terminals such as mobile phones, notebook computers, digital broadcast receivers, Personal Digital Assistants (PDAs), Tablet Computers (PADs), Portable Multimedia Players (PMPs), and vehicle-mounted terminals (such as vehicle-mounted navigation terminals), as well as fixed terminals such as digital TVs, desktop computers. The electronic device shown in FIG. 42 is only an example, and should not limit the functions and scope of use of the embodiments of the present disclosure.

As shown in FIG. 42, the electronic device 2600 may include a processing device (such as a central processing unit and a graphics processing unit) 2601. The processing device 2601 can execute various appropriate actions and processes according to programs stored in a read only memory (ROM) 2602 or loaded from a storage device 2608 into a random-access memory (RAM) 2603. In the RAM 2603, various programs and data necessary for the operation of the electronic device 2600 are also stored. The processing device 2601, the ROM 2602 and the RAM 2603 are connected to each other through a bus 2604. An input/output (I/O) interface 2605 is also connected to the bus 2604.

Generally, the following devices may be connected to the I/O interface 2605: input devices 2606 including, for example, a touch screen, a touch pad, a keyboard, a mouse, a camera, a microphone, an accelerometer, a gyroscope, etc.; output devices 2607 including, for example, a liquid crystal display (LCD), a speaker, a vibrator, etc.; a storage device 2608 including, for example, a magnetic tape, a hard disk, etc.; and a communication device 2609. The communication device 2609 may allow the electronic device 2600 to perform wireless or wired communication with other devices to exchange data. Although FIG. 42 shows the electronic device 2600 having various devices, it should be understood that implementing or having all of the devices shown is not a requirement. More or fewer devices may alternatively be implemented or provided.

In particular, according to an embodiment of the present disclosure, the processes described above with reference to the flowcharts may be implemented as computer software programs. For example, embodiments of the present disclosure include a computer program product. The computer program product includes a computer program carried on a non-transitory computer-readable medium. The computer program contains program code for carrying out the methods shown in the flowcharts. In such an embodiment, the computer program may be downloaded and installed from a network via the communication device 2609, or from the storage device 2608, or from the ROM 2602. When the computer program is executed by the processing device 2601, the functions defined in the methods of the embodiments of the present disclosure are performed.

The electronic device, the method for information interaction, the method for viewing a tag, the method for processing information, and the method for displaying information according to the embodiments of the present disclosure belong to the same inventive concept. For technical details not exhaustively described in this embodiment of the present disclosure, reference may be made to the foregoing embodiments. In addition, the device embodiments of the present disclosure have the same beneficial effects as the above embodiments.

According to an embodiment of the present disclosure, there is provided a computer storage medium on which a computer program is stored. When the program is executed by the processor, the method for processing information or the method for displaying information provided in the foregoing embodiments is implemented.

It should be noted that the above computer-readable medium in the present disclosure may be a computer-readable signal medium or a computer-readable storage medium or any combination of the above two. The computer readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to: electrical connections with one or more wires, portable computer disks, hard disks, a random-access memory (RAM), a read only memory (ROM), an erasable programmable read-only memory (EPROM or Flash), optical fibers, a compact disk read-only memory (CD-ROM), optical storage devices, magnetic memory components, or any suitable combination of the above. In the present disclosure, the computer-readable storage medium may be any tangible medium that contains or stores a program. The program may be used by or in conjunction with the instruction execution system, apparatus or device. In the present disclosure, however, the computer-readable signal medium may include a data signal propagated in baseband or as part of a carrier wave, and the data signal carries computer-readable program code. Such propagated data signals may be in various forms, including but not limited to electromagnetic signals, optical signals, or any suitable combination of the foregoing. The computer-readable signal medium can also be any computer-readable medium other than the computer-readable storage medium. The computer-readable signal medium may transmit, propagate, or transport a program for use by or in connection with an instruction execution system, apparatus, or device. Program code embodied on the computer-readable medium may be transmitted by any appropriate medium, including but not limited to: wires, optical cables, RF (radio frequency), etc., or any suitable combination of the above.

In some embodiments, the client terminal may communicate with a server using any currently known or future-developed network protocols such as HTTP (Hypertext Transfer Protocol), and the client and the server may be interconnected with digital data communication (e.g., a communication network) of any form or medium. Examples of the communication network include local area networks (“LANs”), wide area networks (“WANs”), internetworks (e.g., the Internet), and peer-to-peer networks (e.g., ad hoc peer-to-peer networks), as well as any currently known or future developed network.

The computer-readable medium may be included in the electronic device, or may exist independently without being incorporated into the electronic device.

The computer-readable medium carries one or more programs, when being executed by the electronic device, causes the electronic device to: receive a tag adding operation triggered by a user on a target object, and generate a correspondence according to the tag adding operation; or receive a tag viewing operation triggered by a user on a tag viewing control; and display at least one tag according to the tag viewing operation.

The computer program code for carrying out operations of the present disclosure may be written in one or more programming languages, or a combination thereof. Such programming languages include, but are not limited to, object-oriented programming languages such as Java, Smalltalk, C++, and conventional procedural programming languages such as the “C” language or similar programming languages. The program code may be executed entirely on the user computer, partly on the user computer, as a stand-alone software package, partly on the user computer and partly on a remote computer, or entirely on a remote computer or server. Where a remote computer is involved, the remote computer may be connected to the user computer through any kind of network including a local area network (LAN) or a wide area network (WAN), or may be connected to an external computer (e.g., via the Internet by an Internet service provider).

The flowcharts and block diagrams in the drawings illustrate the architecture, functionality, and operation of possible implementations of systems, methods and computer program products according to various embodiments of the present disclosure. In this regard, each block in the flowchart or block diagram may represent a module, program segment, or portion of code. The module, program segment, or portion of code contains one or more executable instructions for implementing specified logical functions. It should also be noted that, in some alternative implementations, the functions noted in the blocks may occur in an order different form the order noted in the drawings. For example, two blocks shown in succession could, in fact, be executed substantially concurrently or in a reverse order, depending upon the functionality involved. Further, each block in the block diagrams and/or flow charts, and a combination of blocks in the block diagrams and/or flow diagrams may be performed by a dedicated hardware-based system that performs the specified functions or operations or by a combination of dedicated hardware and computer instructions.

The units involved in the embodiments described in the present disclosure may be implemented by software or by hardware. The name of a unit does not in any way constitute a qualification of the unit itself. For example, an editable content displaying unit is also described as an “editing unit”.

The functions described herein above may be performed at least in part by one or more hardware logic components. For example, without limitation, exemplary hardware logic components that may be used include: field programmable gate arrays (FPGAs), application specific integrated circuits (ASICs), application specific standard products (ASSPs), system on chips (SOCs), complex programmable logical devices (CPLDs), etc.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of the machine-readable storage medium may include one or more wire-based electrical connections, portable computer disks, hard disks, a random-access memory (RAM), a read only memory (ROM), an erasable programmable read only memory (EPROM or flash memory), fiber optics, a compact disk read-only memory (CD-ROM), optical storage devices, magnetic storage devices, or any suitable combination of the foregoing.

The above description shows only preferred embodiments of the present disclosure and an illustration of the applied technical principle. Those skilled in the art should understand that the disclosure scope involved in the present disclosure is not limited to the technical solutions formed by specific combinations of the above technical features. Instead, the scope of disclosure involved in the present disclosure shall cover other technical solutions formed by any combination of the above technical features or equivalent features without departing from the above disclosed concepts. For example, a technical solution formed by replacing the above-mentioned features with (but not limited to) technical features with similar functions disclosed in the present disclosure.

In addition, while operations are depicted in a particular order, this should not be understood as requiring that the operations be performed in the particular order shown or to be performed in sequential order. Under certain circumstances, multitasking and parallel processing may be advantageous. Likewise, while the above discussion contains several specific implementation details, these should not be construed as limitations on the scope of the present disclosure. Certain features that are described in the context of separate embodiments are also implemented in combination in a single embodiment. Alternatively, various features that are described in the context of a single embodiment are also implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Instead, the specific features and acts described above are merely example forms of implementing the claims.

It should be noted that embodiments in this specification are described in a progressive way, each embodiment focuses on the differences from other embodiments, and the same and similar parts of each embodiment can be referred to each other. Since the system or device disclosed in the embodiments corresponds to the method disclosed in the embodiments, the description of the system or device is relatively simple, and for related parts, reference is made to the description of the method.

It should be understood that in this application, “at least one (item)” means one or more, and “multiple” means two or more. The term “and/or” describes the association of associated objects, indicating that there are three associations. For example, “A and/or B” includes that only A exists, only B exists, and both A and B exist. A and B are singular or plural. The character “/” generally indicates that the contextual objects are an “or” relationship. The term “at least one of” or similar expressions thereof means that any combination of these items includes any combination of a single item or multiple items. For example, at least one item (unit) of a, b or c includes a, b, c, “a and b”, “a and c”, “b and c”, or “a and b and c”. a, b, and c are single or multiple.

It should also be noted that, relational terms such as first and second etc. are only used to distinguish one entity or operation from another entity or operation, and do not necessarily require or imply any such actual relationship or order between these entities or operations. Moreover, the terms “comprising”, “including” or any other variation thereof are intended to be non-exclusive. Therefore, a process, method, article, or device comprising a set of elements includes not only those elements, but also other elements not expressly listed, or includes elements inherent in such process, method, article, or device. Without further limitations, an element defined by the phrase “comprising a . . . ” does not exclude the presence of additional identical elements in the process, method, article or device including the element.

The steps of the methods or algorithms described in conjunction with the embodiments disclosed herein are directly implemented by hardware, software modules executed by a processor, or a combination of both. The software module is placed in a random-access memory (RAM), a memory, a read-only memory (ROM), an electrically programmable ROM, an electrically erasable programmable ROM, a register, a hard disk, a removable disk, a CD-ROM, or any other form of storage medium known in the technical field.

The disclosed embodiments are described above, so that those skilled in the art can make or use the present disclosure. Various modifications to these embodiments are apparent to those skilled in the art. The general principles defined herein may be implemented in other embodiments without departing from the spirit or scope of the present disclosure. Therefore, the present disclosure is not limited to the embodiments shown herein, but is to be accorded the widest scope consistent with the principles and novel features disclosed herein.

1. A method for information interaction, comprising:
receiving a tag adding operation triggered by a user for a target object; and
generating a correspondence relationship according to the tag adding operation, wherein the correspondence relationship comprises a correspondence relationship between a target tag and the target object.

2. The method according to claim 1, wherein the target tag is created by another user other than the user.

3. The method according to claim 1, wherein the receiving a tag adding operation triggered by a user for a target object comprises:
receiving a tag adding operation triggered by the user for a tag adding control of the target object,
wherein the method further comprises:
receiving a selection operation triggered by the user for the target object and displaying the tag adding control according to the selection operation for the target object, before receiving the tag adding operation triggered by the user for the tag adding control of the target object, or
receiving a display operation of the tag adding control triggered by the user and displaying the tag adding control according to the display operation, before receiving the tag adding operation triggered by the user for the tag adding control of the target object.

4. The method according to claim 1, further comprising:
acquiring the target tag determined by the user according to the tag adding operation after receiving the tag adding operation triggered by the user for the target object, wherein the acquiring the target tag determined by the user according to the tag adding operation comprises:
displaying at least one candidate tag according to the tag adding operation, wherein the at least one candidate tag comprises the target tag;
receiving an selection operation performed by the user on the target tag; and
determining the target tag according to the selection operation.

5. The method according to claim 1, further comprising:
acquiring the target tag determined by the user according to the tag adding operation, after receiving the tag adding operation triggered by the user for the target object; and
displaying prompt information after acquiring the target tag determined by the user according to the tag adding operation, wherein the prompt information indicates that the target tag is already added to the target object.

6. The method according to claim 1, further comprising:
acquiring the target tag determined by the user according to the tag adding operation, after receiving the tag adding operation triggered by the user for the target object; and
receiving a tag viewing operation on the target object triggered by the user and displaying the target tag according to the viewing operation, after acquiring the target tag determined by the user according to the tag adding operation.

7. The method according to claim 1, further comprising:
acquiring the target tag determined by the user according to the tag adding operation, after receiving the tag adding operation triggered by the user for the target object; and
displaying a content viewing control, receiving a viewing operation triggered by the user for the content viewing control, and displaying an object corresponding to the target tag according to the viewing operation, after acquiring the target tag determined by the user according to the tag adding operation.

8. The method according to claim 1, wherein the correspondence relationship between the target tag and the target object comprises a correspondence relationship between the target tag and an information block of the target object, and the information block is generated based on the target object.

9. The method according to claim 8, further comprising:
jumping to an interface comprising the target object in response to a trigger operation on the information block; and/or
displaying the target object in response to the trigger operation on the information block.

10. The method according to claim 1, further comprising:
before receiving the tag adding operation triggered by the user for the target object,
receiving an adding operation triggered by the user for the target tag, and displaying at least one candidate object according to the adding operation; and
determining a candidate object selected by the user from the at least one candidate object as the target object.

11. The method according to claim 10, wherein
the at least one candidate object is classified and presented according to a tag domain from which the candidate object originates.

12. The method according to claim 1, further comprising:
receiving a permission setting operation performed by the user on the target tag, and determining, according to the permission setting operation, the user who has permission to operate the target tag.

13. The method according to claim 1, further comprising:
receiving a delete operation performed by the user on the target tag; and
deleting the target tag according to the delete operation.

14. The method according to claim 1, wherein the correspondence relationship comprises a correspondence relationship between the target tag, the information block of the target object, and information of the user.

15. The method according to claim 1, wherein
the target object comprises at least one of: a cloud document, a schedule, a task, an instant messaging message and a group chat instant messaging message.

16. A method for viewing a tag, comprising:
receiving a tag viewing operation triggered by a user for a tag viewing control; and
displaying at least one tag according to the tag viewing operation,
wherein the at least one tag comprises one or more of:
a tag created by the user; and
a tag which is created by another user other than the user and to which the user has viewing permission.

17. The method according to claim 16, further comprising:
receiving a filtering trigger operation performed by the user on a filtering control; and
presenting a filtering result corresponding to a filter operation triggered by the filter trigger operation,
wherein the filter operation is for filtering tags presented on a target interface according to an attribute value of at least one attribute.

18. The method according to claim 16, wherein
the receiving the tag viewing operation triggered by the user for the tag viewing control comprises: receiving the tag viewing operation triggered by the user for the tag viewing control displayed associatively with the target object; and
the displaying at least one tag according to the tag viewing operation comprises:
displaying at least one tag of the target object according to the tag viewing operation.

19. The method according to claim 16, wherein the at least one tag comprises a first tag, and the method further comprises:
receiving a viewing operation triggered by the user on the first tag, and displaying an information block of at least one object having the first tag.

20. The method according to claim 19, wherein:
the information block of the at least one object having the first tag is classified and presented according to a tag domain from which the object originates,
the tag domain includes one or more of: a task, a schedule, a cloud document, an instant messaging message and an instant messaging group.

21. The method according to claim 18, wherein
the information block of each of the at least one object is presented as a list or canvas card.

22. The method according to claim 19, further comprising:
receiving a grouping operation triggered by the user for at least one object having the first tag; and
grouping one or more of the at least one object according to the grouping operation.

23. The method according to claim 22, wherein
the at least one object comprises a first object, and an information block of the first object is displayed in a first canvas card; and
the receiving the grouping operation triggered by the user for the at least one object having the first tag comprises: receiving a dragging operation performed by the user of dragging the first canvas card to a first group in a canvas view.

24. The method according to claim 19, wherein the at least one object comprises a first object, and the method further comprises at least one of:
jumping to an interface of a first object associated with the information block in response to a trigger operation on the information block of the first object;
displaying the first object in response to the trigger operation on the information block of the first object;
deleting a correspondence relationship between the first object and the first tag in response to receiving a tag delete operation performed by the user on the first object.

25. The method according to claim 16, wherein the at least one tag comprises a second tag, the second tag is created by another user different from the user, and the user does not have viewing permission to the second tag, and
the method further comprises:
receiving a permission application operation for the second tag triggered by the user; and
sending a permission application request to the user corresponding to the second tag according to the permission application operation, wherein the permission application request is for applying for viewing permission to the second tag.

26. The method according to claim 16, further comprising:
receiving a bookmark operation triggered by the user for a target tag in the at least one tag and bookmarking the target tag according to the bookmark operation; or
receiving a viewing operation triggered by the user for a bookmarked tag control, and displaying a bookmarked tag in the at least one tag according to the viewing operation.

27. The method according to claim 16, wherein
the at least one tag is sorted according to a preset rule,
the preset rule comprises one or more of: tag access time, tag creation time, and tag priority.

28. The method according to claim 16, wherein the tag viewing control is at least one of: a tag viewing control of a target cloud document, a tag viewing control of a task, a tag viewing control of a schedule, a tag viewing control of an instant messaging message and a tag viewing control of an instant messaging group.

29. An electronic device, comprising:
a memory configured to storing one or more programs; and
one or more processors configured to execute the one or more programs, to implement:
receiving a tag adding operation triggered by a user for a target object; and
generating a correspondence relationship according to the tag adding operation, wherein the correspondence relationship comprises a correspondence relationship between a target tag and the target object.

30. A non-transitory computer-readable storage medium, on which a computer program is stored, wherein
the program, when executed by a processor, implements:
receiving a tag adding operation triggered by a user for a target object; and
generating a correspondence relationship according to the tag adding operation, wherein the correspondence relationship comprises a correspondence relationship between a target tag and the target object.
